(19) United States
(12) Patent Application Publication
(10) Pub. No.: US 2005/0193015 A1
(43) Pub. Date: Sep. 1, 2005

(54) Method and apparatus for organizing, sorting and navigating multimedia content

(75) Inventors: Gary L. Logston, Poway, CA (US); Matthew S. Logston, Poway, CA (US)

Correspondence Address: Kenneth J. Hoguta, 13287 Monroe Way, Thornton, CO, 80241, US

(73) Assignee: Sandraic Logic, LLC a California limited liability company

(21) Appl. No.: 11/058,382

(22) Filed: Feb. 15, 2005

Related U.S. Application Data
(60) Provisional application No. 60/546,013, filed on Feb. 19, 2004.

(51) Int. Cl. G06F 7/00

(52) U.S. Cl. 707/104.1

(57) ABSTRACT

An improved method and apparatus for organizing, sorting, navigating and selecting for use, one or more multimedia content items available from one or more varied types of multimedia content sources, based on a multimedia content user's characteristics, preferences and entitlements, and multimedia content item attributes and characteristics. In a first aspect of the invention, a method and architecture (FIG. 11) are disclosed which uses an information structure hierarchy of parameter sets and included parameters and their associated information fields contained therein to facilitate identification, description, location and characterization of multimedia content items, multimedia content sources, and user characterizing information. In a second aspect of the invention, a method and architecture are disclosed for sorting multimedia content items by applying sorting criteria expressed in the type and format of the multimedia content item, multimedia content source and user identification, description, location and characteristics information (FIGS. 9, 10), at the time of content creation, distribution and delivery through a multimedia content source and at the time multimedia content is selected by a multimedia content user (FIG. 8), for the purposes of identifying and presenting those items appropriate for a particular multimedia content user. In a third aspect of the invention, a method and architecture are disclosed for displaying on a television or computer screen connected to a multimedia terminal, a plurality of video windows containing a menu and visual rendering (FIG. 12) of only those multimedia content items identified as appropriate for the particular multimedia content user, based on the sorting criteria. In a fourth aspect of the invention, a method and architecture are disclosed for navigating the plurality of display windows (FIGS. 14 through 19) for the purposes of selecting a multimedia content for use by the particular multimedia content user.

The present application claims priority benefit of U.S. provisional application Ser. No. 60/546,013 filed Feb. 19, 2004 and entitled “Method and Apparatus for Organizing, Sorting and Navigating Multimedia Content”, which is incorporated herein in its entirety.

The present invention was not made by an agency of the United States Government or under a contract with an agency of the United States Government.

### BACKGROUND OF THE INVENTION

1. Field of the Invention

The present invention, called a Multimedia Content Navigation Tool (“MCNT”), relates generally to the field of multimedia content creation, storage, distribution and delivery, and the navigation and selection of multimedia content items from one or more multimedia content sources, such as, inter alia, cable television, satellite television, local broadcast or other wireless television, and IP data systems and networks, including the Internet, and specifically to a method and apparatus for organizing, sorting, and user-friendly graphical illustration display and navigation of multimedia content items for selection by a user using remote control buttons, keyboard keys, and/or on-screen button icon displays connected to multimedia terminal devices including, inter alia, cable tv set-top boxes, television sets, satellite tv receivers, video game consoles, multimedia computers, portable communications devices, audio players, DVD players, CD burners/players, digital video recorders, video cassette recorders.

2. Description of Related Prior Art

A major dilemma facing the content creators, content aggregators, service providers, and the content consumer is the difficulty in navigating among the enormous quantity of content that is now available in the home. New techniques are needed to allow viewers to select desirable content in today's multi-dimensional media space without endlessly surfing through thousands of television channels and media web sites. The present invention is designed to allow agents at various points in the multimedia delivery system to dynamically create matrices of content that simplify the navigation process for the content consumer at the endpoint of the media universe.

Many media delivery systems, such as cable and satellite television systems, utilize Electronic Program Guides, or EPGs, such as those disclosed by Freeman in U.S. Pat. No. 4,264,924 and Young in U.S. Pat. No. 4,706,121, to provide organization for time-linear media programming offered by the service providers. Such EPGs allowed a viewer to manually select the programming that was desirable for viewing at certain scheduled times, with the underlying system automatically locating the selected program by controlling a programmable channel tuner to connect the viewer to the appropriate video signal. Such systems, unfortunately, still require the viewer to actively select the desired programming and provide no real assistance in sorting through the thousands of programming options available in today's multi-dimensional media space.

Improvements in the navigation of content over time were made in systems such as that described by Herz et al. in U.S. Pat. No. 5,351,075 that allows the viewer to select video programming based on a future schedule of programming events. Many systems have also been developed that allow the viewer to customize the content selection process by utilizing an on-screen display that includes programs from only a specific content category or a list of programs on favorite channels. See, for example, White et al. in U.S. Pat. No. 5,596,373 and Lawler in U.S. Pat. No. 5,758,259. While such navigational systems provide improvements over the pure linear selections of the earlier EPGs, it is desirable to have additional capabilities that allow viewers to sort information from many sources base on individual preferences.

An example of such a sort-based system is described by Herz in U.S. Pat. No. 6,088,722, where viewer profile information is used to calculate an “agreement matrix” which characterizes the attractiveness of each video program to each viewer. A variety of content can be thus selected from among the active video channels and sorted into Virtual channels that are targeted to meet the viewing tastes of particular customers. This system is a step in the right direction, but does not provide the flexibility needed to sort across a multi-dimensional media space that includes broadcast and stored media, as well as web-based content choices. This system also does not provide any mechanism to pre-process multi-dimensional content matrices to target the tastes of a variety of viewers that might be simultaneously accessing content on a multi-faceted delivery system, such as that found in cable television systems today, that can provide access to broadcast video, Video on Demand Servers, Specialty Pay-per-View channels, Live Webcasts, Interactive, Video games, Stored Web-based Media, and a variety of stored media interconnected by home networking technologies. Such multi-dimensional media systems require a more sophisticated organizational and navigation system, such as that described in the present invention.

There have been systems introduced that provide the capacity to navigate across two or more media dimensions, such as the merged scheduling approach described by Nishikawa, et. al. in U.S. Pat. No. 6,348,932 and Klosterman in U.S. Pat. No. 5,550,576, where the program guide information from multiple media sources are merged into a single EPG. Another such system was developed by Hoffman in U.S. Pat. No. 5,883,677, where separate streams of programming information are collected from multiple outside video service providers are combined into a single database for presentation to the viewer. Although each of these systems do provide for navigation across multi-dimensional media space, the end result is to collapse the media space into a large, flat single dimensional space that is more difficult to navigate. The present invention provides the means to organize and sort media in such multi-dimensional media spaces, not by combining all of the available media into a single dimension, but by searching and sorting across the media spaces using algorithms ruled by viewer preference.

There are also systems that combine access to content across television channels and the Internet, such as that described by Boyer, et. al. in U.S. Pat. No. 6,268,849, where the information for the EPG is obtained by access to a Internet Website. Other systems, such as that described by Legall, et. al. in U.S. Pat. No. 6,005,565, provides an integrated search tool that can access information available from EPGs and Websites to aid in the selection and display of desirable content. Such tools store the search criteria in filters that can be effectively executed at a future time. These inventions provide a positive step in moving towards integrated organizational and search techniques across television and Internet. What they are lacking, however, is a unified method and technique that allows for content to be processed and sorted at multiple points in the media spaces, such as the pre-processing and real-time processing that the present invention provides.

### SUMMARY OF THE INVENTION

Generally, the present invention discloses a method and apparatus for organizing, sorting, and navigating one or more multimedia content items available from one or more of a plurality of multimedia content sources (each content source herein also referred to as a “media plane” and the one or more multimedia content items available from the multiple media planes herein referred to as a “multi-dimensional media space”), which such multimedia content sources (media planes) include, but are not limited to, wired or wireless information, communications or broadcast systems and networks, such as, inter alia, cable television, satellite television, local broadcast or other wireless television, telephone, cell phone/PCS, Internet world-wide-web, other internet protocol (“IP”) Client-Server, video-on-demand, and electronic magazine rack systems and networks, and associated computer, storage and communications devices of the foregoing. A multimedia content item (herein also referred to as a “content item”) is defined as information comprising any one or a combination of video, audio, still or moving images, text, symbols, or graphics including, but not limited to, movies, television programming, photos, web pages, video games, software code, maps, charts, music, speeches, literary text and artwork images (and associated audio, if any).

A multimedia content user desiring to select from a vast number of available multimedia content items by virtue of having access to one or more media planes, with each media plane providing a large amount of multimedia content item choices, is faced with a daunting task in the absence of some method of organizing, sorting, displaying for navigation, and navigating the vast number of available content items in a user-friendly way. The present invention solves this problem by enabling a user, such as a viewer of multimedia content (or a video game player, a person interacting with interactive multimedia content, or a person downloading a software module), to find and select multimedia content items which have been sorted based on defined sorting criteria, by presenting to the user, in a viewer-friendly display for navigation, a graphical illustration of a list, menu and image of the one or more content item(s) matching or otherwise conforming to said sorting criteria, and by enabling the user to navigate said displayed content item(s) graphical illustration by invoking a plurality of navigation functions by pressing buttons on a remote control device, keys on a keyboard, and/or on-screen button icons appearing on a display connected to a multimedia terminal device such as, inter alia, a cable tv set-top box, television set, satellite television receiver, video game console, multimedia computer, portable communications device, audio player, DVD player, CD burner/player, digital video recorder, video cassette recorder. The present invention discloses a method of organizing multimedia content items available from a multi-dimensional media space; sorting out one or more subset(s) list(s) of multimedia content items from said multi-dimensional media space (which such subset(s) match(es), or otherwise conform(s) to, a defined sorting criteria) and presenting the subset(s) list(s) in a display for navigation; and displaying and navigating the subset(s) list(s), whereby a user of multimedia content is able to view a display showing a graphical illustration of said one or more matching (conforming) subset(s) list(s), and by so viewing, point to and otherwise manipulate one or more display windows of said graphical illustration to select a content item from the subset(s) list(s) for use (e.g. viewing, listening, interactive playing, or downloading) by pressing buttons on a remote control device, keys on keyboard, and/or on-screen button icons connected to a multimedia terminal device to invoke one or more navigation functions. Each of the organizing, sorting, displaying, and navigating methods disclosed uses a hierarchial multi-dimensional information structure disclosed by the present invention. Each of the parameter sets in the hierarchy of the multidimensional information structure disclosed contains one or more parameters and each said parameter contains one or more related information fields, and each of the fields contains variables having values expressed in any one or a combination of alphanumeric characters, punctuation symbols, text strings, arithmetic and logic operators, integers, and real numbers.

As one example, and not as a limitation of the present invention, a plurality of available multimedia content items is organized, sorted, displayed and navigated in a system having at least one of the following multimedia terminal devices, such as a digital cable tv set-top box with associated remote control device, a digital television set with associated remote control device, and an in-home area network multimedia computer with associated wired or wireless keyboard, said multimedia terminal device(s) being connected to a multi-dimensional media space comprising a cable television system delivering multiple television programming, pay per view, video-on-demand, and music programming services, a satellite television system delivering multiple television and music programming services, an off-air local broadcast digital television station delivering multiple television programming services, a broadband XDSL or cable modem IP network connection providing access to multiple file, video-on-demand, web page and streaming media servers on the Internet world-wide-web or a virtual private network, and an in-home area network connecting a digital video recorder, multimedia server computer and storage device, with said device itself storing a plurality of multimedia content items. Each of the aforementioned television programming, pay per view, video-on-demand, file/web, image, music and streaming media sources contain multiple multimedia content items, all of which comprise a multi-dimensional media space organized, sorted, displayed and navigated by the present invention.

In a first aspect of the invention, a method of organizing one or more multimedia content items in a multi-dimensional media space using a hierarchy of parameter sets in a multi-dimensional information structure, is disclosed. The method generally comprises organizing characteristic information particular to each content item, including, inter alia, title/name, identification number, description, version, class and type, location, restrictions or entitlements on use, genre/subject matter, owner/provider/author/publisher/distributor, date of publication or release, source, time and duration of availability, running time duration, decode/display/processing format/engine, file size, targeted viewer/user demographics, and appropriateness or other content rating (e.g. tv rating, movie rating, video game rating, target viewer demographics, into the information fields of the parameters in the parameter sets comprising the multi-dimensional information structure. One of the parameter sets, a Content Instance, comprises a Content Descriptor and a Content Locator. Another parameter set, a Content Diagonal, organizes, through characterizing and locating, one or more Content Instances by containing, along with one Diagonal Header to identify the Content Diagonal itself, both a Content Instance Locator and a Content View Token particular to each Content Instance assigned to the Content Diagonal, with said assignment being based on their respective Content View Tokens. Any particular Content Diagonal may contain Content Instances from one or more media planes, although the respective Content View Tokens defines one or more common characteristics of the Content Instances found in a particular Content Diagonal. Another parameter set, a Content Display Matrix, organizes, through characterizing and locating, one or more Content Diagonals by, along with a Matrix Header to identify the matrix itself, both a Diagonal Locator and a Diagonal View Token particular to each Content Diagonal assigned to the Content Display Matrix, with said assignment being based on their respective Diagonal View Tokens. Any particular Content Display Matrix may contain Content Diagonals having different Diagonal View Tokens, so that content items of varied characteristics (i.e. defined by different view tokens) can be made eligible for display or use if said characteristics conform to the pre-defined sorting criteria as specified below.

In a second aspect of the invention, a method of sorting out one or more subset(s) list(s) of multimedia content items from a multi-dimensional media space by performing one or more sorting algorithms to determine one or more multimedia content items which match(es), or otherwise conform(s) to, defined sorting criteria; preparing an ordered list of the one or more matching (or otherwise conforming) subset(s); and presenting said subset(s) for display and navigation using a plurality of presentation and navigation parameter sets in the hierarchy of the multi-dimensional information structure disclosed. The sorting method generally comprises defining the sorting criteria (either in advance of content item selection or in real-time at the time of content selection) as content item characteristic information expressed in the type and format of the parameters and variables in the fields of the aforementioned organizing parameter sets; examining the information contained in the organizing parameter sets of each multimedia content item in a multi-dimensional media space using one or more sorting algorithms; comparing said examined information with the defined sorting criteria information using one or more sorting algorithms to determine the content items which match, or otherwise conform to, said sorting criteria (thereby identifying the content item(s) as “acceptable” for the particular active viewer; preparing one or more list(s) of one or more of the matching (or otherwise conforming) multimedia content items using one or more sorting algorithms, whereby said list(s) is/are subset(s) of the content items in the multi-dimensional media space and said list(s) contain content items sorted into one or more parameter sets in the hierarchy of the multi-dimensional information structure; using said one or more sorting algorithms to assign a Content View Token to each content item listed in the sorted subset(s); using said one or more algorithms to sort content items by comparing their individual Content View Token(s) with one or more Viewing Profiles as sorting criteria to sort each content item into one or more Content Diagonals; further using said Content View Token(s) by a real-time Navigation Processing Engine to dynamically evaluate whether or not a particular content item can be viewed or accessed as “acceptable” for a particular viewer or user, as further specified below. As an example and not as a limitation of the present invention, said subset(s) of content items may be sorted according to the Content Locator and/or to the Content Descriptor contained in the Content Instance of each of the listed content items. In a third aspect of the invention, a method of further sorting multimedia content items for navigation is disclosed. The method generally comprises defining a set of one or more Viewing Profile(s) as information expressed in the type and format of the information contained in the aforementioned Content View Token(s); examining the Content View Token(s) of one or more content items in a multi-dimensional media space and comparing said Content View Token(s) with one or more Viewing Profile(s) to create a list of those content items having a Content View Token(s) which match(es), conforms with (or is otherwise “compatible” with) the one or more Viewing Profile(s); using the results of the aforementioned sorting to create a new, or modify an existing, set of Content Diagonals containing a list of only those content items with a Content View Token(s) matching, conforming with, or otherwise “compatible” with, the defined View Profile(s), whereby a content item having an associated Content View Token not matching the Viewing Profile(s) is either: not included in the Content Diagonal, or is removed from the Content Diagonal, or is “blanked out” in the on-screen display of the Content Diagonal, or is replaced by a substituted content item having a Content View Token that is “acceptable” according to the Viewing Profile(s).

In a fourth aspect of the invention, a method of navigating the aforementioned one or more sorted subset(s) list(s) of multimedia content items using a multi-dimensional graphical tool comprising a real-time Navigation Processing Engine to process, prepare and communicate a set of “active” navigation information parameter sets to a real-time Navigation Display Engine, is disclosed. The method, embodied in the real-time Navigation Processing Engine, generally comprises inputting configuration information pertinent to a particular user (viewer, listener, gamer), herein referred to as a Viewer Configuration Information parameters set, along with other parameter sets of the disclosed multidimensional information structure, including, inter alia, Content Instances, Content Diagonals and Content Display Matrices, as well as content items delivered from one or more media planes, into the real-time Navigation Processing Engine; processing said inputted Viewer Configuration Information and other parameter sets in the real-time Navigation Processing Engine to calculate View Values; comparing said View Values with the individual Content View Token(s) of one or more content items; then, based on the results of said comparison as being “acceptable” or “unacceptable”, either allowing an acceptable content item to remain in the active Content Display Matrix, deleting an unacceptable content item from the active Content Display Matrix, “blanking out” the on-screen display listing of an unacceptable content item even though the content item may still be contained in the active Content Display Matrix, or searching for and substituting an acceptable content item into the active Content Display Matrix to replace an unacceptable content item; generating one or more active Content Display Matrix (or Matrices); preparing the appropriate set of active Content Diagonals identified by the one or more active Content Display Matrix (or Matrices), which such Content Diagonals may require modification, before communication by the real-time Navigation Processing Engine to the real-time Navigation Display Engine, if the Content View Token(s) of the content items listed in the Content Diagonals indicate that the Content Instances are unacceptable for the particular active viewer; extracting “information requests” from the Viewer Configuration Information; retrieving the information requested in the aforementioned information requests from Content Descriptors, Content Instances, and Content Locators; and formatting and communicating the retrieved information to the real-time Navigation Display Engine as a set of Display Information Containers, whereby there is at least one Display Information Container transmitted for each Content Diagonal and at least one Display Information Container transmitted for each Content Instance.

In a fifth aspect of the invention, a method of displaying navigation information and content item subset list(s) using a graphical user interface (“GUI”) provided by a real-time Navigation Display Engine, for displaying a list/menu for navigating the sorted one or more subset(s) list(s) of multimedia content items based on the active navigation information prepared and communicated by the aforementioned real-time Navigation Processing Engine. The method, embodied in the real-time Navigation Display Engine, enables a user (e.g. viewer, listener, gamer, downloader of multimedia content) to navigate among the subset(s) list(s) of one or more content items actually being displayed currently (herein called the Current Content Items), as well as to obtain information about the subset(s) list(s) of content items that could be displayed (herein referred to as Viewable Content Items) accessible within the active Content Display Matrix (or Matrices), and generally comprises a plurality of display windows, said plurality of display windows comprising an Active Content Item Window as the primary display window (typically, but not necessarily, located in the center of the display) displaying the content item that has been activated by the viewer, an Active Diagonal Information Window displaying information extracted from the aforementioned Display Information Containers and related to content items associated with the active Content Diagonal, a Selected Item Information Window displaying information related to the selected content item, one or more Diagonal Windows, with each such window displaying content items having some common characteristic, such as, but not limited to, a cable television channel with multiple content items comprising television programs arranged according to their scheduled showing times.

In a sixth aspect of the invention, a method of operating the aforementioned navigation display content items lists/menus generated by the real-time Navigation Display Engine to enable a user (e.g. viewer, listener, gamer, downloader of multimedia content) using the GUI to navigate the displayed information contained in the active Content Display Matrix (or Matrices) using navigation functions mapped to, and invoked by pressing remote control buttons, keyboard keys, and/or on-screen button icons connected to a multimedia terminal device of the types specified herein, is disclosed. The method generally comprises a plurality of navigation functions including, but not limited to, a Diagonal Forward or Up function to shift the content item referenced and displayed in the aforementioned content display windows forward, or up, in value by at least one count each time the function is invoked; a Diagonal Reverse or Down function to shift the content item referenced and displayed in the aforementioned content display windows backward, or down, in value by at least one count each time the function is invoked; a Diagonal Rotation Counterclockwise function to position a Content Diagonal into a certain viewing space on the display (said viewing space herein referred to as the Viewable Content Diagonal Space) by rotating at least one Content Diagonal counter-clockwise around the display each time the function is invoked; a Diagonal Rotation Clockwise function to position at least one Content Diagonal into the Viewable Content Diagonal Space by rotating the at least one Content Diagonal clockwise around the display each time the function is invoked; a Diagonal Forward View function to replace at least one Content Diagonal then positioned in the Viewable Content Diagonal Space with a “next” set of one or more Content Diagonal(s) found in an ordered set of Content Diagonals each time the function is invoked; a Diagonal Reverse View function to replace at least one Content Diagonal then positioned in the Viewable Content Diagonal Space with a “previous” set of one or more Content Diagonal(s) found in an ordered set of Content Diagonals each time the function is invoked.

### BRIEF DESCRIPTION OF THE DRAWINGS

FIG. 1 is a block diagram illustrating an exemplary method of organizing information pertinent to the identification, description, characterization, and location of one or more multimedia content item(s) using Content Instances 100, each Content Instance 100 identifying a content item and its location by containing a Content Descriptor 105 and Content Locator 106, to identify, describe, and locate (“point to”) said content item in a multi-dimensional media space 201 comprising a plurality of media planes 202, 203, 204.

FIG. 2 is a block diagram illustrating one exemplary embodiment of the method of organizing and sorting information pertinent to the identification, description, characterization, and location of multimedia content items into a Content Diagonal 301 containing multiple Content Instance Locators 304 and their associated Content View Tokens 303, identifying multiple content items, ordered by time of day, thereby identifying, describing and locating multiple content items scheduled for showing between 6 p.m. and 11 p.m. from a particular cable television channel of a cable television system media plane 203.

FIG. 3 is a block diagram illustrating an exemplary embodiment of the method of organizing and sorting information pertinent to multimedia content items into a Content Diagonal 301 (also referred to as a “Diagonal”), with its identifying Diagonal Header 302, and containing multiple Content Instance Locators 304 and their associated Content View Tokens 303 which identify, describe, characterize and locate a plurality of different content items located in several different media planes, resulting in a Content Diagonal 301 “spanning” the multi-dimensional media space 201.

FIG. 4 is a block diagram illustrating an exemplary embodiment of the method of organizing and sorting information pertinent to multimedia content items into a Content Display Matrix 401 (also referred to as a “Content Matrix” and “Matrix”), with its identifying Matrix Header 402 and containing, for each Content Diagonal 301 included therein, a Diagonal Locator 403 and an associated Diagonal View Token 404.

FIG. 5 is a block diagram illustrating an exemplary embodiment of a Content Matrix Descriptor Chaining method for linking Content Matrix Descriptors 431 together and thereby facilitating the processing of Content Display Matrices 401 by the real-time Navigation Processing Engine 1201 and the real-time Navigation Display Engine 1202 depicted in FIG. 11.

FIG. 6 is a block diagram illustrating the marking of one of three Content Matrix Descriptors 431 marked for removal in the Content Matrix Descriptor Chaining method shown in previous FIG. 5.

FIG. 7 is a block diagram illustrating two remaining Content Matrix Descriptors 431 after one of three Content Matrix Descriptors was marked and removed as shown in the previous FIGS. 5 and 6 respectively.

FIG. 8 is a block diagram illustrating the “sorting operation points” in the multimedia content, creation, storage, distribution, delivery chain where, according to the present invention, sorting algorithms, executed in either a pre-processing or a real-time processing sort operation, may be applied to create, modify, or prepare one or more Content Matrices 401, with such sort operation points including anywhere in the systems and networks comprising the one or more media planes in the multi-dimensional media space, as well as also in the multimedia terminal device itself.

FIGS. 9A through 9C depict a logical flow diagram illustrating one exemplary embodiment of the method of sorting content items to create, modify or prepare one or more Content Matrices 401 as a pre-processing sort operation according to the present invention.

FIGS. 10A through 10H depict a logical flow diagram illustrating one exemplary embodiment of the method of sorting content items to create, modify or prepare one or more Content Matrices 401 as a real-time processing sort operation according to the present invention.

FIG. 11 is a block diagram illustrating an exemplary architecture for receiving multimedia content from a plurality of media planes of the multi-dimensional media space, as well as Viewer Configuration Information 125 and Content Matrices 401 (containing Content Diagonals 301 which contain Content Instances 100), by a real-time Navigation Processing Engine (NPE) 1201 and communicating active display and navigation information, in the form of at least one active Content Matrix 401, containing at least one Content Diagonal 301, accompanied by at least one Display Information Container 192, between the real-time Navigation Processing Engine (NPE) 1201 and the real-time Navigation Display Engine (NDE) 1202. Note that the exemplary architecture does not require that the NPE 1201 and 1202 does not limit or require that the NPE and NDE processing functions be performed at the same location in the multimedia system or multimedia network. Said functions may, in whole or in part, be distributed across said multimedia system or multimedia network.

FIG. 12 is a display screen presentation illustrating one exemplary embodiment of the real-time Navigation Display 1300 layout of an Active Content Item Window 1301, a Selected Item Information Window 1303, an Active Diagonal Information Window 1302, one or more Diagonal Windows 1304, and an Active Diagonal Window 1305.

FIG. 13 is one example of the Navigation Display 1300 screen layout presentation previously shown in FIG. 12 with examples of content item information contained in the plurality of display windows for user-friendly navigation of multimedia content according to the present invention.

FIG. 14 is a block diagram illustrating one exemplary embodiment of the method of operating the Navigation Display 1300 by the real-time Navigation Display Engine 1202 using the Diagonal Forward function to advance through an ordered list of Content Instance Locators 304 contained in a Content Diagonal 301 and shifting-right the list of content items displayed in a Diagonal Window 1304.

FIG. 15 is a block diagram illustrating one exemplary embodiment of the method of operating the Navigation Display 1300 by the real-time Navigation Display Engine 1202 using the Diagonal Reverse function to step backward through an ordered list of Content Instance Locators 304 contained in a Content Diagonal 301 and shifting-left the list of content items displayed in a Diagonal Window 1304.

FIG. 16 is a block diagram illustrating one exemplary embodiment of the method of operating the Navigation Display 1300 by the real-time Navigation Display Engine 1202 using the Diagonal Rotation Counterclockwise function to position at least one Content Diagonal 301 into the Viewable Content Diagonal Space on the Navigation Display 1300 screen by rotating said at least one Content Diagonal 301 counter-clockwise around the Navigation Display 1300.

FIG. 17 is a block diagram illustrating one exemplary embodiment of the method of operating the Navigation Display 1300 by the real-time Navigation Display Engine 1202 using the Diagonal Rotation Clockwise function to position at least one Content Diagonal 301 into the Viewable Content Diagonal Space on the Navigation Display 1300 screen by rotating said at least one Content Diagonal 301 clockwise around the Navigation Display 1300.

FIG. 18 is a block diagram illustrating one exemplary embodiment of the method of operating the Navigation Display 1300 by the real-time Navigation Display Engine 1202 using the Diagonal Forward View function to replace one or more Content Diagonals 301 then positioned in the Viewable Content Diagonal Space with a “next” set of one or more Content Diagonals 301 found in an ordered set of Content Diagonals 301.

FIG. 19 is a block diagram illustrating one exemplary embodiment of the method of operating the Navigation Display 1300 by the real-time Navigation Display Engine 1202 using the Diagonal Reverse View function to replace one or more Content Diagonals 301 then positioned in the Viewable Content Diagonal Space with a “previous” set of one or more Content Diagonals 301 found in an ordered set of Content Diagonals 301.

### DESCRIPTION OF THE PREFERRED EMBODIMENT

Reference is now made to the drawings wherein like numerals refer to like parts throughout.

Overview

The present invention, a Multimedia Content Navigation Tool (“MCNT”), discloses a method and apparatus useful for organizing, sorting, displaying for navigation, navigating and selecting from a plurality of multimedia content items available from a multi-dimensional media space of one or more multimedia content sources (said sources herein also referred to as media planes). Said media planes include, but are not limited to, wired or wireless communications or broadcast systems and networks including, inter alia, cable television, broadcast or other wireless television, satellite television, telephone, cell phone/PCS, and internet protocol (“IP”) networks, including the Internet, systems and networks, as well as multimedia, file, web or video-on-demand server and client computers, and associated storage and communications devices.

The present invention discloses a hierarchy of parameter sets in a multi-dimensional information structure containing characteristics of multimedia content items to particularly identify, describe, characterize and locate each individual content item to organize and sort the content items according to one or more of their characteristics, list a menu of said content items in a graphical illustration display for navigation, and navigate said content item(s) list(s) and select from said listed content item(s) for use (e.g. viewing, listening, downloading, interacting with) using a plurality of navigation functions to navigate, select displayed items within, and operate said display. Such content item characteristics include, inter alia, title/name, identification number, version, short narrative description, date of release or publication, type and class, genre/subject matter, product/good/service type (such as for a content item which is an advertisement or infomercial), location where it can be found, restrictions or entitlements to its use, owner, provider or author, actor or performer, time and duration of availability of the content item, decode/display format/engine, targeted viewer/user demographics, age appropriateness or other content rating, file size, and length of the content item. Information pertaining to the characteristics of content items is represented as variables having values expressed in alphanumeric characters, punctuation symbols, text strings, arithmetic and logical operators, integers, and real numbers contained in one or more information fields within the parameters comprising the parameter sets. Further, parameter sets themselves are contained in other parameter sets to form a hierarchy of parameter sets in the multi-dimensional information structure for identifying, describing, characterizing, and locating each instance of a particular multimedia content item available in the multi-dimensional media space of multiple media planes. This multi-dimensional information structure disclosed is further used to sort, display for navigation, navigate and select said content items according to the present invention, as specified herein.

The present invention discloses a method of sorting multimedia content items available from the multi-dimensional media space by examining and comparing one or more of the information fields contained in the aforementioned parameter sets for the purpose of identifying those content items which match, or otherwise conform to, defined sorting criteria, with said sorting criteria being expressed in the same types, formats and values of the variables contained in the aforementioned information fields. As a result of one or more sorting operations, one or more subset(s) of one or more matching, or otherwise conforming, content items are then placed in one or more ordered lists according to the sorting criteria they matched or otherwise conformed with. The subset ordered list(s) is (are) identified, described and given a location using additional parameter sets in the hierarchy of the multi-dimensional information structure disclosed in the present invention. The subset ordered list(s) is (are) prepared and presented to a multimedia content user (e.g. viewer, listener, gamer) in a graphical illustration display for navigation using the display and navigation method disclosed herein using the multi-dimensional information structure.

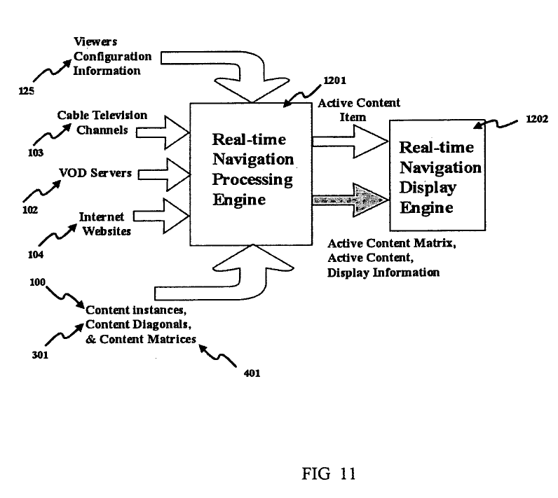

The present invention discloses a method of using a plurality of parameter sets in the multi-dimensional information structure to prepare, present and activate a display presentation, and enable navigation, of the aforementioned subset(s) list(s) of multimedia content items resulting from the aforementioned sorting method, by generating and communicating information identifying, describing, characterizing, and locating said subset(s) of content items, as well as providing additional “active” navigation information and navigation functions required to display and navigate said subset(s) list(s) on a viewable image screen including, inter alia, screens generated by multimedia terminal devices of the type specified herein. The display and navigation method disclosed is embodied in a real-time Navigation Processing Engine 1201 and a real-time Navigation Display Engine 1202, shown in FIG. 11, in one exemplary embodiment of the present invention.

Multimedia Content Navigation Tool Terminology

As used herein, the term “MCNT” or “Multimedia Content Navigation Tool” refers to the overall present invention disclosed.

As used herein, the term ” multimedia content item” or ” content item” refers generally to information comprising any one or a combination of, video, audio, still or moving images, text, symbols or graphics including, but not limited to, a movie, television programming including but not limited to tv series, movies, news, weather and sports, infomercial or tv advertisements about products/goods or services, photograph(s), web page(s), streaming media files, video game(s), software code, map(s), chart(s), musical pieces, speechs, text, and art work images and audio associated with any of the foregoing.

As used herein, the term “multimedia terminal device” refers generally to devices capable of processing, displaying and otherwise reproducing the video, audio and other components of multimedia content items from a multimedia system or multimedia network, and includes, inter alia, set-top boxes, television sets, direct-broadcast satellite television receivers, video game consoles, multimedia computers, portable communications devices, audio players, DVD players, CD burners/players, digital video recorders, video cassette recorders, and any combination of one or more of the foregoing devices.

As used herein, the term “user”, which is interchangeable with and includes, inter alia, “viewer”, “listener”, “gamer”, and “player”, refers generally to a person who, by operating a multimedia terminal device of the type specified herein, uses a multimedia content item, which, depending on the particular content item and multimedia terminal device used, includes any one or more of the following: viewing (such as a movie or television program), listening to (such as a musical piece or audio program), playing or interacting with (such as a video game or interactive content item), or downloading (such as with a downloadable content item or software module) a multimedia content item respectively.

As used herein, the term “multimedia system(s)” refers generally to a group of either wired or wirelessly interconnected or related devices for creating, storing, distributing, or delivering multimedia content items. As examples, and not as a limitation, multimedia systems include, inter alia, a multichannel analog or digital cable television system of headend equipment, coax and fiber cable and transmission devices, a local analog or digital broadcast television station of production studio and transmitter devices, a video-on-demand server computer and associated storage, display and communications devices, a broadband connection to the Internet through cable tv coax cable modem, fiber cable, or multi-pair telephone wire XDSL transmission, routing and switching devices, a file or web server computer and associated storage and communications devices, a satellite television system of uplink, space segment satellite(s), and home satellite receiver devices, a wireless WIFI cell/PCS phone or television system of fixed transmitting-receiving station equipment and portable transmitting-receiving devices, one or more computers interconnected with internet protocol (“IP”) routing, switching, transmission and other networking devices, the Internet world-wide-web or virtual private network (VPN), cameras, microphones and video and audio amplification, recording and storage devices, electronic “magazine rack” systems, electronic library systems.

As used herein, the term “multimedia network(s)” refers generally to a group of the aforementioned wired or wirelessly interconnected or related multimedia systems, as specified above, for the creation, storage, distribution, or delivery of multimedia content items; and, also refers to one or more business entities involved in the creation, storage, distribution, or delivery of multimedia content items, or both. As examples, and not as a limitation, said network(s) include, inter alia, a plurality of local broadcast television stations affiliated with a national broadcast network (e.g. NBC, CBS, ABC, FOX, WB), a plurality of cable tv systems interconnected and operated under a common brand name (e.g. Comcast, Time Warner Cable), a satellite television service operated under a common brand name (e.g. Dish Network), a cable or satellite television programming service (e.g. ESPN, CNBC, CNN, Discovery, HGTV, HBO, Showtime), a movie production and distribution operation (e.g. Universal movie studios, Paramount movie studios, Disney movie studios).

As used herein, the term “media plane(s)”, “multi-media content source(s)” or “content sources” refers generally to one or more multimedia systems or multimedia networks, from which is available for delivery, one or more multimedia content items.

As used herein, the term “multi-dimensional media space” refers generally to one or more of a plurality of media plane(s).

As used herein, the term “hierarchial multi-dimensional information structure” refers generally to a plurality of parameter sets, defined in a multi-level hierarchy, used to contain and manipulate information for organizing, sorting, displaying for navigation, navigating, and selecting content items according to the present invention. Table 1 below depicts an exemplary embodiment of the hierarchial multi-dimensional information structure of the present invention comprising a plurality of parameter sets and their included parameters and information fields used for organizing, sorting, displaying for navigation, and navigating content items.

As used herein, the term “parameter set(s)” refers generally to the information or data structure disclosed, with each parameter set comprising one or more parameters, each parameter containing information fields pertinent to content items, as well as information pertinent to identify the parameter sets themselves.

As used herein, the term information “field(s)” refers generally to the one or more data structure spaces contained in a parameter. Information fields contain variables for identifying, describing, characterizing, and locating content items and the parameters themselves, with such variable values expressed and delimited by alphanumeric characters, punctuation symbols, logical operators, integers, and real numbers.

It should be noted that throughout this specification, terminology and parts/component/element descriptions, including parameter and field names of the disclosed information structure, while consistent in the use of a part number, may be capitalized or in small letters, shortened or abbreviated, or may use alternative cross-referenced names (e.g., Content Display Matrix=Content Matrix=Display Matrix,=Matrix 401) without the intent of altering or modifying their meaning, definition, or function; and, such alternative names, having the same part number, are intended to be interchangeable.

Method of Organizing, Identifying, and Locating Content Items Using a Hierarchial Multi-Dimensional Information Structure

Reference is made to the parameter sets of the hierarchial multi-dimensional information structure comprising the parameters and their respective information fields listed in Table 1 below, wherein like numerals refer to like parameters and included information fields throughout this specification. Each of the parameter sets in the information structure contain one or more parameters, and each of the parameters contains information fields of variables having values expressed in any combination of alphanumeric characters, punctuation symbols, logical operators, algebraic and arithmetic symbols, integers, and real numbers.

### Table 1—Hierarchial Information Structure Parameter Sets

Content Display Matrix (CDM) 401 (also referred to as “Content Matrix”, “Display Matrix”, or “Matrix”) (Organizes available Content Items that can be displayed to a particular viewer.)

| Comprises the following for each CDM: | Purpose or Function of Parameter or Field |
|---|---|
| CDM Header 402 | Header identifying this CDM |
| Content Matrix Name 405, Content | Name, id, version of this CDM |
| Matrix id 406, Content Matrix Version 407 | |
| Display Matrix Availability 408 | Indicates when this CDM info can be |
| | accessed. |
| Display Matrix Duration 409 | Indicates time duration this CDM info is |
| | active. |
| View Token Definition Locator 410 | Points to View Token Definition 307 used |
| | in this CDM |
| Sort Algorithm Locator 411 | Points to Sort Algorithm 420 used by this |
| | CDM. |
| | Sort Algorithm 420 contains the number of |
| | algorithm entities therein, with each entity |
| | defining the logic operation of the |
| | algorithm. |
| Current Root Diagonal Number 412 | Designates Current Root Diagonal |
| 1 to n CDVT 404 with associated 1 to n | Content Diagonal View Token (CDVT) |
| CDL 403 pointing to 1 to n CDs 301 | 404 and an associated Content Diagonal |
| | Locator (CDL) 403 for each of the one or |
| | more (i.e., 1 to n) Content Diagonals (CD) |
| | 301 contained in this CDM. |
| | One CDVT 404 reflects the View Tokens |
| | 303 of the Content Items contained in each |
| | CD and thereby defines the content |
| | characteristics of the overall CD. |
| | One CDL 403 points to the location of each |
| | CD contained in this CDM. |
| | The CDL 403 contains at least the |
| | following “Locator Information Fields”: |
| | media plane 141: defines source. |
| | delivery type 142: defines delivery means. |
| | location 143: specific location details. |
| | availability 144: defines when accessible. |
| | duration 145: time span of active status. |
| | search type 146: search technique used. |
| | access security 147: security level to |
| | access: i.e. free, protected, locked, |
| | unlocked, subscription, CAS protected, |
| | pay-per-view. |

Content Diagonal (CD) 301 (also referred to as “Diagonal”)

(Contains an ordered list of CILs 304s, each of which point to a unique CI 100.)

| Comprises the | |
|---|---|
| following for each CD: | Purpose or Function of Parameter or Field |
| CD Header 302 | Header identifying this CD |
| Diagonal Name 305, | Name, id of this CD |
| Diagonal id 306 | |
| 1 to m CVTs 303 with | A Content Instance (CI) 100 describes and |
| associated 1 to m | locates a Content Item. |
| CILs 304 pointing | Any number, m, of CIs may be contained in |
| to 1 to m CIs 100 | a CD. |
| | Content item View Token (CVT or VT) |
| | 303 and an associated Content Instance |
| | Locator (CIL) 304 for each of the one or |
| | more (i.e, 1 to m) Content Instances 100 |
| | contained in this Content Diagonal. A VT |
| | 303 defines the content characteristics of its |
| | associated Content Instance 100. A CIL |
| | 304 points to the location of a Content |
| | Instance 100. Each CIL 304 contains at |
| | least the following previously defined |
| | “Locator Information Fields”: media plane, |
| | delivery type, location, availability, |
| | duration, search type, access security. |

Content Instance (CI) 100 (Describes and locates a particular Content Item.)

| Comprises the | |
|---|---|
| following for each CI: | Purpose or Function of Parameter or Field |
| Content Descriptor | Describes a particular Content Item and |
| (CDES) 105 | includes, inter alia, the following: |
| | Name 107: content item name |
| | Id 108: content item identification |
| | version # 109: content item version # |
| | class 110: e.g., inter alia, “sports |
| | event”, . . . |
| | type 111: e.g., inter alia, “baseball”, |
| | tennis, . . . |
| | engine descriptor 112: decode/processing |
| | format/engine . . . e.g., mpeg 2, dolby 5.1, . . . |
| | provider id 113: content provider id |
| | owner id 114: content owner id |
| | genre 115: e.g. mystery, action, romance |
| | appropriateness 116: content rating or age |
| | usage descriptor 117: rules for use by users |
| | text descriptor 118: text describing content |
| | demographics 119: target demographics |
| Content Locator (CL) | Locates the particular instance of a Content |
| 106 | Item in a multi-dimensional media space |
| | and contains at least the following “Locator |
| | Information Fields”: |
| | media plane 141: defines source. |
| | delivery type 142: defines delivery means. |
| | location 143: specific location details. |
| | availability 144: defines when accessible. |
| | duration 145: time span of active status. |
| | search type 146: search technique used. |
| | access security 147: security level to |
| | access: i.e. free, protected, locked, |
| | unlocked, subscription, CAS protected, |
| | pay-per-view. |

Real Time Content Matrix Descriptor (RTCMD or CMD) 425

(Contains info about a Content Matrix received by Navigation Processing Engine.)

| Comprises the following for each CMD: | Purpose or Function of Parameter of Field |
|---|---|
| Matrix Tag 426 | Identifies a particular Content Matrix 401 |
| Matrix Status 427 | Describes status of the Content Matrix 401 |
| | and any modifications to it that may exist. |
| | Status includes: “matrix unavailable”, |
| | “original matrix available”, “matrix |
| | modifications available”. |
| Matrix Information Locator 428 | Points to the location of the Matrix |
| | Information Data 450 and contains at least |
| | the following previously defined “Locator |
| | Information Fields”: media plane, delivery |
| | plane, location. |
| Previous Matrix Descriptor Locator | Points to the location of the Previous |
| (PMDL) 429 | Matrix Descriptor 432, and, along with the |
| | NMDL 430, links CMDs 425 together in a |
| | chain for sequential processing by the real- |
| | time Navigation Processing Engine 1201 |
| | and Navigation Display Engine 1202. |
| | Points to the Content Matrix Descriptor |
| | 425 of the Content Matrix 401 which |
| | entered the Navigation Processing Engine |
| | 1201 before it. |
| | The PMDL 429 contains at least the |
| | following previously defined “Locator |
| | Information Fields”: media plane, delivery |
| | type, location. |
| Next Matrix Descriptor Locator (NMDL) | Points to the location of the Next Matrix |
| 430 | Descriptor 433, and, along with the PMDL |
| | 429, links CMDs together in a chain for |
| | sequential processing by the real-time |
| | Navigation Processing Engine 1201 and |
| | Navigation Display Engine 1202. |
| | Points to the CMD 425 of the Content |
| | Matrix 401 which is to enter the Navigation |
| | Processing Engine after it. |
| | The NMDL 430 contains at least the |
| | following previously defined “Locator |
| | Information Fields”: media plane, delivery |
| | type, location. |

Matrix Information Data (MID) 450 (Contains information about a particular Content Matrix 401)

| Comprises the | |
|---|---|
| following for each MID: | Purpose or Function of Parameter or Field |
| Original Content Matrix | Points to the location of the Original |
| Locator (OCML) 451 | Content Matrix 456 and contains at least |
| | the following previously defined “Locator |
| | Information Fields”: media plane, delivery |
| | type, location. |
| Original Content Matrix | Contains list of viewers/users, as defined |
| Viewer List (OCMVL) 452 | by their respective viewer id, which are |
| | approved to view/use the content items |
| | contained in the Original Content Matrix |
| | 456, with such approval being attained |
| | when the designated View Filter |
| | successfully filters said Original Content |
| | Matrix 456. |
| | A viewer id 128 is a text field containing |
| | viewer's identification, which can be a |
| | name that the viewer has chosen. |
| Number of Modifications | Indicates the number of modifications, |
| 453 | from 1 to w, that have been performed on |
| | the Original Content Matrix 456. |
| 1 to w CMMLs 454 with | A Content Matrix Modification Locator |
| associated 1 to | (CMML) 454 and an associated Modified |
| w MCMVLs 455 | Content Matrix Viewer List (MCMVL) 458 |
| | for each of the one or more (i.e., 1 to w) |
| | modifications made to the Original Content |
| | Matrix 456. The CMML 454 points to the |
| | location of a Modified Content Matrix 457 |
| | and contains at least the following |
| | previously defined “Locator Information |
| | Fields”: media plane, delivery type, |
| | location. |
| | The MCMVL 455 contains a list of |
| | viewers/users, as defined by their |
| | respective viewer id, which are approved to |
| | view the content items contained in the |
| | Modified Content Matrix 457, with such |
| | approval being attained when the |
| | designated view filter successfully filters |
| | said Modified Content Matrix 457. |

Viewer Configuration Information (VCI) 125

(Provides a list of viewer/user preferences, restrictions, entitlements used to define how the real-time Navigation Display Engine displays the list/menu of Content Items.)

| Comprises the following | |
|---|---|
| for each VCI: | Purpose or Function of Parameter or Field |
| Viewer Filter Definition | Points to the location of the View Filter |
| Locator (VFDL) 126 | Definition (VFD) 150 and contains at least |
| | the following previously defined “Locator |
| | Information Fields”: media plane, delivery |
| | type, location. |
| Number of Configured | Indicates the number of viewers/users that |
| Viewers (NCV) 127 = q | have performed the viewer configuration |
| | operation. |
| 1 to q Viewer IDs 128 with | For one or more (i.e., 1 to q) viewers, |
| associated | contains, for each viewer, at least the |
| 1 to q VCDLs 130, | following locators to find each particular |
| 1 to q VFLs 129, and | viewer's configuration, view filter, and |
| 1 to q VDDLs 182 | display descriptor: |
| | Viewer Configuration Descriptor Locator |
| | (VCDL) 130 points to the location of the |
| | descriptor for the particular viewer's |
| | configuration and contains at least the |
| | following previously defined “Locator |
| | Information Fields”: media plane, delivery |
| | type, location. |
| | Viewer Filter Locator (VFL) 129 points to |
| | the location of the particular viewer's view |
| | filter 155 and contains at least the |
| | following previously defined “Locator |
| | Information Fields”: media plane, delivery |
| | type, location. |
| | Viewer Display Descriptor Locator |
| | (VDDL) 182 points to the location of the |
| | particular viewer's Viewer Display |
| | Descriptor 180 and contains at least the |
| | following previously defined “Locator |
| | Information Fields”: media plane, delivery |
| | type, location. |

View Filter Definition (VFD) 150

(Provides the format and information field definitions for a View Filter.)

| Comprises the following for each VFD: | Purpose or Function of Parameter or Field |
|---|---|
| Number of Filter Values (NFV) 151 = x | Indicates the number of View Filter |
| | Reference 153 that are defined in this VFD. |
| Number of View Filter Reference | Indicates the number of defined values for |
| Definitions (NVFRD) 152 = j | a given View Filter Reference 153. |
| 1 to x View Filter Values 157 with | For each of one or more (i.e., 1 to x) Filter |
| associated | Values 157, defines an associated View |
| 1 to x View Filter References (VFR) 153 | Filter Reference 153. |
| | A View Filter Reference 153 defines the |
| | parameter or field to be evaluated in the |
| | View Filter 155, such as “genre”. |
| | For each of one of more (i.e., 1 to j) View |
| | Filter Reference Definitions 158, defines an |
| | associated View Filter Reference Value |
| | Definition 154. |
| | A View Filter Reference Value Definition |
| | 154 contains a name corresponding to a |
| | particular type of the View Filter Reference |
| | 153. |

Viewer Configuration Descriptor (VCD) 131

(Contains text describing a particular viewer's preferences, restrictions, entitlements.)

| Comprises the | |
|---|---|
| following for each VCD: | Purpose or Function of Parameter or Field |
| Number of Entities 132 = i | Indicates the number of text types and |
| | associated text strings contained in this |
| | VCD. |
| 1 to i text string types with | For each of one or more (i.e., 1 to i) text |
| associated 1 to i text strings | string types, contains an associated text |
| | string which provide configuration |
| | information applicable to a particular |
| | viewer, such as, inter alia, the viewer's |
| | name, gender, age, favorite class, favorite |
| | genre, etc . . . in alphanumeric text string |
| | format. |

View Filter (VF) 155_(Provides the algorithm used to verify that each CD and each CI contained in the Active Content Matrix meets a particular viewer's configuration requirements.)

| Comprises the | |
|---|---|
| following for each VF: | Purpose or Function of Parameter or Field |
| Number of Filter Entries | Indicates the number of Filter entities |
| (NFE) 156 = a | contained in this View Filter. |
| Filter Entity 159 | For each of one or more (i.e., 1 to a) Filter |
| | Entries, contains an associated one of the |
| | view filter references 153 defined in the |
| | View Filter Definition 150, with each of |
| | the one or more view filter references 153 |
| | containing logic operators and logic field |
| | separators. |

Viewer Display Descriptor (VDD) 180 (Contains the definition of information to be displayed by the real-time Navigation Display Engine for a particular viewer.)

| Comprises the | |
|---|---|
| following for each VDD: | Purpose or Function of Parameter or Field |
| Number of Entities 181 = b | Indicates the number of text string entities |
| | contained in this VDD. |
| 1 to b text strings | 1 to b text strings of information applicable |
| | to a particular viewer. |

Display Information Array (DIA) 190 (Contains an array of information, arranged into a set of Display Information Containers used by the real-time Navigation Display Engine for creating the actual display fields.)

| Comprises the | |
|---|---|
| following for each DIA: | Purpose or Function of Parameter or Field |
| Number of Display | Indicates the number of Display |
| Information Containers | Information Containers 192 contained in |
| (NDIC) 191 = c | this DIA. |
| 1 to c Display Information | For each of one or more (i.e., 1 to c) Display |
| Containers 192 | Information Containers 192, defines the |
| with associated | Container Type 193 (as either a diagonal or |
| 1 to c Container Types 193 | instance container) and its associated one |
| | or more Display Information Container |
| | Descriptor(s) 194. |
| | A Display Information Container |
| | Descriptor 194 provides the display |
| | configuration information applicable to a |
| | particular viewer and comprises one or |
| | more test string type(s) and their associated |
| | text string(s). |

Hierarchial Information Structure List of Parameters and Information Fields:
100 Content Instance (CI); 105 Content Descriptor (CDES); 106 Content Locator (CL); 107 Content item name; 108 Content item id; 109 Content item version; 110 Content item class
111 Content item type; 112 Content item engine descriptor; 113 Content item provider id; 114 Content item owner id; 115 Content item genre; 116 Content item appropriateness; 117 Content item usage descriptor; 118 Content item text descriptor; 119 Content item targeted viewer demographics; 125 Viewer Configuration Information (VCI)
126 Viewer Filter Definition Locator (VFDL); 127 Number of Configured Viewers (NCV); 128 Viewer id (Vid); 129 Viewer Filter Locator (VFL); 130 Viewer Configuration Descriptor Locator (VCDL); 131 Viewer Configuration Descriptor (VCD); 132 Number of VCD text type entities and associated text strings.
“Locator Information Fields” (141 to 147): 141 media plane; 142 delivery type; 143 location 144 availability; 145 duration; 146 search type; 147 access security
150 View Filter Definition (VFD); 151 Number of Filter Values (NFV);
152 Number of View Filter Reference Definitions (NVFRD); 153 View Filter References (VFR)
154 View Filter Reference Value Definition (VFRVD); 155 View Filter (VF); 156 Number of Filter Entities (NFE); 157 View Filter Value (VFV); 158 View Filter Reference Definitions.
180 Viewer Display Descriptor (VDD); 181 Number of VDD text entities (NVDDE)
182 Viewer Display Descriptor Locator (VDDL).
190 Display Information Array (DIA); 191 Number of Display Information Containers (NDIC)
192 Display Information Containers (DIC); 193 Container Type (CT)
194 Display Information Container Descriptor (DICD)
201 Multi-dimensional Media Space (MMS); 202 Media File Server System and Network Media Plane; 203 Cable Television System and Networks Media Plane; 204 Internet System and Network Media Plane
301 Content Diagonal (CD) or Diagonal; 302 Diagonal Header (DH); 303 Content View Token (CVT) or View Token (VT); 304 Content Instance Locator (CIL); 305 Diagonal name; 306 Diagonal id; 307 View Token Definition (VTD)
401 Content Display Matrix (CDM) or Content Matrix, or Display Matrix, or Matrix
402 Matrix Header, or Content Matrix Header; 403 Content Diagonal Locator (CDL)
404 Content Diagonal View Token (CDVT) or Diagonal View Token; 405 Matrix name; 406 Matrix id; 407 Matrix version; 408 Matrix availability; 409 Matrix duration
410 View Token Definition Locator (VTDL); 411 Matrix Sort Algorithm Locator, or Sort Algorithm Locator (SAL); 412 Current Root Diagonal Number; 420 Matrix Sort Algorithm (MSA), or Sort Algorithm; 425 Real-time Content Matrix Descriptor (RTCMD)
426 Matrix Tag (MT); 427 Matrix Status (MS); 428 Matrix Information Locator (MIL)
429 Previous Matrix Descriptor Locator (PMDL); 430 Next Matrix Descriptor Locator (NMDL); 431 Content Matrix Descriptor (CMD); 432 Previous Matrix Descriptor (PMD)
433 Next Matrix Descriptor (NMD); 434 View Token Reference Value Definition (VTRVD)
435 Number of Token Values (NTV); 436 Token Reference (TR); 437 Number of Token Reference Values (NTRV); 450 Matrix Information Data (MID); 451 Original Content Matrix Locator (OCML); 452 Original Content Matrix Viewer List (OCMVL); 453 Number of Content Matrix Modifications (NCMM); 454 Content Matrix Modification Locator (CMML);
455 Modified Content Matrix Viewer List (MCMVL); 456 Original Content Matrix (OCM)
457 Modified Content Matrix (MCM); 458 Modified Content Matrix Locator (MCML)
459 Real-time Content Matrix Database (CMDbase); 460 Matrix Modification Database (MMDbase)
501 Active Content Matrix (ACM); 502 Active Content Matrix Sort Algorithm (ACMSA)
503 Active Content Matrix Display Algorithm (ACMDA)

Content Instances:

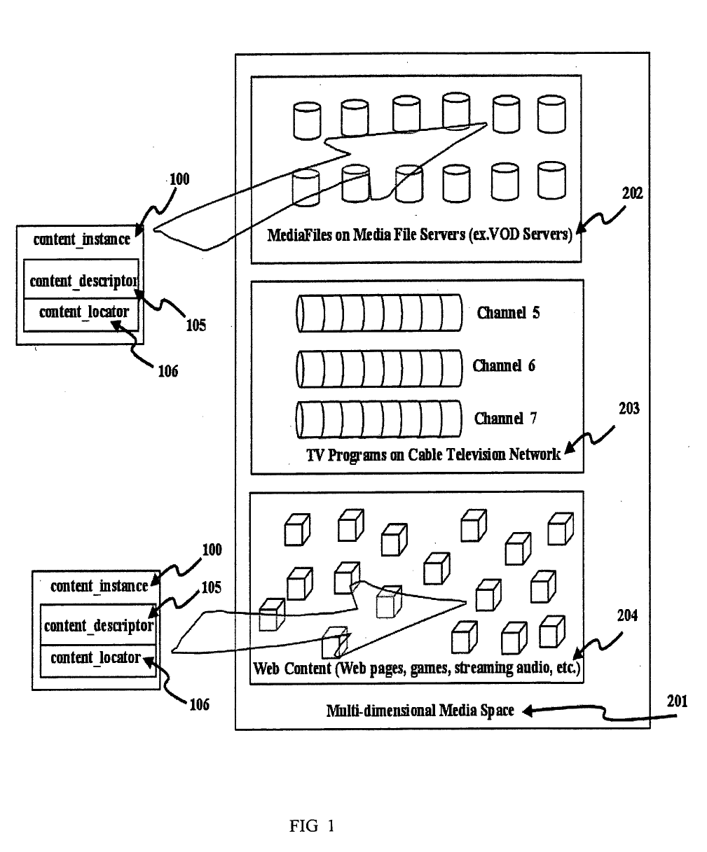

Referring now to FIG. 1, Content Instance 100 parameter set containing a Content Descriptor 105 parameter and an associated Content Locator 106 parameter identifies, describes and locates one instance (i.e. one existence, occurrence) of a particular content item within a media plane of a multi-dimensional media space 201, which such multi-dimensional media space includes, but is not limited to, the Media Files and Video Servers media plane 202, the TV Programs on Cable Television Network media plane 203, and the Web Pages, Games, Streaming Audio on the Web Content media plane 204 in FIG. 1.

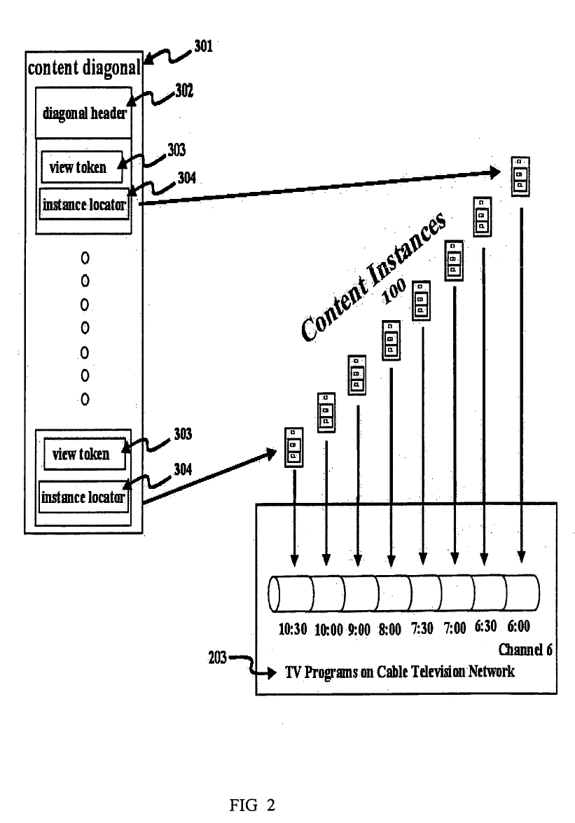

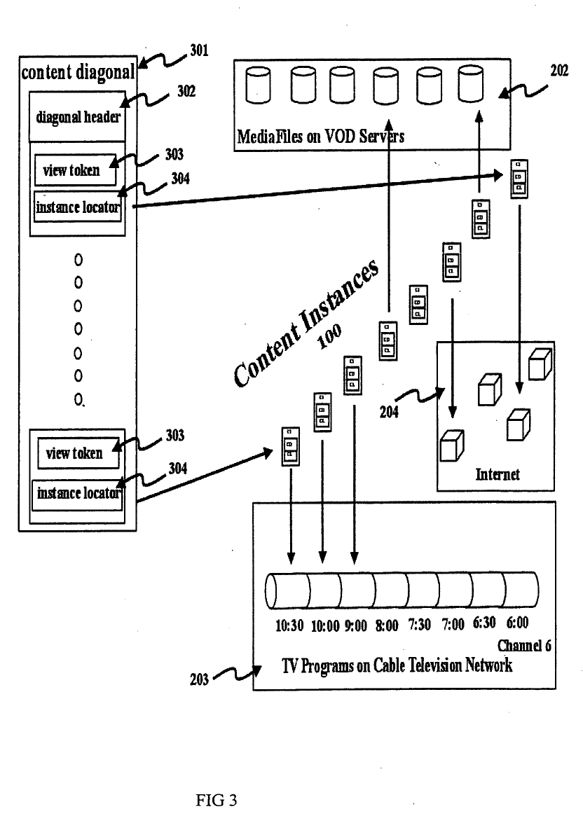

A particular content item may be located (i.e. exist) in more than one location within a particular media plane and in more than one media plane, and, therefore, may be represented by more than one Content Instance 100. Although a particular content item, for example, a particular episode of a sitcom television series, may be in more than one location, a particular location in a media plane will contain only one content item. A Content Instance Locator 106 defines the location of a particular Content Instance 100. A Content Descriptor 105 parameter set identifies and describes a content item. As an example, a content item located in two media plane locations may have two Content Instances 100, each having a similar Content Descriptor 105, but a different Content Locator 106. In the FIG. 1, a Content Instance 100 “points to” a content item, which is a file located in a first media plane of three media planes comprising the multi-dimensional media space 201 shown in the figure, here said first media plane 202 being a multimedia network of file servers and video-on-demand servers containing, inter alia, a plurality of media files as content items. Also, in FIG. 1, a second Content Instance 100 “points to” a second content item, which is a web page, streaming media file, or video game located in a second media plane of the multi-dimensional media space, here said second media plane 204 being the Internet world-wide-web containing, inter alia, a plurality of web pages, on-line or downloadable games, and streaming video/audio files as content items. Also shown in FIG. 2 is a third media plane 203 of the multi-dimensional media space, here being a cable television network having multiple channels with each channel having multiple television programs scheduled by time of day as the content items. Although not shown in the figure, a third Content Instance 100, itself identifying a content item, could be used to “point to” said content item found in the aforementioned third media plane 203. Note also, that a particular content item may be represented by more than one Content Instance 100, with each such Content Instance 100 having a similar Content Descriptor 105 but a different Content Locator 106, thereby “pointing to” more than one location in more than one media plane indicating that a particular content item is located and available from multiple sources. As previously described, this would occur in such case as a movie or a sitcom that is available for viewing anytime from a video-on-demand server, but is also scheduled as a television program showing at a specific time of day, or a video clip that is both available as a downloadable file from one file server at a site on the Internet world-wide-web and as a real time media stream from a streaming media server located at a different site on the web.

The Content Instance 100 parameter set comprises a Content Descriptor 105 parameter, identifying and describing the content item, and a Content Locator 106 parameter, defining the location of the content item, and is expressed as follows:
Content_Instance(x)={content_descriptor(y), content_locator(z)}

FIG. 2 depicts two Content Instances 100, each Content Instance 100 describing a particular content item in a particular location, with one located on the Media/VOD Server media plane 202 and the other located on the Internet Web Content media plane 204 in the multi-dimensional media space 201.

A Content Instance 100 is assigned to each instance (occurrence, existence) of a particular content item, although a particular content item may have one or more Content Instances 100 if it is located in multiple locations within one media plane or within multiple media planes in the multi-dimensional media space. For example, a movie that is available from both a video-on-demand server of media plane 202 and is also scheduled for showing at a specific time on a cable tv channel of media plane 203 would have two Content Instances 100. In this example, both Content Instances 100 may have the same Content Descriptor 105, but each one would have a different Content Locator 106.

The descriptive information particular to a multimedia content item is contained in the Content Descriptor 105 parameter comprising a plurality of information fields, which fields together describe a particular multimedia content item. In an exemplary embodiment of the present invention, the Content Descriptor 105 parameter contains a plurality of fields containing at least the following information expressed as follows:
Content_Descriptor( )={content_name, content_id, version_number, content_class, content_type-descriptor( ), content_engine_descriptor( ), provider_id, owner_id, genre, appropriateness, user_demographics, content_usage_desciptor( ), content_text_descriptor( )}

In said exemplary embodiment, the fields of the Content Descriptor 105 parameter contain the following types of variable values:
The content_name 107 is a text string that contains the formal name of the content item.
The content_id 108 is a unique alphanumeric value used to identify the content item.
The version_number 109 is an alphanumeric value indicating the version of the content item.
The content_class 110 is a text string containing the class of the content. The content class subdivides the set of all available content items into distinct classes. Content_classes include, inter alia, {“movie”, “news”, “sports event”, “weather”, “television series”, “infomercial or advertisement”, “interactive game”, “magazine”, “website”, “music video”, “radio program”, “musical piece”, “concert event”, “software module”, “streaming media file”}. It is anticipated that the set of content classes may be altered to include other classes without departing from the spirit and scope of the invention.

Each content_class comprises a set of one or more associated content types and the content_type_descriptor( ) 111 contains information describing the type of the content item. As an example, and not as a limitation of the invention, the set of content types associated with the “sports event” content_class includes, inter alia, {baseball, basketball, football, soccer, track, golf, fishing, rugby, boxing, wrestling, cycling, tennis}. As another example and not as a limitation, the set of content types associated with the “movies” content_class includes, inter alia, {full-length feature film, made-for-tv, short}. As yet another example and not as limitation, the set of content types associated with the “infomercial or advertisement” content_class includes, inter alia, {product, good, service, general information}. {According to the invention, the specific data format, type and structure for the content_type_descriptor may be different for each content_class. It is anticipated that the set of content types associated with a particular content class may be altered to include additional content types, as well as the data format, type and structure of their associated descriptors may be altered, without departing from the spirit and scope of the invention.

The content_engine_descriptor( ) 112 contains information describing the content engine or format necessary to properly or accurately decode, process, display, reproduce, or enable usage of, the content item. The content_engine_descriptor comprises a set of pairs defining the content engines necessary to process the content item, and contains at least the following information expressed as follows:
content_engine_descriptor( )={number_of entities; for (i=0; i++,i<number_of entities) {content_engine, content_coding}}

As an example of a particular content_engine descriptor, and not as a limitation of the invention, if the content item is a digitally compressed movie, then the content_engine descriptor would contain at least the following information expressed as follows:
content_engine_descriptor={2, “video_engine”, “mpeg_{—}2_std”, “audio_engine”, “dolby_stereo_surround”}

The provider_id 113 is an alphanumeric value uniquely identifying the provider of the particular content item.

The owner_id 114 is an alphanumeric value uniquely identifying the owner of the particular content item.

The genre field 115 is a text string containing the genre, or the subject matter, of the particular content item. As an example and not as a limitation, genre for the “movie” content-class includes, inter alia, {western, mystery, action, science-fiction, documentary}. As another example, and not as a limitation, the subject matter for the “infomercial or tv advertisement” content_class and “product” content_type may include, inter alia, {automobile, tires, appliance, toothpaste}

The appropriateness field 116 is an integer indicating the minimum appropriate age of the viewer for the content item. As an example and not as a limitation of the invention, an appropriateness value of 9 would indicate that the content item was appropriate for viewers age 9 and above, but was inappropriate for viewers below the age of 9. As yet another example, and not as a limitation, the appropriateness field may contain more than one integer to define an age range. As another example and not as a limitation, the appropriateness field may contain a value indicating the rating number relating to a content rating system such as for video games or television shows.

As another example, a viewer_demographics field(s) 117 contains information comprising a set of integer codes with defined meanings regarding viewer demographics including, inter alia, viewer gender, age range, ethnic background, geographic region, income level range, product/good/service/or information interest of the intended or targeted viewer (or user) of the content item, as well as such other information items pertinent to the target market for the particular product, good, service, or information that is the subject of the content item. The viewer_demographics field for a particular content item can be compared to the Viewer Profile as the sorting criteria used by the sorting operation according to the present invention to determine those infomercials or advertisements targeted to a particular viewer.

The content_usage_descriptor( ) 118 contains information comprising a set of pairs defining the rules governing the usage of the content item, such as, by way of example and not as a limitation of the invention, service entitlements or access restrictions applying to the particular content item. The content_usage_descriptor contains at least the following information expressed as follows:
content_usage_descriptor( )={number_of_entities; for (i=0; i++,i<number_of_entities) {usage_type, usage_rule,}}

As one example, and not as a limitation of the invention, if a particular content item offered in a premium subscription cable tv program service can only be viewed by paid premium subscribers, and only viewed on certain dates for a certain time period (in this example, for a duration of two hours anytime during the month of August, 2003), the applicable content_usage_descriptor would be
content_usage_descriptor={4, “subscription”, ” premium”, start date”, “08012003”, “end date”, “08312003”, “max time per use”, “120”}

The content_text_descriptor( ) 119 contains text describing characteristics of the particular content item including, inter alia, title, brief summary narrative, rating, year of first publication release, key actors or performers, director, production studio, category, license window duration, per use price, maximum authorized period for viewing. The content_text descriptor contains at least the following information expressed as follows:
content_text_descriptors( )={number_of_entities; for (i=0; i++,i<number_of_entities) {text_string_type, text_string( ),}

As an example and not as a limitation of the invention, for a content item that is a movie, the content_text_descriptor would be expressed as:
content_text_descriptor={14, “Title”, “Joe's Big Adventure”, “Summary_short”, “Joe is a teenager who learns about growing up during a summer vacation when he discovers a buried treasure and meets the girl of his dreams”, “Rating”, “PG”, “Year”, “2002”, “Actors”, “Cage, Nicholas”, “Actors”, “Cruz, Penelope”, “Actors”, ““Jones, Barns”, “Director”, “Flintstone, Fred”, “Studio”, “Universal Studio“”, “Category”, “New Releases/Comedy”, “License Window Start”, “04032003”, “License Window End”, “08312003”, “Price”, “3.95”, “Max Authorized Viewing Period”, “24:00:00”}

Referring again to FIG. 2, any particular content item may be available from one or more locations in one or more media planes in the multi-dimensional media space 201. As one example and not as a limitation, a particular episode of the vintage television program series, “My Three Sons”, may be a content item choice available from a Video On Demand (VOD) server media plane 202, a downloadable file from an Internet website on the Web Content media plane 204, a program scheduled at 8:30 PM on a cable channel 53, and a program scheduled at 10:00 AM on cable channel 355 from a Cable Television Network media plane 203.

The Content Locator 106 parameter describes the location of an instance of a particular content item in a multi-dimensional media space. In one exemplary embodiment of the present invention, the Content Locator 106 parameter comprises a plurality of parameters containing at least the following information expressed as follows:
content_locator(z) {media_plane, delivery_type, location( ), availability( ), duration( ), search_type( ), access_security( )}

In said exemplary embodiment, the information fields of the Content Locator 106 parameter contains the following types of variable values:

The media_plane 141 indicates the media plane where an instance of a particular content item is located, including, inter alia, {broadcast television channels, cable television channels, satellite television channels, wireless television channels, telephony television channels, local, regional, national, and international video-on-demand servers, the Internet, digital video recorder, video cassette recorder, DVD, CD, electronic library, electronic magazine rack}. Media planes contemplated by the present invention are specified elsewhere herein. Additional media planes are contemplated by and easily accommodated by the methods disclosed in this invention without departing from its spirit and scope.

The delivery_type 142 indicates the means of delivery, typically associated with the media plane, used to deliver or access the particular content item, including, inter alia, {cable television A, cable television B, satellite A, satellite B, broadcast television, telephony A, telephony B, wireless network A, wireless network B, wired LAN, wired WAN, cable modem A, cable modem B, DSL modem A, DSL modem B, satellite modem A, satellite modem B, USB A, USB B, communications port A, communications port B, Firewire 1394 A, Firewire 1394 B, local storage device A, local storage device B, removable media player A, removable media player B, removable media carousel A, removable media carousel B}. Additional delivery types are contemplated by and easily accommodated by the methods disclosed in this invention without departing from its spirit and scope.

The location( ) 143 information field identifies the specific location of the particular content item in the specified media plane and used to obtain delivery of the content item from said media plane location via the specified delivery type. If a particular content item is located in several locations in one media plane or in several media planes, thereby resulting in more than one location detail, then the multiple location details are applied in the order listed in the location( ) field. The location( ) field contains at least the following location detail information expressed as follows:
location( )={number_of_entities; for (i=0; i++,i<number_of_entities) {location_detail}}

As an example and not as a limitation of the invention, the location detail includes values identifying, inter alia, {depository address, channel number, URL, file name or number, data base address, track number, reference number}. It is anticipated that the set of location detail values may be altered to include other forms of locating information, which are contemplated and easily accommodated without departing from the spirit and scope of the invention.

The availability( ) 144 information field comprises a set of pairs defining the rules governing when the content item can be accessed, and contains at least the following information expressed as follows:
availability( )={number_of_entities; for (i=0; i++,i<number_of_entities) {availability_detail, availability_value,}}

As an example and not as a limitation of the invention, the availability( ) field contains detail information fields including, inter alia, values defining the following availability opportunities: “always”, “time limited”, “real-time limited”, “when loaded”. In this example, if the availability of the particular content item is “always” or “when loaded”, then the availability_detail information field value is set to zero. It should be noted that there may be times when an “always available” content item is not accessible due to technical reasons. As another example, if the availability of the content item is “time limited”, then the availability_detail information field value indicates the time period that the particular content item is available. In yet another example, if the availability of the content item is “real-time”, then the availability_detail information field value indicates the “clock time” that the content item is available; or, if the content item is streaming media or broadcast content, the availability_detail information field value indicates the time that the content item starts.

The duration( ) 145 field indicates the duration of time that a streaming media or broadcast content item will be active.

The search_type( ) 146 field is a text string containing the name of a search technique used to locate the content item, with said search technique also utilizing the other information contained in the information fields of the location( ) parameter.

The access_security( ) 147 field contains an ordered list of security access information used to determine whether the user has the necessary security clearance to access the content item. The access security field contains at least the following information expressed as follows:
access_security( )={number_of_entities; for (i=0; i++,i<number_of_entities) {security_detail,}}
Values of the security_detail information field include, inter alia, “Free-to-air”, “Unprotected”, “Protected”, “Locked”, “Unlocked”, “Subscription Required”, “CAS Protected”, “Pay-per-view”.

In an exemplary embodiment of the invention, the foregoing security_detail values are defined as follows:
“Free-to-air” indicates that the content item is freely available to all users and there is no security action necessary to access the content item.
“Unprotected” indicates that the content item is not currently protected by security measures.
“Protected” indicates that the content item is protected by security measures, and additional security information is needed to access the content item.
“Locked” indicates that the content item is protected and currently locked and cannot be viewed without applying an unlocking process.
“Unlocked” indicates that the content item is protected, but currently unlocked and accessible for use.
“Subscription Required” indicates the content item is protected and is part of a subscription service, whereby only valid subscribers have the necessary information needed to access the content item.
“CAS protected” indicates that a conditional access system (CAS) protects the content item and interaction with the CAS is required to access the content item.
“Pay-per-view” indicates that the content item is available on a pay-per-view or pay-per use basis, requiring a financial transaction before the content item can be accessed.

It is anticipated that the set of possible access security_detail information field values may be altered to include other values and associated access definitions, which are contemplated and accommodated without departing from the spirit and scope of the invention.

Locator Information Fields

It should be noted and recognized in the specifications following, that the definitions of the foregoing information fields, namely the media_plane 141, delivery_type 142, location( ) 143, availability( ) 144, duration 145, search_type 146, and access_security 147, collectively referred to as the “Locator Information Fields” (“LIF”), apply to other locator parameters in the disclosed hierarchial multidimensional information structure, except that their reference pertains to the particulars of the specific locator to which they are applied. Therefore, repeated reference to these LIF definitions will be made, in the specifications and the parameter tables of FIG. 1, as to the other locators to which they apply are defined and explained in the specifications following, but, without continually or numerously repeating the definitions in favor of specification efficiency. In summary, the foregoing LIF definitions apply, with modifications particular to the locator parameter, to the following locator parameters including, but not limited to: Content Locator (CL) 106, Content Instance Locator (CIL) 304, Content Diagonal Locator (CDL) 403, View Token Definition Locator (VTDL) 410, Matrix Information Locator (MIL) 428, Previous Matrix Descriptor Locator (PMDL) 429, Next Matrix Descriptor Locator (NMDL) 430, Original Content Matrix Locator (OCML) 451, Content Matrix Modification Locator (CMML) 455, Viewer Filter Definition Locator (VFDL) 126, Viewer Configuration Descriptor Locator (VCDL) 130, View Filter Locator (VFL) 129, Viewer Display Descriptor Locator (VDDL) 182.

Content Diagonals

A Content Diagonal 301 parameter set characterizes and locates one or more Content Instances 100, containing a Diagonal Header 302 for its identification, as well as an ordered list containing both a Content Instance Locator 106 and an associated Content View Token 303 for each of the one or more Content Instances 100 contained in (i.e. assigned to) the Content Diagonal 301. The Content Instance Locator 106 points to the content item location in a media plane and the Content View Token 303 characterizes the content item for purposes of comparison to a defined sorting criteria. The assignment of a Content Instance 100 to a particular Content Diagonal 301 is based on its respective Content View Token 303 which defines characteristics common to all other Content Instances 100 contained in the particular Content Diagonal 301, although any particular Content Diagonal 301 may contain Content Instances 100 from one or more media planes.

Content Display Matrix (Also Referred to as Content Matrix or Matrix)

Another parameter set, a Content Display Matrix 401 characterizes and locates one or more Content Diagonals 301, containing a Matrix Header 402 for its identification, as well as an ordered list containing both a Diagonal Locator 403 and a Diagonal View Token 404 for each one or more Content Diagonals 301 contained in (i.e. assigned to) the Content Display Matrix 401. The Content Diagonal Locator 403 describes the location of a particular Content Diagonal 301 and the associated Diagonal View Token 404 characterizes that Content Diagonal 301 as to the Content View Tokens 403 of the content items contained in that Content Diagonal 301. The assignment of a particular Content Diagonal 301 to a Content Display Matrix 401 is based on its Diagonal View Token 404, which, as previously stated above, reflects the common characteristics defined by the Content View Tokens 403 of the content items contained within the assigned Content Diagonal 301. Any particular Content Display Matrix 401 may contain Content Diagonals 301 having different Diagonal View Tokens 404, so that content items of varied characteristics (i.e. content items defined by different Content View Tokens 403), even though contained in different Content Diagonals 301 within the Content Display Matrix 401, can be listed and “activated” in the displayed menu and thereby be selected for use.

Assignment of Sorted Content Items into Content Diagonal:

Referring now to FIG. 2, an exemplary embodiment of a Content Diagonal (CD) 301 parameter set (also referred to as a “Diagonal”) comprising a Diagonal Header 302 and an ordered list of Content Instance Locators 304 and their associated Content View Tokens (CVT), also referred to as View Tokens (VT) 303. A Content Diagonal 301 is a repository of sorted content items resulting from the operation of one or more sorting algorithms in the sorting method disclosed. New Content Diagonals 301 are created by searching one or more media planes in the multi-dimensional media space for content items that have “compatible” View Tokens 303. One or more Content Diagonals 301 are created from the list of content items meeting the compatibility evaluation resulting from the sort. Two or more content items have “compatible” View Tokens 303 when their View Token Definitions 307 are the same, and thereby are allowed to be in the same Content Diagonal 301 and the same Content Display Matrix 401. Existing Content Diagonals 301 are modified as a result of sorting View Tokens 303 by examining and comparing them with a Viewer Configuration Information 125. When the View Token 303 of a particular content item does not match or otherwise conform, that content item is either removed from the Content Diagonal 301, or is “blanked out” of the display of the Content Diagonal 301, or a replacement content item having a compatible View Token 303 is substituted into the Content Diagonal 301. Said substitution is accomplished by searching for a content item that has a compatible view token 303 and “fits” into the Content Diagonal 301.

Content Diagonals 301 are used to organize content items having similar characteristics as reflected in the respective Content View Tokens 303, and contain at least the following information expressed as follows:
Content_diagonal {diagonal_name( ), diagonal_id, number_of_entities, for (i=0; i++, i=number_of_entities) {content_view_token(i), content_instance_locator(i)}

In said exemplary embodiment, the Content Diagonal 301 parameter set contains the following parameters:

The diagonal_name 305 is a text string containing the formal name of the diagonal.

The diagonal_id 306 is a unique alphanumeric value used to identify the diagonal.

The Content View_Token 303 (also referred to as a “View Token”) is an ordered set of integers used to determine whether or not the associated content item is “acceptable” for a particular viewer. A Content View_Token 303 may take on many different configurations, but the configuration must be the same for all Content View_Tokens 303 within a particular Content Diagonal 301. A locator, the View Token Definition Locator (VTDL) 410, in each Content Display Matrix (CDM) 401 is used to locate the appropriate View Token Definition (VTD) 307, which provides the applicable Content View Token 303 format and field definitions. The sorting criteria information is used to create the View Token Definition 307, and such VTD 307 is further used to define all of the View Tokens 303 in a given Content Display Matrix 401.

The Content_View_Token 303 (also referred to as View Token) contains at least the following information expressed as follows:

View_Token={number_of_entities; for (i=0; i++,i<number_of_entities){token_value,}}; where the token_value is an integer having a value defined in the View Token Definition 307, which defines the View Token 303 format and fields. As a result of one or more sorting algorithms, a View Token 303 is assigned to each content item of the sorted subset. The View Token 303 of each sorted content item is examined and used to assign said content item into one or more Content Diagonal(s) 301 or used by a real-time Navigation Processing Engine 1201 (as illustrated in FIG. 11) to dynamically evaluate content items as acceptable or unacceptable for a viewer, based on the sorting criteria for said viewer applied by the one or more sorting algorithms. Note that a View Token 303 is associated with an individual content item, and should be differentiated from the Diagonal View Token 404, which applies to the entire Content Diagonal 301.

The Content_Instance_Locator (CIL) 304 describes the location of Content Instances 100 in a multi-dimensional media space. The Content_Instance_Locator 304 contains at least the following information expressed as follows:
Content_Instance_Locator(z)={media_plane, delivery_type, location( ), availability( ), duration, search_type( ), access_security( )}

The information fields contained in the Content Instance Locator 304 parameter have the same type of values as the fields called the “Locator Information Fields” (“LIF”), namely the media plane 141, delivery type 142, location 143, availability 144, duration 145, search type 146, access security 147, previously specified for the Content Locator 106, except that the reference here is to a Content Instance 100 rather than to a content item. For the sake of specification efficiency, these LIF definitions, adapted to the Content Instance Locator 304 use, are not repeated here. Therefore, in applying the initial LIF definitions, the words “Content Instance” should be substituted wherever the words “content item” appear in said LIF definitions.

Assignment of Sorted Content Diagonal(s) into Content Display Matrix

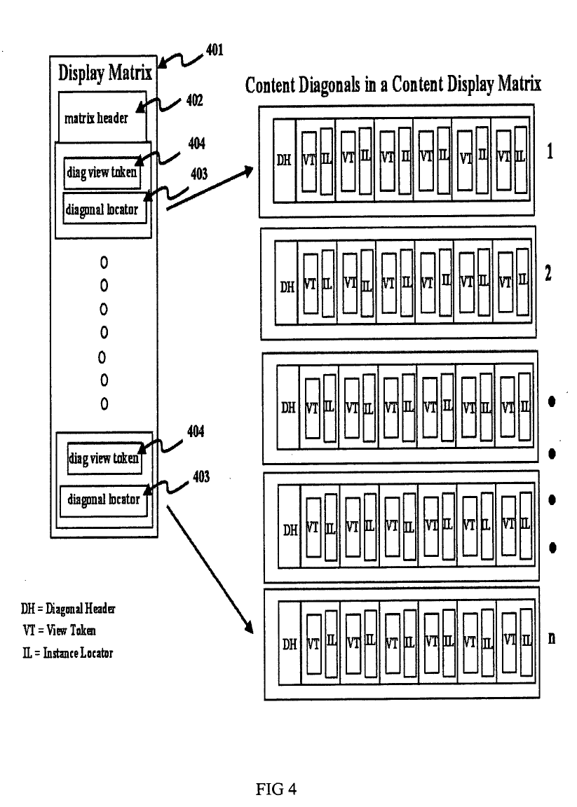

Referring to FIG. 4, an exemplary embodiment of a Content Display Matrix (CDM) 401 (herein also referred to as a “content matrix”, “display matrix”, or “matrix”) organizes and lists the available content items that are acceptable (by virtue of a sorting operation using a defined sorting criteria and assignment to the appropriate Content Diagonal 301) for selection by a particular viewer. The Content Display Matrix 401 contains an ordered list of Content Diagonal Locators 403 and associated Diagonal View Tokens 404, for the Content Diagonals 301 included therein. Said sorting criteria is used to create the view token definition 307 that would be used to define all of the view tokens in a given content display matrix 401.

The Content Display Matrix 401 parameter set contains at least the following information expressed as follows:
Content_Display_Matrix( )={display_matrix_name( ), display_matrix_id, display_matrix_version, display_matrix_availability( ), display_matrix_duration( ), view_token_definition_locator( ), sort-algorithm-locator( ), current_root_diagonal_number, Number_of_diagonals, for (i=0; i++,i=number_of_diagonals) {diagonal_view_token(i), content_diagonal_locator(i) }

In an exemplary embodiment, the Content Display Matrix 301 contains the following:

The display_matrix_name 405 is a text string containing the formal name of the display matrix.

The display_matrix_id 406 is a unique alphanumeric value used to identify the display matrix.

The display_matrix_version 407 is an integer or real number which indicates the version number of the display matrix.

The display_matrix_availability( ) 408 parameter indicates when the information in the Content Display Matrix 301 can be accessed. This availability field comprises a set of pairs that define the rules governing when the content item can be accessed, and contains the following information expressed as follows:
Display_matrix_availability( )={number_of_entities, for (i=0;i++,i<number_of_entities) {availability_detail, availability_value}}

Availability indicates when the content item can be accessed. The variable itself consists of a set of pairs that define the rules governing when the content item can be accessed, and is expressed as follows:
availability( )={number_of_entities, for (i=0; i++,i<number_of_entities) }availability_detail, availability_value}}

In this exemplary embodiment, availability_detail is an integer which can be any of the following possible values: “0”, meaning not currently available; “1” meaning “always available”; “2”, meaning “available when loaded from media”; “3” meaning “available during a limited time”; “4” meaning “available during a specific time period”; “5” to “255” being reserved for other meanings. In this exemplary embodiment, availability_value is a text string having values which are dependent on the availability_detail value as follows.
When availability_detail is 0, 1, or 2, then the availability_value is 0;
When availability_detail is 3, then availability value is of the form days:hours:minutes, where
days is an integer within a range of 0 to 365, hours is an integer within a range of 0 to 24, and
minutes is an integer within a range of 0 to 59. Under the foregoing situation, the availability_detail defines the amount of time, in days, hours, and minutes, that the content will be available following the time at which the content item is selected.

When availability_detail is 4, then availability_value indicates the start time at which the content item is available and is of the form year:month:day:hour:minute:second, where year is an integer that indicates the year that the content item is first available, month is an integer within a range of 1 to 12 indicating the month that the content item is first available, day is an integer within a range of 1 to 31 indicating the day that the content item is first available, hour is an integer with a range of 0 to 23 indicating the hour that the content item is first available, minute is an integer within a range of 01 to 59 indicating the minute that the content item is first available, second is an integer from 01-59 indicating the second that the content item is first available.

The display_matrix_duration 409 value indicates the length, in time, that information in the Content Display Matrix 301 will be active.

The view_token_definition_locator 410 has multiple fields describing the location or placement of the View Token Definition 307, used in this Content Display Matrix 401, in a multidimensional media space. In this exemplary embodiment, the view_token_definition_locator 410 contains at least the following information, expressed as follows:
View_token_definition_locator( )={media_plane, delivery_type, location( ), availability( ), duration, search_type( ), access_security( )}

The information fields contained in the view token definition locator 410 have the same type of values as the fields called the “Locator Information Fields” (“LIF”), namely the media plane 141, delivery type 142, location 143, availability 144, duration 145, search type 146, access security 147, previously specified for the Content Locator 106, except that the reference here is to a View Token Definition 307 rather than to a content item. For the sake of specification efficiency, these LIF definitions, adapted to the view token definition locator 410 use, are not repeated here. Therefore, in applying the initial LIF definitions, the words “View Token Definition” should be substituted wherever the words “content item” appear in said LIF definitions.

The sort_algorithm_locator( ) 411 describes the location or placement of a sort algorithm 420 used in this Content Display Matrix 401, in a multi-dimensional media space. In this exemplary embodiment, the sort_algorithm_locator( ) contains at least the following information, expressed as follows:
Sort_algorithm_locator( )={media plane, delivery_type, location( ), availability( ), duration, search_type( ), access_security( )}.

The information fields contained in the sort algorithm locator 411 have the same type of values as the fields called the “Locator Information Fields” (“LIF”), namely the media plane 141, delivery type 142, location 143, availability 144, duration 145, search type 146, access security 147, previously specified for the Content Locator 106, except that the reference here is to a Sort Algorithm 420 rather than to a content item. For the sake of specification efficiency, these LIF definitions, adapted to the sort algorithm locator 411 use, are not repeated here. Therefore, in applying the initial LWF definitions, the words “Sort Algorithm” should be substituted wherever the words “content item” appear in said LIF definitions.

The current_root_diagonal 412 is an integer which indicates which diagonal is currently designated as the root diagonal by the real-time Navigation Display Engine 2001 shown in FIG. 20. The current_root_diagonal becomes a reference diagonal for constructing the navigation display according to the invention.

The diagonal_view_token 404 parameter is an alphanumeric used to determine whether or not the content items contained in the associated Content Diagonal 301 is acceptable for viewing by a particular viewer. If the diagonal_view_token 404 is null (i.e., zeros in all fields), this means that the individual Content View Token(s) 303 of the individual content items listed in the Content Diagonal 301 are different and must be examined individually. If the diagonal_view_token 404 is non-null, then the diagonal_view_token 404 contains a “group value” that can be used to sort all of the content items in the associated Content Diagonal 301 collectively and thereby not requiring individual examination. Under such a non-null condition, the diagonal_view_token 404 is assigned the “group value” and shares the same definition as the individual Content View Token(s) 303 of the individual content items in the Content Display Matrix 401, and is expressed as follows:
diagonal_view_token={number_of_entities; for (i=0; i++,i<number_of_entities) {token-value(i)}}

In this exemplary embodiment, the token_value is an integer, the value of which is defined in the View Token Definition 307. The view_token_definition locator 410 locates the appropriate view_token_definition 307, which defines the diagonal_view_token 404 format and information fields.

The Content_Diagonal_Locator 403 parameter, included in the Content Display Matrix 401, describes the location or placement of a Content Diagonal 301 in a multi-dimensional media space 201. The Content Diagonal Locator 403 contains at least the following information expressed as follows:
Content_diagonal_locator( )={media-plane, delivery_type, location( ), availability( ), duration, search_type( ), access_security( )}.

The information fields contained in the content diagonal locator 403 have the same type of values as the fields called the “Locator Information Fields” (“LIF”), namely the media plane 141, delivery type 142, location 143, availability 144, duration 145, search type 146, access security 147, previously specified for the Content Locator 106, except that the reference here is to a Content Diagonal 301 rather than to a content item. For the sake of specification efficiency, these LIF definitions, adapted to the view content diagonal locator 403 use, are not repeated here. Therefore, in applying the initial LWF definitions, the words “Content Diagonal” should be substituted wherever the words “content item” appear in said LIF definitions.

The View Token Definition 307 defines the format and fields for a set of View Tokens 303. Each field in the View Token 303 contains an integer. The View Token Definition 307 contains at least the following information expressed as follows:
View_Token_Definition( )={number_of_token_values, for (i=0;i++,i=number_of_token_values) {token_reference(i), number_of token_reference_values, for (j=0;j++j=number_of token_reference_values) {j, “=”, token_reference_value_definition(j)}}}.
   Note that in this exemplary embodiment, all values for “j” that are not used in the token reference value definition for each token reference are considered to be undefined.

In this exemplary embodiment, the information fields contained in the View_Token_Definition 307 include the following:

The number_of_token_values 435 is an integer which defines the number of integers contained in the defined view token.

The token_reference 436 is a text string which contains the name of the field that is evaluated in the token. An example of a token reference would be “content descriptor, genre”.

The number_of token_reference_values 437 is an integer which contains the number of defined values for a given token reference.

The token_reference_value_definition 434 is a text string which contains a name corresponding to a particular type of the token reference. As an example and not as a limitation, if the view token is defined as containing only one reference as genre, with only four possible values of “cartoon”, “sports, all”, “movie”, or “education, general”, then the view token definition would be expressed as:
View_token_definition)example)={1, “genre”, 4, 0 “=cartoon”, 1 “=sports, all”, 2 “=movie”, 3 “=education, general”}

The content_matrix_sort_algorithm 420 (also referred to as sort algorithm) defines the sorting algorithm used to verify that each Content Diagonal 301 and each Content Instance 100 included in the Content Display Matrix 401 meets the identity requirements, i.e. that the application of the sort algorithm 420 to the content items in the Content Matrix 401 produces a logical “1” or “true” result. Each sort algorithm 420 comprises variables and logic operations. Only the token references declared in the View Token Definition 307 are eligible to be variables in the sort algorithm 420 and each such variable can only have a value that has been defined in the View Token Definition 307. The sort algorithm 420 contains at least the following information, expressed as follows:
Content_matrix_sort_algorithm( )={Number_of_algorithm_entries, for (i=0; i++,i=number_of algorithm_entities) {algorithm_entity(i), “//”)}}.

In this exemplary embodiment, the information fields of the content_matrix_sort_algorithm( ) are defined as follows:

Number_of_algorithm_entries 421 is an integer which defines the number of text entities contained in the defined sort algorithm.

Algorithm_entity is a text string having the following possible values:
a token_reference( ) 436 which is one of the token references defined in the view token definition 307;
a numeric value “j” which is one of the numeric values defined for token_reference(i) in the view token definition;
logic_operators which comprise {logical “or” operation depicted by a plus sign “+”, a logical “and” operation depicted by an asterisk “*”, and a logical “not” operation depicted by a minus sign “−”};
logic_field_separators which comprise {open parenthesis “(”, close parenthesis “)”, open bracket “[”, and close bracket “]”}.

As an example, and not as a limitation, a sort algorithm 420 for the View Token Definition 307 example specified above would be expressed as:
sort algorithm=genre(0)+genre(1)+genre(3).

As another example and not as a limitation, according to this sort algorithm 420, content items having the “cartoon” genre, “sports” genre, or “general education” genre are allowable for inclusion in the example Content Display Matrix 401, but “movie” genre content items are excluded from the example content matrix. This example would result in a content matrix sort algorithm 420 of the following form:
Content_matrix_sort_algorithm={8, “genre”, “//”, “0”, “//”, “+”, “//”, “genre”, “//”, “1”, “//”, “+”, “//”, “genre”, “//”, “3”, “//”}. Content Matrix Descriptor Chaining:

The following refers to FIGS. 5, 6, and 7 and to the Navigation Processing Engine 1201 and Navigation Display Engine 1202 depicted in FIG. 11.

Referring to Table 1, the Real-time Content Matrix Descriptor (RTCMD or CMD) 425 contains information about a Content Display Matrix 401 communicated to the real-time Navigation Processing Engine 1201 for processing. The Real-time Content Matrix Descriptor 425 contains at least the following information, expressed as follows:
Real-time_content_matrix_descriptor( )={matrix_tag; matrix_status; matrix_info_locator( ); previous_matrix_descriptor_locator( ); next_matrix_descriptor_locator}.

In this exemplary embodiment, the parameters of the real_time content_matrix_descriptor( ) 425 parameter set are defined as follows:

The Matrix_tag 426 is an integer identifying a particular Content Display Matrix 401 within the domain of the real_time Navigation Processing Engine 1201.

Matrix_status 427 is an integer describing the status of the Content Display Matrix 401 and any modifications that may exist thereto, and the matrix_status 427 variable can take on values including, but not limited to, “0” meaning that the Content Display Matrix 401 is unavailable; “1” meaning that only the original content matrix 456 is available; or “2” meaning that content matrix modifications are available.

The Matrix_Information_Locator 428 parameter comprises information fields that together describe the location or placement of the matrix information data (MID) 450 for the particular Content Display Matrix 401. In this exemplary embodiment, the matrix info locator parameter contains at least the following information, expressed as follows:
Matrix_info_locator( )={media_plane, delivery_type, location}

The information fields contained in the matrix information locator 428 have the same type of values as the fields called the “Locator Information Fields” (“LIF”), namely the media plane 141, delivery type 142, location 143, previously specified for the Content Locator 106, except that the reference here is to Matrix Information Data 450 rather than to a content item. For the sake of specification efficiency, these LWF definitions, adapted to the matrix information locator 428 use, are not repeated here. Therefore, in applying the initial LIF definitions, the words “matrix information data” should be substituted wherever the words “content item” appear in said LIF definitions.

Referring now to FIG. 5 and the RTCMD 425 (also referred to as CMD) parameter of Table 1, the previous_matrix_descriptor_locator (PMDL) 429 parameter and the next_matrix_descriptor_locator (NMDL) 430 parameter are used to link matrix descriptors (i.e. CMDs) together, and thereby facilitate the processing of content matrices by both the real_time Navigation Processing Engine 1201 and the real_time Navigation Display Engine 1202 depicted in FIG. 11. When the first content matrix (for example, call it content matrix A) is received by the Navigation Processing Engine 1201, both the PMDL 429 and the NMDL 430 descriptor locators are set to zero indicating that it is both the first and the last descriptor available. When another content matrix 401 (for example, call it content matrix B), the next matrix descriptor locator 430 for content matrix A points forward to the descriptor for content matrix B and the previous content matrix descriptor locator 429 for content matrix B points backward to the descriptor of content matrix A. The next content matrix descriptor locator 430 for content matrix B is set to zero, indicating that this is the last descriptor available. The process is continued as each subsequent content matrix is communicated to the Navigation Processing Engine 1201.

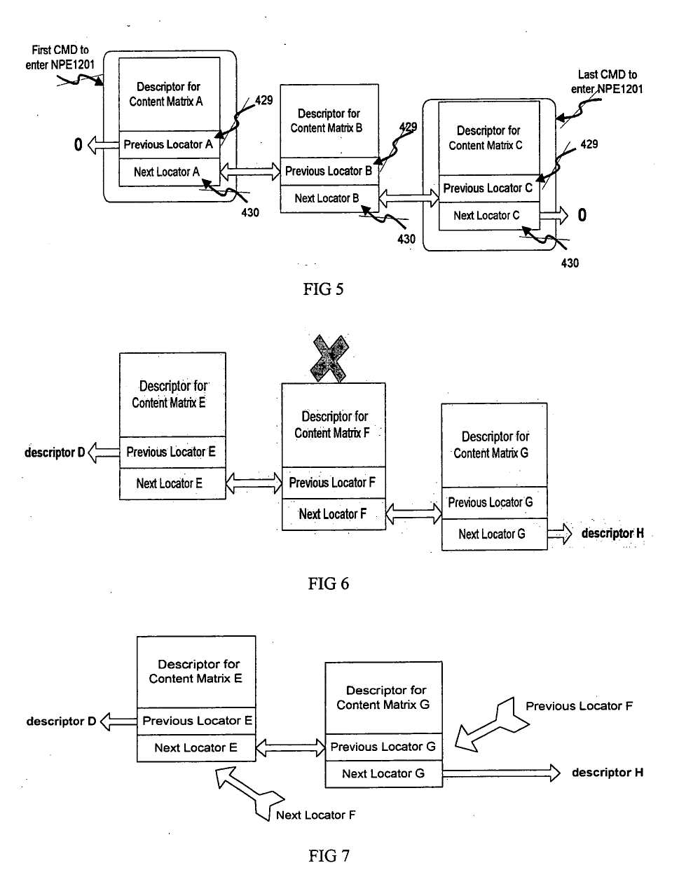

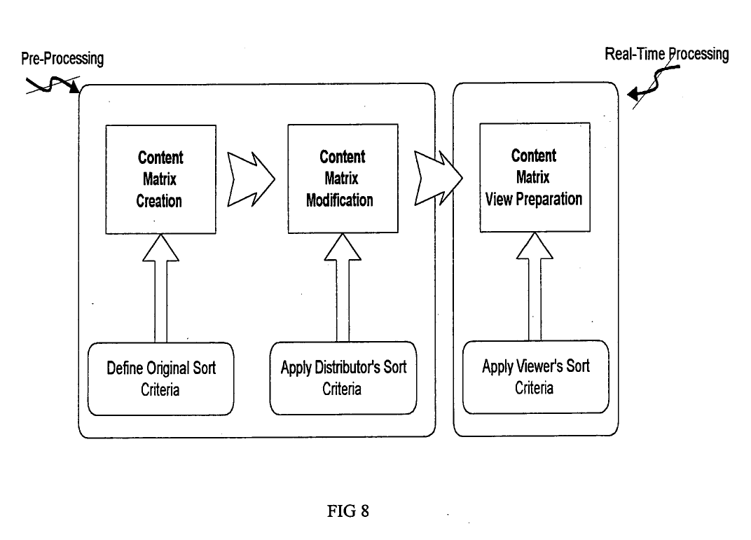

Referring now to FIGS. 6 and 7, when a content matrix 401 (for example, call it content matrix F) is no longer valid, or has been removed by viewer action, the next matrix descriptor locator 430 of content matrix descriptor F is loaded into the next matrix descriptor locator 430 space of the previous content matrix (call it content matrix E) descriptor and the previous matrix descriptor locator 429 of content matrix descriptor F is loaded into the previous descriptor locator 429 space of the next content matrix (call it content matrix G) descriptor. FIG. 7 depicts the CMD chain after the removal of the content matrix F descriptor. The previous_matrix_descriptor_locator (PMDL) 429 parameter describes the location or placement of a previous matrix descriptor. The previous matrix descriptor locator contains at least the following information, expressed as follows:
previous_matrix_descriptor_locator( )={media_plane, delivery_type, location}

The information fields contained in the previous matrix descriptor locator 429 have the same type of values as the fields called the “Locator Information Fields” (“LIF”), namely the media plane 141, delivery type 142, location 143, previously specified for the Content Locator 106, except that the reference here is to a real time Content Matrix Descriptor (CMD) 425 rather than to a content item. For the sake of specification efficiency, these LIF definitions, adapted to the previous matrix descriptor locator 429 use, are not repeated here. Therefore, in applying the initial LIF definitions, the words “content matrix descriptor” should be substituted wherever the words “content item” appear in said LIF definitions.

The next_matrix_descriptor_locator (NMDL) 430 parameter describes the location or placement of a next matrix descriptor. The next matrix descriptor locator contains at least the following information, expressed as follows:
next_matrix_descriptor_locator( )={media_plane, delivery_type, location}

The information fields contained in the next matrix descriptor locator 430 have the same type of values as the fields called the “Locator Information Fields” (“LIF”), namely the media plane 141, delivery type 142, location 143, previously specified for the Content Locator 106, except that the reference here is to a real time Content Matrix Descriptor (CMD) 425 rather than to a content item. For the sake of specification efficiency, these LIF definitions, adapted to the next matrix descriptor locator 430 use, are not repeated here.

Therefore, in applying the initial LWF definitions, the words “content matrix descriptor” should be substituted wherever the words “content item” appear in said LIF definitions.

Matrix Information Data

Referring to Table 1, the Matrix_Information_Data (MID) 450 parameter set contains information about a particular Content Display Matrix 401 including the locator that points to the original content matrix, a list of viewers for the original content matrix, locators that point to modifications of the original content matrix and a list of viewers for each modification. Content Display Matrix 401 modifications are made, as required, based on the requirements of the Viewer Configuration Information 125. The Matrix Information Data 450 parameter set includes at least the following information, expressed as follows:
matrix_information_data( )={original_content_matrix_locator( ), original_content_matrix_viewer_list( ), number_of_modificiations, for (i=0; i++; i<number_of_modifications) {content_matrix_modification_locator( ), modified_content_matrix_viewer_list( )}}

In this exemplary embodiment, the parameters of the Matrix Information Data 450 parameter set are defined as follows:

The original_content_matrix_locator (OCML) 451 parameter describe the location or placement of the original content matrix. The original content matrix locator contains at least the following information, expressed as follows:
original_content_matrix_locator( )={media_plane, delivery_type, location}

The information fields contained in the original content matrix locator 451 have the same type of values as the fields called the “Locator Information Fields” (“LIF”), namely the media plane 141, delivery type 142, location 143, previously specified for the Content Locator 106, except that the reference here is to the original content matrix 456 rather than to a content item. For the sake of specification efficiency, these LIF definitions, adapted to the next matrix descriptor locator 451 use, are not repeated here. Therefore, in applying the initial LIF definitions, the words “original content matrix” should be substituted wherever the words “content item” appear in said LWF definitions.

The original_content_matrix_viewer_list (OCMVL) 452 parameter contains a list of viewers that have been “approved” to view the content item(s) contained in the original content matrix 456. This approval is attained when the designated view filter 155 successfully filters the original content matrix. The original content matrix viewer list 452 parameter contains at least the following information, expressed as follows:
original_content_matrix_viewer_list( )={number_of_entities; for (i=0; i++,i<number_of_entities) {viewer_id }}.

The number_of_modifications 453 parameter is an integer defining the number of modifications performed on the original content matrix 456.

The content_matrix_modification_locator (CMML) 454 parameter describes the location or placement of a modified content matrix 457. The content matrix modification locator 454 parameter contains at least the following information, expressed as follows:
content_matrix_modification_locator( )={media_plane, delivery_type, location}

The information fields contained in the content matrix modification locator 454 have the same type of values as the fields called the “Locator Information Fields” (“LIF”), namely the media plane 141, delivery type 142, location 143, previously specified for the Content Locator 106, except that the reference here is to the modified content matrix 457 rather than to a content item. For the sake of specification efficiency, these LWF definitions, adapted to the content matrix modification locator 454 use, are not repeated here. Therefore, in applying the initial LWF definitions, the words “modified content matrix” should be substituted wherever the words “content item” appear in said LIF definitions.

The modified_content_matrix_viewer_list (MCMVL) 455 parameter contains a list of viewers that have been “approved” to view the content contained in the modified content matrix 457. This approval is attained when the designated view filter 155 successfully filters the modified content matrix. The modified content matrix viewer list 455 parameter contains at least the following information, expressed as follows:
modified_content_matrix_viewer_list( )={number_of_entities; for (i=0; i++,i<number_of_entities) {viewer_id }}

In this exemplary embodiment, the viewer_id 128 is text containing the viewer's (i.e. content item user's) identification, which is usually, but not necessarily, a name chosen by the viewer.

Viewer Configuration Information

Referring to Table 1, the Viewer_Configuration_Information (VCI) 125 parameter set contains a particular user's (i.e. viewer, listener, gamer of content items) preferences, entitlements and restrictions which are used by the real_time Navigation Display Engine 1202 to determine how it displays the list of content items. Viewer Configuration Information 125 contains at least the following information, expressed as follows:
viewer_configuration_information( )={view_filter_definition_locator( ), number_of_configured_viewers, for (i=0;i++,i=number_of_configured_viewers) {viewer_id(i), viewer_configuation_descriptor_locator(i), view_filter_locator(i), viewer_display_descriptor_locator(i)}}

In this exemplary embodiment, the Viewer Configuration Information 125 comprises the following:

The viewer_id( ) 128 is, as previously described, text containing the viewer's (i.e. content item user's) identification, which is usually, but not necessarily, a name, chosen by the viewer.

The view_filter_definition_locator (VFDL) 126 parameter describes the location or placement of the View Filter Definition (VFD) 150. The View Filter Definition Locator 126 contains at least the following information, expressed as follows:
view_filter_definition_locator( )={media_plane, delivery_type, loation}

The information fields contained in the view filter definition locator (VFDL) 126 have the same type of values as the fields called the “Locator Information Fields” (“LIF”), namely the media plane 141, delivery type 142, location 143, previously specified for the Content Locator 106, except that the reference here is to a View Filter Definition 150 rather than to a content item. For the sake of specification efficiency, these LIF definitions, adapted to the view filter definition locator 126 use, are not repeated here. Therefore, in applying the initial LIF definitions, the words “view filter definition” should be substituted wherever the words “content item” appear in said LIF definitions.

The number_of_configured_viewers (NCV) 127 is an integer specifying the number of viewers that have performed the viewer configuration operation.

The viewer_configuration_descriptor_locator (VCDL) 130 parameter describes the location or placement of the viewer configuration descriptor (VCD) 131. The viewer configuration descriptor locator 130 contains at least the following information, expressed as follows:
viewer_configuration_descriptor_locator( )={media_plane, delivery_type, location}

The information fields contained in the view filter definition locator (VCDL) 130 have the same type of values as the fields called the “Locator Information Fields” (“LEF”), namely the media plane 141, delivery type 142, location 143, previously specified for the Content Locator 106, except that the reference here is to a Viewer Configuration Descriptor 131 rather than to a content item. For the sake of specification efficiency, these LIF definitions, adapted to the viewer configuration descriptor locator 130 use, are not repeated here. Therefore, in applying the initial LWF definitions, the words “view configuration descriptor” should be substituted wherever the words “content item” appear in said LIF definitions.

The view_filter_locator (VFL) 129 parameter describes the location or placement of the view filter (VF) 155. The view filter locator parameter 129 contains at least the following information, expressed as follows: view_filter_locator( )={media_plane, delivery_type, location}

The information fields contained in the view filter locator (VFL) 129 have the same type of values as the fields called the “Locator Information Fields” (“LWF”), namely the media plane 141, delivery type 142, location 143, previously specified for the Content Locator 106, except that the reference here is to a Viewer Filter 155 rather than to a content item. For the sake of specification efficiency, these LWF definitions, adapted to the viewer filter locator 129 use, are not repeated here. Therefore, in applying the initial LIF definitions, the words “view filter” should be substituted wherever the words “content item” appear in said LIF definitions.

The viewer_display_descriptor locator (VDDL) 182 parameter describes the location or placement of the viewer display descriptor (VDD) 180. The viewer display descriptor locator 182 parameter contains at least the following information, expressed as follows:
viewer_display_descriptor_locator( )={media_plane, delivery_type, location}

The information fields contained in the viewer display descriptor locator (VDDL) 182 have the same type of values as the fields called the “Locator Information Fields” (“LIF”), namely the media plane 141, delivery type 142, location 143, previously specified for the Content Locator 106, except that the reference here is to a Viewer Display Descriptor 180 rather than to a content item. For the sake of specification efficiency, these LIF definitions, adapted to the viewer filter locator 129 use, are not repeated here. Therefore, in applying the initial LIF definitions, the words “viewer display descriptor” should be substituted wherever the words “content item” appear in said LIF definitions.

The view_filter_definition (VFD) 150 parameter set contains the format and field definitions for the view filter (VF) 155. All of the possible values for each view filter reference (VFR) 153 are defined in this data structure. The view filter definition 150 contains at least the following information, expressed as follows:
view_filter_definition( )={number_of_filter_values, for (i=0;i++,i=number_of_filter_values) {view_filter_reference(i), number_of_view_filter_reference_definitions(i), for (j=0;j++j=number_of_view_filter_reference_definitions) {j, ”=”, view_filter_reference_definition(j)}}}

Note that all values for “j” that are not used in the filter reference definition for each view filter reference are considered to be undefined.

In this exemplary embodiment, the parameters of the view_filter_definition (VFD) 150 parameter set are defined as follows:

The number_of_filter_values 156 is an integer specifying the number of view filter references 153 that are defined.

The view_filter_reference (VFR) 153 is a text string containing the name of the field that is evaluated in the view filter (VF) 155. An example of a view filter reference 153 would be “genre”.

The number_of_view_filter_reference_definitions 152 is an integer containing the number of defined values for a given view filter reference 153.

The view_filter_reference_value_definition 154 is a text string containing a name corresponding to a particular type of the view filter reference 153.

The viewer_configuration_descriptor( ) (VCD) 131 contains text describing a particular viewer's preferences, entitlements and restrictions. This descriptor consists of a set of pairs that define the configuration information that apply to a particular viewer.
viewer_configuration_descriptors( )={number_of_entities, for (i=0; i++,i<number_of_entities) {text_string_type, text_string( )}}

If, as an example and not as a limitation, the viewer is an 8 year old boy named Bobby that only wants to watch cartoons, movies, and sports and he likes to play action video games, but whose parents prefer that he have broader viewing choices, the viewer configuration descriptor in an exemplary embodiment would be:
viewer_configuration_descriptor(example)={20, “name”, “Bobby”, “gender”, “male”, “age”, “8”, “favorite class”, “television”, “favorite class”, “movies”, “favorite class”, “video games”, “favorite genre”, “cartoon”, “favorite genre”, “sports, all”, “favorite genre”, “movie”, “parent preferred class”, “television”, “parent preferred class”, “movies”, “parent preferred class”, “internet”, “parent preferred genre”, “education, general”, “parent preferred genre”, “documentary”, “parent preferred genre”, “current events”, “restricted genre”, “infomercial”, “view control”, “age restricted viewing”, “view control”, “limit viewing time”, “view time start”, “6:00 AM”, “view time end”, “9:30 PM”}.

The view filter (VF) 155 parameter set identifies the algorithm used to verify that each Content Diagonal 301 and each Content Instance 100 that is included in the active Content Display Matrix 401 meets the viewer configuration requirements, i.e., that the view filter algorithm produces a logical true or positive result. Each view filter 155 is composed of variables and logical operations. Only view filter references 153 declared in the view filter definition 150 can be variables in the view filter algorithm and each variable can only have a value that has been defined in the view filter definition 150. The view filter contains at least the following information, expressed as follows:
view_filter( )={Number_of_filter_entries, for (i=0;i++,i=number_of_filter_entities) {filter_entity(i), “//”}}

In this exemplary embodiment, the view_filter 155 parameter set contains the following:

The number_of_filter_entries 156 is an integer defining the number of text entities contained in the defined view filter.

The filter_entity 159 is a text string having the following possible values:
view_filter_reference(i) is one of the view filter references defined in the view filter definition;
a numeric value “j” which is one of the numeric values defined for view_filter_reference(i) in the view filter definition;
logic_operators which comprise {logical “or” operation depicted by a plus sign “+”, a logical “and” operation depicted by an asterisk “*”, and a logical “not” operation depicted by a minus sign “−”};
logic_field_separators which comprise {open parenthesis “(”, close parenthesis “)”, open bracket “[”, and close bracket “]”}.

The viewer_display_descriptor (VDD) 180 parameter contains the definition of information that is to be displayed, if available and if possible, by the real_time Navigation Display Engine 1202 depicted in FIG. 11. The viewer display descriptor 180 contains a set of text strings that define the display information which applies to a particular viewer. The viewer display descriptor contains at least the following information, expressed as follows:
viewer_display_descriptor( )={number_of_entities, for (i=0; i++,i<number_of entities) {text_string( )}}.

As an example and not as a limitation, if the viewer display is to be configured as that shown in FIG. 21, the viewer_display_descriptor would be as follows:
viewer_display_descriptor (example)=5, “Title”, “Short summary”, “Showtime”, “Duration”, “Channel number”}. Display Information Array:

Referring again to Table 1, the Display Information Array (DIA) 190 parameter set is an array of information used by the real_time Navigation Display Engine 1202 (see FIG. 11) for creating the actual display windows. The information is arranged into a set of Display Information Containers (DIC) 192 that order the needed information for the Navigation Display Engine 1202. The Display_Information-Array 190 contains the following information, expressed as follows:
Display_information_array( )={number_of_display_information_containers, for (i=0;i++,i=number_of_display information_containers) {container_type,
number_of_container_descriptors, for (j=0;j++,j=number_of_container_values) {display_information_container_descriptor( )}}}.

In this exemplary embodiment, the parameters in the display_information_array 190 are defined as follows: The container type 193 parameter defines the type of display information container. In an exemplary embodiment, valid container types are: {diagonal, instance}.

The display_information_container_discriptor 194 parameter contains text which provides the display information. This descriptor comprises a set of pairs defining the configuration information which applies to a particular viewer, and contains at least the following information, expressed as follows:
display_information_container_descriptors( )={number_of_entities, for (i=0; i++,i<number_of_entities) {text_string_type, text_string( )}}

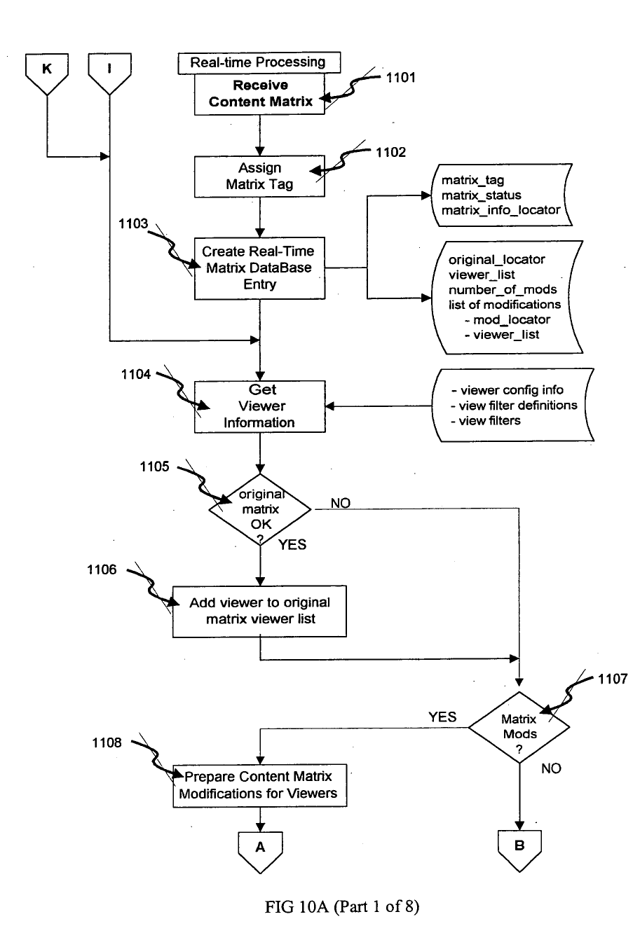

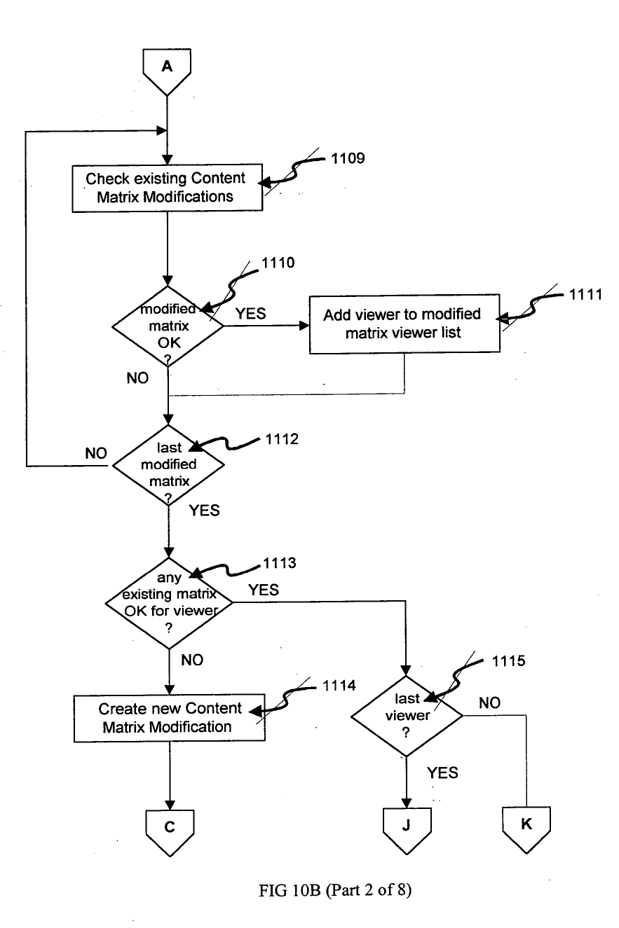

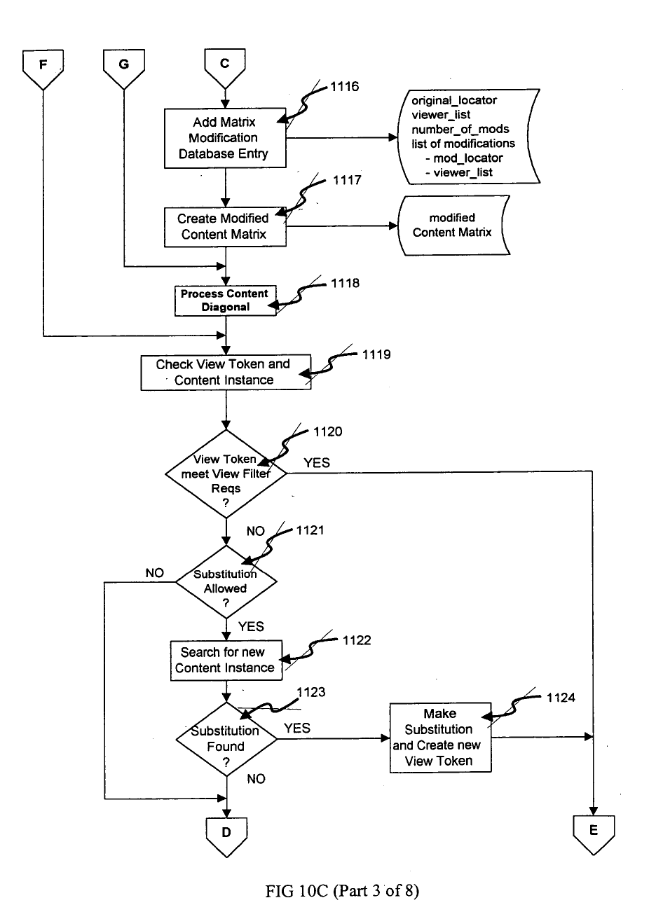

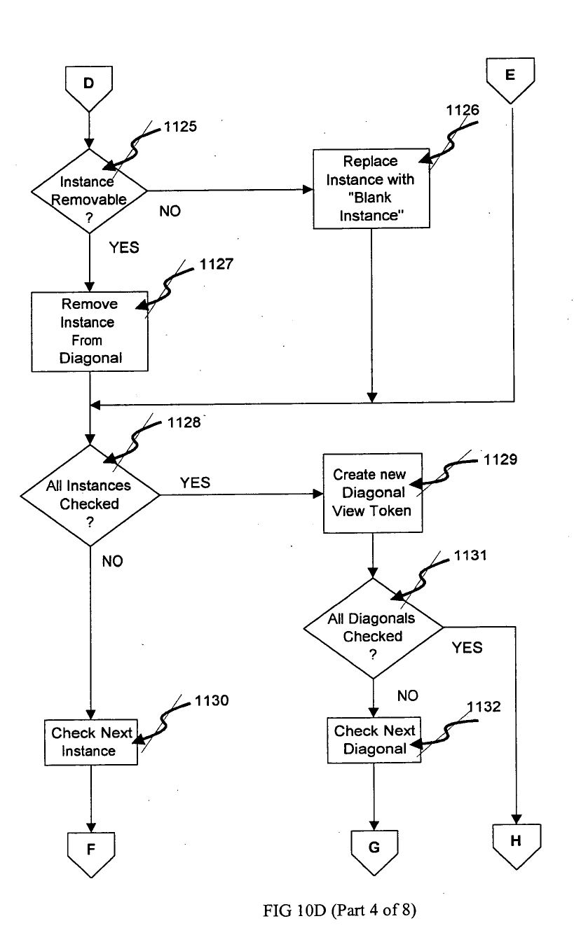

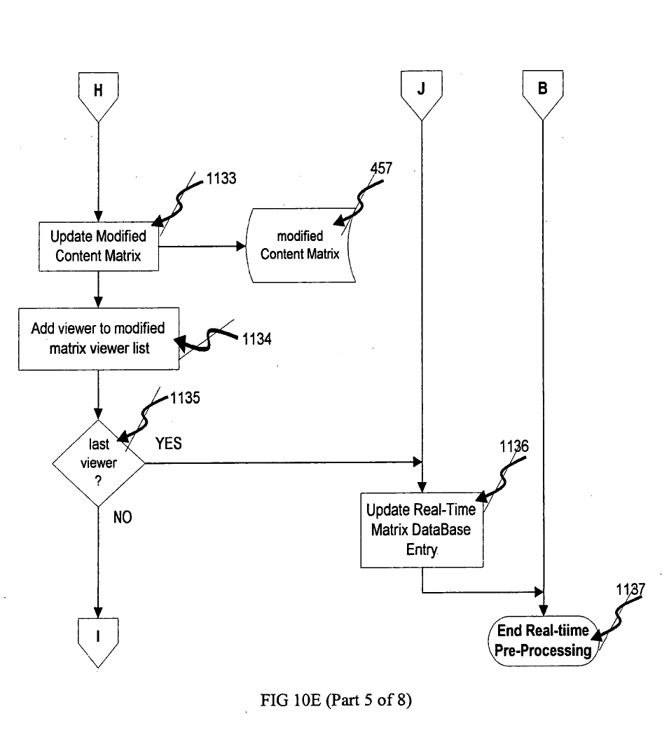

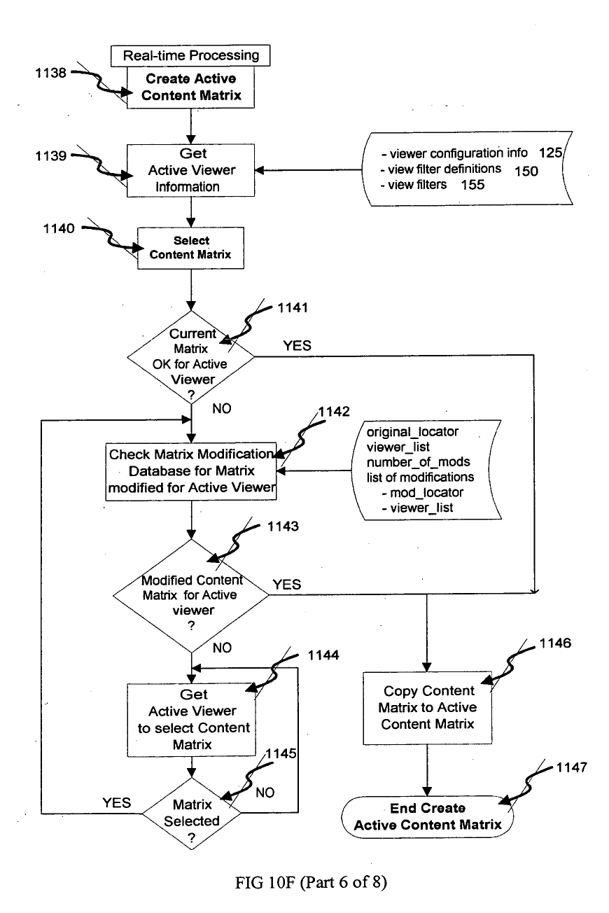

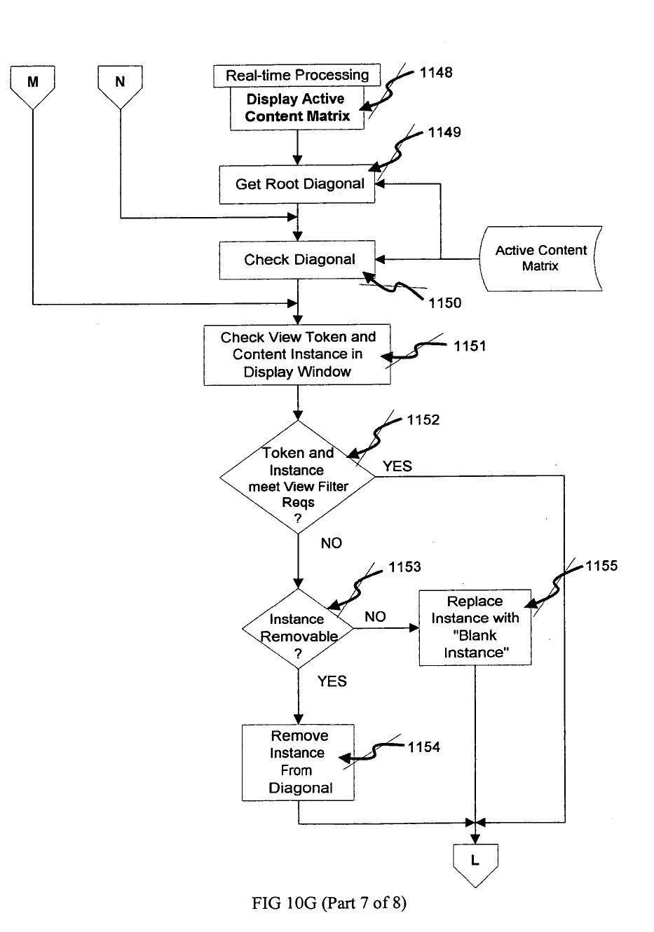

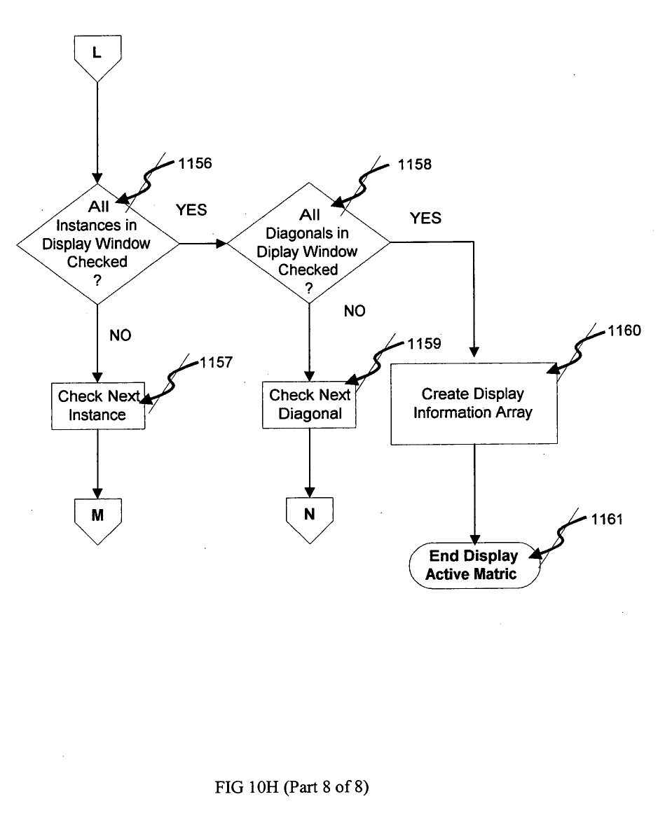

FIGS. 10G and 10H illustrate a logic flow diagram of the active content matrix display algorithm 503, comprising steps 1148 through 1161 of the real-time processing sort method 1100 which prepares the Active Content Matrix 501 for display. Steps 1148, 1149, and 1150 comprises getting and checking the Root Diagonal number 412 as the reference for the Active Content Matrix 501. Steps 1151 and 1152 comprise checking the View Token 303 and Content Instance 100 in the Display Window and determining whether said View Token 303 and Content Instance 100 meet the view filter 155 requirements. If not, step 1153 further determines if the Content Instance 100 is removable, thereby allowing step 1154 to so remove it. However, if the Content Instance 100 is not removable, then step 1155 replaces said Content Instance 100 with a “blank” instance (as such blank instance is previously defined). Steps 1156 through 1159 continue the process, ensuring all Content Instances 100 and View Tokens 303 of all the Content Diagonals 301 in the Display Window are checked, following which steps 1160 and 1161 create the Display Information Array 180 and end the active content matrix display algorithm 503 respectively.

Sorting Method for Creating and Managing Content Item Subset(s)

The present invention discloses a method of creating, modifying, and managing one or more subset(s) of content items for viewing, as available from a multi-dimensional media space of one or more media planes. Using the parameter sets previously specified and a defined sorting criteria, the disclosed method identifies one or more subset(s) of one or more content items which match, or otherwise conform to, the defined sorting criteria, so as to be “acceptable” for a viewer/user according to said sorting criteria and viewer's viewer configuration information 125. The disclosed method uses the content organizing aspects of the previously specified multi-dimensional information structure as depicted in the parameter definitions of Table 1, and one or more sorting algorithms to apply defined sorting criteria to the list of all content items in an applicable multi-dimensional media space. One exemplary embodiment of the sorting method comprises one or more sorting operations, with the type and number of sorting algorithms used in said sorting operations dependent on the complexity of the desired sort. According to the present invention, said one or more sorting operations may occur as a pre-processing operation (i.e. at any time in advance of viewer's content item selection) or as a real-time operation (i.e. at the time of viewer's content item selection).

Referring now to FIG. 8, according to the invention, there are at least three points in the process flow of a Content Display Matrix 301 when sorting algorithms can be used to apply a defined sorting criteria to the content items to be sorted. FIG. 8 shows a first point, at the time of Content Matrix Creation, when the Content Display Matrix 301 is first created and made available for viewing, at which time a pre-defined original sort criteria is applied, with said sort criteria being defined by the content item creator or other entity. This first point occurs anywhere in the multimedia system or network, as such system and network is previously defined. FIG. 8 shows a second point, at the time of Content Matrix Modification, when the content item is located within the content distribution pipeline when sort criteria defined by the content distributor, deliverer or other entity may be applied, which is usually, but not necessarily always, at either the beginning or end of the content distribution pipeline. This second point also occurs anywhere in the multimedia system or network. FIG. 8 also shows a third point, at the time of Content Matrix View Preparation, when the content item is prepared within the multimedia terminal device itself for the viewing event. Sorting which occurs at the first or at the second points defined above is a pre-processing operation, while sorting which occurs at the third point defined above is a real-time processing operation.

The sorting criteria is defined as a set of content item characteristics expressed in the type and format of information contained in the aforementioned content item organizing parameter sets. The sorting criteria may be criteria defined by the user (e.g. viewer, listener, gamer) of multimedia content at the time of content item selection, as a real-time processing operation, or by the content creator (e.g., movie studio or tv producer), distributor (e.g. programming network), or delivering service provider (e.g. cable tv systems operator, satellite tv operator) as a pre-processing operation. Examples of sorting criteria which may be used in the present invention includes, but is not limited to, content item title, identification number, version, descriptive narrative, publication or release date, class and type, genre/subject matter, location, usage restrictions or entitlements, owner, provider, producer or author, actor or performer, time, day and duration of availability, appropriateness or other content rating, viewer demographics (such as gender, age, income level, ethnic background, interests), running time length, and file size of the content item. As one example and not as a limitation of the invention, the sorting criteria definition could be to sort content items by genre; and, as a result, using the present invention, a viewer could select a list of content items of genre types that said viewer would be interested in. As another example, the sorting criteria could be to sort content items by appropriateness of the content for a viewer of a particular age; and, as a result, only content items meeting the particular age appropriateness would be listed on the navigation display for selection by the viewer. These first two examples represent a sorting criteria applied in either a pre-processing or real-time processing sort operation. As yet another example, a sorting criteria could be defined as those content items to which a particular viewer's access is entitled (by virtue of paying a subscription or per-use fee). This last example represents a sorting criteria applied in a pre-processing sorting operation at the beginning, end or elsewhere in the multimedia content item distribution pipeline.

The sorting method disclosed by the present invention comprises one or more of a plurality of examination, comparison and other algorithms, from simple to complex, executed in one or more sorting operations, to apply the sorting criteria to the content items available from one or more media planes. An exemplary embodiment of the present invention comprises at least one algorithm executed in one or more sorting operations, with the number of sorting operations and the number of algorithms therein depending on the complexity (i.e. the number of parameters and their fields to be examined) of the sorting criteria and the sorted content items.

Generally, the basic operation of the one or more sorting algorithms includes, but is not limited to, searching a set of content items, examining at least the Content Descriptor 105 of each Content Instance 100 associated with each content item to be sorted, comparing the information contained in the Content Descriptor 105 with the sorting criteria information to determine whether there is a match with the sorting criteria, or that the information in the Content Descriptor 105 examined is within the bounds of the sorting criteria and that the particular content item is not otherwise eliminated by the sorting criteria information. However, the aforementioned basic operation represents the simplest algorithm, although in the present invention, the number and complexity of sorting algorithms may vary, thereby performing additional examination and comparison of information contained in the Content Descriptor 106 as well as one or more other fields in the hierarchial information structure disclosed herein. As one example and not as a limitation of the invention, a sorting algorithm may be as simple as examining and comparing one characterizing parameter and field of the Content Descriptor 105 such as the genre of content items with a list of genre desired by a viewer, or as complex as that required to examine and compare multiple fields of the Content Descriptor 105, perform a series of sorting operations based on how said fields compare to the sorting criteria, and then order the results of the sorting operations based on information retrieved from the Content Locator 106. Another example of when the number and complexity of sorting algorithms vary in the present invention occurs when multiple instances of the same content item must be searched and sorted. Since, as previously specified herein, a Content Instance 100 describes each location in one or more media planes where there exists a particular content item (for example, a particular movie title). This multiple instance situation requires that the particular content item be represented by more than one Content Instance 100, since the content item can be found in more than one location in the multi-dimensional media space (for example, multiple locations in one or more media planes). Therefore, according to the present invention, the number and complexity of algorithms varies to examine and compare all relevant Content Instances 100 in order to perform an adequate search and sort of available content items in one or more media planes (for example, media planes 202, 203, 204) of the multi-dimensional media space 201 shown in FIG. 1.

As previously stated, the one or more sorting algorithms may be executed in either pre-processing or real-time sort operations, further described below.

Pre-Processing Sort Operation

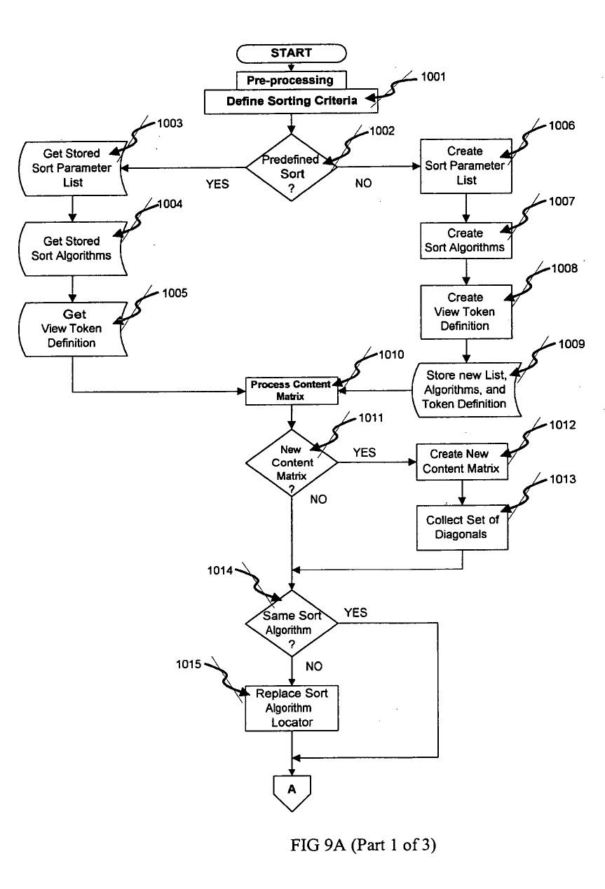

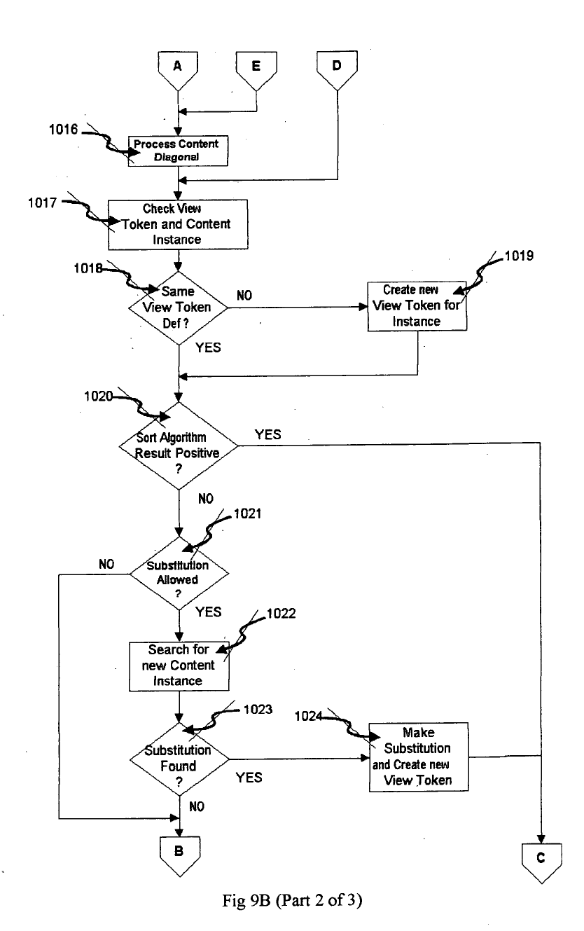

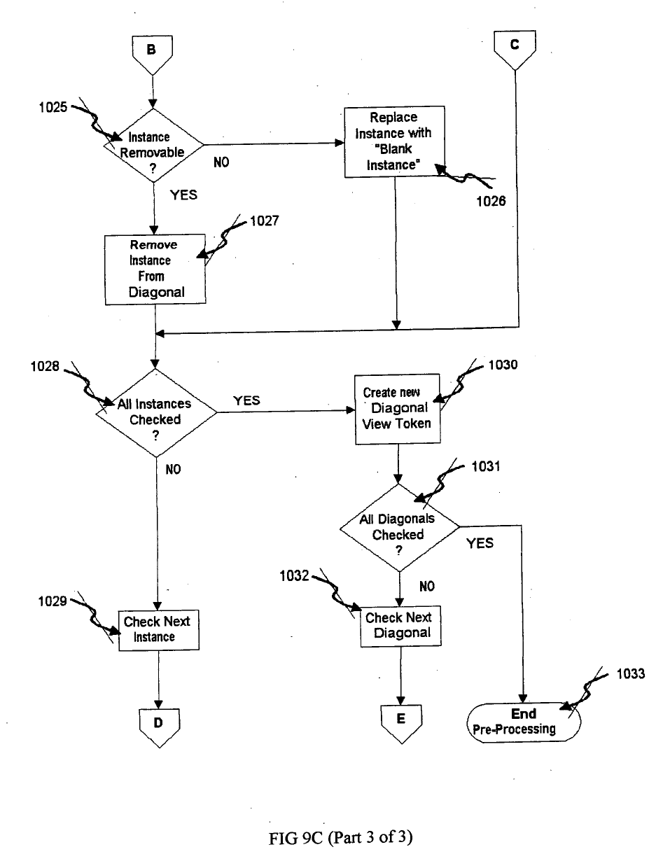

Referring now to Table 1, and the logic flow diagram of FIGS. 9A, 9B, 9C, said diagram depicts an exemplary embodiment of a sort algorithm 420 in a pre-processing sort operation, which can occur anywhere in a multimedia system or network when a content matrix 401 is originated, when a content matrix is modified, or when a derivative content matrix is created from a previously existing content matrix. For example, when a content matrix 401 is created that contains references to all of the television programming that would be available over a specific time period for a specific location (for example 4:00 PM-8:00 PM ET on Feb. 14, 2004 in Biloxi, Miss.), the pre-process sort operation is performed, thereby generating a new content matrix e.g. a modified content matrix 457. Additionally, a particular local cable tv system operator in Biloxi could apply a different set of sort criteria to this newly created matrix using a pre-processing sort operation according to the present invention, thereby modifying the original content matrix 456 thereby creating a derivative, or modified content matrix 457 derived from the original content matrix 456. As another example and not as a limitation, the local cable tv system operator could apply a different set of sort criteria, such as to define a particular target audience based on viewer demographics, to modify or derive a content matrix containing content items, such as infomercials or advertisements, specifically of interest or targeted to the defined target audience of viewers.

Referring again to FIGS. 9A, 9B, and 9C, the method 1000 of pre-processing sorting of multimedia content items according to the present invention is described. The first steps 1001 through 1009 of the method 1000 in FIG. 9A comprises determining whether the pre-processing will be based on a set of existing sort criteria (i.e., a predefined sort), or whether a new set of sort criteria will be defined. In either case, the sort criteria comprises both the view token definition 307 and the sort algorithms 420.

The view token definition 307 must include any content item that may be used in the sorting algorithm 420. Information fields contained in the view token 303 are the same fields used by the sort algorithm 420 to compare the same fields also found in the sort criteria. If a particular information field is not contained in the view token definition 307, it cannot be contained in the sort algorithm 420. As an example and not as a limitation, content items can be sorted using content class 110, content type 111, appropriateness 116, or usage descriptor 117 restrictions by examining the information in the content descriptors 105. One example of a sorting criteria definition would be to sort content items by genre 115 and by the appropriateness 116 of the content based on the viewer's age.

Referring again to FIG. 9A, after the view token definition 307 has been created (or retrieved if it already existed) through steps 1001 through 1009, steps 1010 through 1015 of the method 1000 comprises creating a new content matrix 401 by collecting a set of content diagonals 301, or re-processing an existing content matrix, in steps 1011, 1012, and 1013, and applying the appropriate content matrix sort algorithm 420 in steps 1014 and 1015. Said steps 1014 and 1015 may either effectuate the re-application of a previously applied content matrix sort algorithm 420 or define a new content matrix sort algorithm 420 to be applied. The content matrix sort algorithm 420 defines a specific logical relationship that must exist among a set of defined content item characteristics for the examined content item to conform with the sort criteria and thereby be “acceptable” for the applicable active viewer. This “relationship” is essentially the sort criteria, and when the sort algorithm 420, in applying the sort criteria yields a logical “true” result, the sort criteria is deemed to be met. As an example and not as a limitation, in the present invention, the sort algorithm 420 could be as simple as comparing the genre 115 of content items against a list of desired genre; or the sort algorithm 420 could also be quite complex, requiring a substantial number of content item characteristics to have very specific logical relationships with each other.

In steps 1010 through 1013 of the sort method 1000, either an existing content matrix 401 is processed or a new content matrix 401 is created by collecting a set of content diagonals 301 and assembling them into the content matrix 401 structure. Steps 1014 and 1015 of the sort method 1000 replace the sort algorithm locator 411 if the selected sort algorithm 420 is different from the sort algorithm 420 in the existing content matrix.

Referring now to FIG. 9B, steps 1016 through 1019 of sort method 1000 process content diagonals 301 by checking each content instance 100 and view token 303 in a particular content diagonal 301. As a result of the checking step 1018, if the view token definition 307 has been changed, then a new view token 303 must be created for each content instance 100 as in step 1019.

Next, referring again to FIG. 9B illustrating sort method 1000, step 1020 checks each content instance to see if it passes the sort criteria, thereby having a sort algorithm 420 result of a logical “true” or “positive”, indicating that the content instance 100 examined with respect to the sort criteria is “acceptable” for the applicable viewer. If the content instance 100 does not meet the sort criteria, and is therefore unacceptable, then a step 1021 check is performed to determine if a substitution operation is allowed. If substitutions are allowed, then a step 1022 search is conducted for an acceptable replacement content instance 100. If step 1023 determines that an acceptable replacement is found, then step 1024 replaces the previous content instance 100 with said found acceptable replacement and creates a new view token 303. If step 1021 determines that substitutions are not allowed or step 1023 determines that an acceptable replacement cannot be found, then (referring now to FIG. 9C) a step 1025 check is performed to determine if the content instance 100 can be removed from the content matrix 401.

Continuing with reference to FIG. 9C illustrating sort method 1000, if step 1025 determines that removal is allowed, then step 1027 removes the content instance 100 and the associated view token 303 from the content matrix 401. However, if step 1025 determines that removal is not allowed, step 1026 replaces the content instance 100 with a “blank” instance. Although a blank instance may be contained in the content matrix 401, it's presence is not displayed.

Still referring to FIG. 9C, the operation described by steps 1001 through 1029 of the sort method 1000 continues checking each content instance 100 until step 1028 determines that all of the content instances 100 in the content diagonal 301 have been checked. When all content instances 100 in the particular content diagonal 301 have been checked, then step 1030 creates a new Diagonal View Token 404 for the content diagonal 301 just checked. If step 1031 determines that all content diagonals 301 have been checked, step 1032 commences the repetition of steps 1016 through 1031, thereby examining another content diagonal 301 contained in the content matrix 401. When step 1031 has determined that all of the content diagonals 301 in the content matrix 401 have been examined and the repetition of step 1030 has created all of the diagonal view tokens 404 necessary in the content matrix 401, then step 1033 terminates the content matrix pre-processing sort operation.

Real-time Processing Sort Operation

Referring now to Table 1 and the logic flow diagram of FIGS. 10A through 10H, said diagram depicts an exemplary embodiment of a sorting algorithm 420 in a real-time processing sort operation, which, according to the present invention, is performed typically, but not necessarily, in a multimedia terminal device of the type specified herein, although said sort operation may be performed elsewhere in a multimedia system or multimedia network.

In an exemplary embodiment, the real-time Navigation Processing Engine (NPE) 1201 illustrated in FIG. 11 performs the real-time processing sort operation when it receives a new content matrix 401 for view preparation. The sort criteria is based on viewer information that has been collected and modified based on viewer inputs.

When a content matrix is received by the real-time Navigation Processing Engine 1201, said processing Engine (see FIG. 11) creates the content matrix descriptor (CMD) 431 and matrix information data 450 entries in the Real-time Processing Database for the original content matrix (OCM) 456. If content matrix modifications are allowed or enabled, then the content matrix modification process commences. Upon such commencement, the real-time Navigation Processing Engine 1201 then compares the information in the content matrix to the configuration and filtering information for each viewer.

The initial steps of the real-time processing sort method 1100 generally comprise receiving the initial content matrix and applying a content matrix sort algorithm 420 to perform the content matrix modifications. The latter steps of the real-time processing sort method 1100 generally comprise transferring a content matrix, and creating an active content matrix. Steps for performing these aspects of the disclosed sort method 1100 are described in greater detail below.

The real-time processing sort method 1100 receives a content matrix sort algorithm 420 by first retrieving viewer's information, and if original content matrix 456 is acceptable for viewer, said viewer's id 128 is added to original viewer list. If any existing modified content matrices are acceptable for the viewer, said viewer's id 128 is added to the viewer list for the corresponding modified content matrix 457. Steps for performing these aspects of the disclosed sort method are described in greater detail below.

Referring first to FIG. 10A, the first steps 1101, 1102, 1103 of the real-time processing sort method 100 comprises receiving a content matrix, assigning a Matrix Tag 426 to the content matrix, creating and making entries into the Real-Time Matrix Database.

Steps 1104, 1105, 1106 of the real-time processing sort method 1100 comprises getting viewer information, determining if original content matrix 456 is acceptable for a viewer, adding viewer id 128 to original content matrix viewer list (OCMVL) 452.

Steps 1107 through 1115 of the real-time processing sort method 1100 comprises, for all applicable active viewers, determining if there are content matrix modifications and terminating the real-time processing sort operation if there isn't, checking existing content matrix modifications, determining if existing or any content matrix modifications are acceptable for the viewer, and if not, creating new content matrix modifications acceptable for the viewer, updating a Real-time Content Matrix Database entry upon completion of the foregoing steps for all applicable active viewers.

Following the foregoing steps 1107 through 1114 resulting in the creation of new content matrix modifications as necessary to achieve acceptability for an applicable active viewer, referring now to FIG. 10C, steps 1116 and 1117 comprises creating the modified content matrix 457 including the newly created modifications, adding said modifications to the matrix modification database entry.

Referring again to FIG. 10C, the real-time processing sort method 1100 processes content diagonals very similar to the pre-processing sort method 1000 previously specified. Steps 1118 through 1124 of said sort method 1100 comprises checking the view token 303 and associated content instances 100 contained in each content diagonal 301 to determine whether said view tokens 303 meet the view filter requirements associated with the applicable viewer, finding and substituting (into said content diagonals 301) content instances 100 which are acceptable under the view filter requirements, and creating new view tokens 303 associated with the substituted content instances 100.

Referring now to FIG. 10D, in performing the foregoing steps 1118 through 1124, the disclosed sort method 1100 provides additional steps 1125 through 1132 comprising, for all content instances 100 within a content diagonal 301 and for all content diagonals 301 within the applicable content matrix 401, determining whether a content instance 100 is removable and if not, replacing it with a “blank” instance (as such blank instance is previously defined), removing a content instance 100 from content diagonal 301 if it is removable, creating new content diagonal view tokens 404 reflecting the effects of the individual view tokens 303 of the content instances 100 substituted into said content diagonal 301.

Referring now to FIG. 10E, the modified content matrix (MCM) 457 and its associated modified content matrix viewer's list (MCMVL) 455 for all viewers is updated, as well as the Real-time Matrix DataBase reflecting such updates is accomplished through execution of steps 1133 through 1137.

Method of Displaying Content Items for Navigation

Activating Content Items for Display by Creating the Active Content Matrix:

Referring now to Table 1, to FIGS. 10F through 10H, and to FIG. 11, following the initial content matrix modifications performed by the earlier steps of the real-time processing sort method 1100 previously described, the information is ready for display processing. When a viewer makes a selection that initiates the transfer and display of content, an Active Content Matrix 501 must be created by the real-time Navigation Processing Engine 1201 illustrated in FIG. 11. The real-time processing sort method 1100, illustrated in FIGS. 10F, 10G and 10H, using an active content matrix sort algorithm 502, creates said active content matrix 501 for communication to the real-time Navigation Display Engine 1202 also illustrated in FIG. 11.

Generally, the active content matrix sort algorithm 502, in the real-time processing sort method 1100, retrieves the active viewer's information, checks that the current content matrix 401 is acceptable for the viewer, and if so, makes said content matrix the Active Content Matrix 502. If not acceptable, then said active content matrix sort algorithm 502 checks if any corresponding modifications to the content matrix 401 are acceptable for the viewer. If the created original content matrix 456 or modified content matrix 457 remains unacceptable for the viewer, the active content matrix sort algorithm 502 gets the viewer to select a different content matrix 401. The active content matrix sort algorithm 502 then continues until a content matrix 401 acceptable for the viewer is determined, and this acceptable content matrix 401 is made the Active Content Matrix 501 to complete the process. The following reference to the figures and steps describes the active content matrix sort algorithm 502 in the real-time processing sort method 1100 in more detail.

Referring to FIG. 10F, steps 1138 through 1147 comprises the active content matrix sort algorithm 502 for creating the active content matrix 501 by selecting an available existing content matrix 401 in step 1140 based on the applicable active viewer information obtained in step 1139, which such information includes at least the viewer configuration information (VCI) 125, viewer filter definitions (VFD) 150 and view filters (VF) 155. The selected content matrix 401 is checked by step 1141 to determine if it is acceptable for the applicable active viewer. If not acceptable, step 1142 checks the content matrix modification database for corresponding modifications which make the content matrix 401 acceptable for the viewer, using parameters and fields including at least the original content matrix locator (OCML) 451 and associated original content matrix viewer list (OCMVL) 452, number of content matrix modifications (NCMM) 453 and list of modifications, content matrix modification locator (CMML) 454, and, as necessary, the modified content matrix (MCM) 457 and associated viewer list (MCMVL) 455, to make the created active content matrix 501 acceptable for the applicable active viewer. If execution of steps 1138 through 1143 result in no created original content matrix 456 or modified content matrix 457 which is acceptable for the viewer, steps 1144 and 1145 comprises repeatedly asking the viewer to outright select a content matrix 401. Once the created or viewer-selected content matrix 401 has been determined acceptable for the viewer, said content matrix is copied into (i.e. made) the Active Content Matrix 501 and the active content matrix creation process terminates in accordance with steps 1146 and 1147 respectively. Preparing the Active Content Matrix for Display; Creating the Display Information Array:

Referring now to FIG. 11, according to the present invention, the one or more subset(s) list(s) of content items sorted according to the sorting method disclosed is/are “activated” by presenting and enabling for menu display and navigation, using a multi-dimensional, user-friendly graphical illustration tool, such as a Graphical User Interface (“GUI ”). FIG. 11 shows an exemplary embodiment of a real-time Navigation Processing Engine 1201 and a real-time Navigation Display Engine 1202 used to process and activate the content item subset lists and for processing display and navigation information in the present invention.

Generally, the Navigation Processing Engine 1201 compares the View Tokens 303 with the viewer configuration information 125. If the Navigation Processing Engine 1201 determines a View Token 303 acceptable as a result of said comparison, its associated content item remains in the Active Content Matrix 501. However, if the Navigation Processing Engine 1201 determines a View Token 303 unacceptable as a result of said comparison, it either eliminates the content item from the Active Content Matrix 501, or “blanks out” the display of said unacceptable content item even though the content item may still remain in the Active Content Matrix 501, or it initiates a search for a substitute acceptable content item to replace the unacceptable content item.

The real-time Navigation Processing Engine 1201 generates a set of “active” navigation information and communicates said active navigation information to the real-time Navigation Display Engine 1202. This information includes the Active Content Matrix 501 used to provide information to the viewer. There may be more than one Content Matrix 401 inputted to the real-time Navigation Processing Engine 1201. As one example, there may be a Content Matrix 401 for each possible user of a particular multimedia terminal device; but, only one Content Matrix 401would be displayed at any one time. If, for example, a particular viewer named “Bob” is registered as the “current viewer” using a particular multimedia terminal device, then the Content Matrix 401 appropriate or applicable to “Bob” will become the Active Content Matrix 501 communicated by the Navigation Processing Engine 1201 to the Navigation Display Engine 1202. Additionally, the real-time Navigation Processing Engine 1201 examines the Active Content Matrix 501 to determine whether any Content Diagonals 301 must be removed, “blanked out”, or replaced, as previously specified.

Still referring to FIG. 11, the Navigation Processing Engine 1201 generates the appropriate set of active Content Diagonals 301 “called for” by the Active Content Matrix 501. The Content Diagonals 301 inputted to the Navigation Processing Engine 1201 are real-time processed by the NPE 1201 if the Diagonal View Tokens 403 of said inputted Content Diagonals 301 indicate that the Content Instances 100 therein contained are unacceptable for the applicable active viewer. Said real-time processing of the Content Diagonals 401 by the NPE 1201 occurs prior to communicating them to the Navigation Display Engine 1202 as “active”.

In addition to processing the Content Matrix 301 and the Content Diagonals 301, the Navigation Processing Engine 1201 extracts a set of “information requests” contained in the Viewer Configuration Information 125. In response to said requests, the NPE 1201 will comply by retrieving the requested information from the Content Instances 100 (e.g. Content Descriptors 105 and/or Content Locators 106), as appropriate, and communicate said retrieved information to the Navigation Display Engine 1201 in a set of Display Information Containers (DIC) 192, with at least one such DIC 192 communicated for each active Content Diagonal 301 and at least one such DIC 192 communicated for each active Content Instance 100. Content Diagonals 301 and/or Content Instances 100 that are likely to become active in the near future are communicated by the NPE 1201 as additional Display Information Containers 192 held in a queue in the Navigation Display Engine 1202.

Following its creation in the real-time Navigation Processing Engine (NPE) 1201 illustrated in FIG. 11 using the previously described active content matrix sort algorithm 502, the Active Content Matrix 501 is next prepared for display by the real-time Navigation Display Engine (NDE) 1202. In performing this preparation, the NDE 1202 executes an active content matrix display algorithm 503 within the real-time processing sort method 1100, as illustrated in FIGS. 10G and 10H, generally, by first getting the root diagonal number 412 of the Active Content Matrix 501, checking each content instance 100 in the content diagonal 301 to verify that it is acceptable for the current viewer, and if not, then blanking the unacceptable content instance 100. Once all content instances 100 in the content diagonal 301 are checked, the process repeats to check all content instances 100 in the next viewable content diagonal 301 and so on. Once all viewable content diagonals 301 have been checked, the Display Information Array (DIA) 190 is created and the information therein is displayed, thereby completing the process.

The active content matrix display algorithm 503 comprises steps 1148 through 1161, depicted in FIGS. 10G and 10H. The current root diagonal number 412 is retrieved in step 1149. In steps 1150 through 1159 each view token 303 and each content instance 100 in each content diagonal 301 of the display window are checked to determine whether they meet the view filter 155 requirements (as in step 1152), and if not, remove the unacceptable content instance 100 (as in steps 1153 and 1154), or “blank” the unacceptable content instance 100 from being displayed (as in steps 1153 and 1155). After all view tokens 303 and all content instances 100 in all content diagonals 301 have been checked as acceptable, as removed, or as “blanked”, the Display Information Array 190 is created in step 1160 and the algorithm 503 in the sort method is terminated in step 1161.

Method of Displaying Navigation Windows

Attributing to the “user-friendliness” of navigating multimedia content items according to the present invention, the Navigation Display Engine 1202 illustrated in FIG. 11 generates and controls a graphical user interface (GUI) comprising, inter alia, a plurality of display windows for displaying content item and display information.

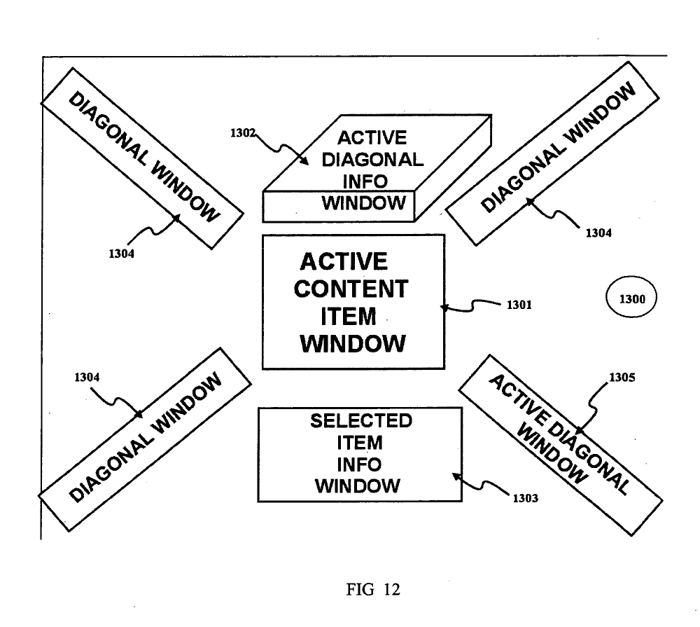

Referring now to the Real-time Navigation Display 1300 layout depicted in FIG. 12, said plurality of display windows aids the viewer in navigating among the various current content items, as well as obtaining information about viewable content items which are accessible to the viewer by virtue of them being listed in the Active Content Matrix 501. In one exemplary embodiment of the present invention, said plurality of display windows comprises at least three display windows typically, but not necessarily located in the center of the display, and additionally, at least two diagonal windows 1304, one of which is an active diagonal window 1305, each emanating radially, so as to be diagonal, from the center of the display and extending to the outer perimeter of the display (the Viewable Content Diagonal Space), as illustrated in FIG. 12; provided however, that other display and window layouts are contemplated and accommodated by the present invention without departing from its spirit and scope.

Referring again to FIG. 12, the aforementioned at least three display windows comprise at least one Active Content Item Window 1301, at least one Active Diagonal Information Window 1302, and at least one Selected Item Information Window 1303. The at least one Active Content Item Window 1301 displays the content item that has been activated by the viewer. As an example, in a media plane such as a Cable Television System 203, said viewer-activated content item would be equivalent to the selected television program (activated by channel and program selection). The at least one Active Content Item Window 1301 is typically the primary display window and is usually, but not necessarily, located in the center of the display.

The at least one Active Diagonal Information Window 1302 contains information related to content items defined in the at least one Active Diagonal Window 1305. Said information is extracted from the Display Information Containers 192 for display.

The at least one Selected Item Information Window 1303 contains information related to the content item selected by the viewer and shown in the at least one Active Content Item Window 1301.

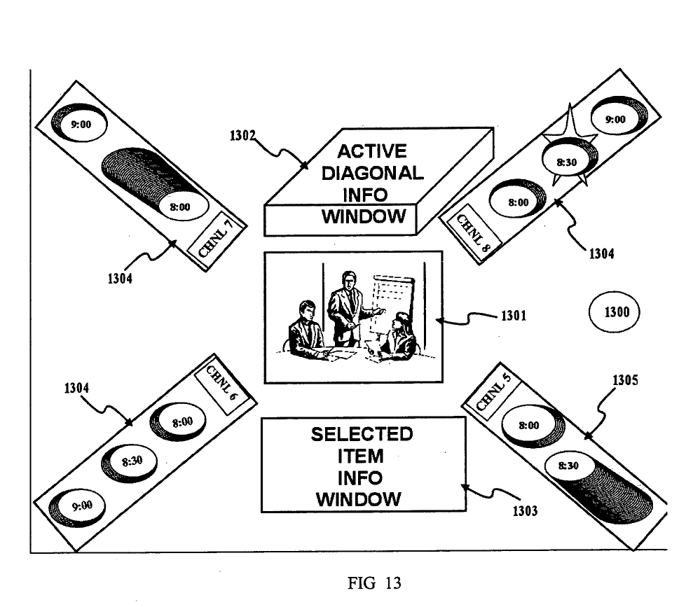

Diagonal Windows 1304 provide at least one of a plurality of graphical indices useful for the selection of content items. As previously specified, Content Diagonals 301 contain content items which share some common characteristic. As an example, referring now to FIG. 13, when navigating through a Cable Television System 203 media plane and its associated television programs as content items, each Content Diagonal 301 and its associated Diagonal Window 1304 displayed may be configured to represent a particular cable channel (e.g. channel 4, channel 5, . . . channel 100) with the content items shown in a particular Diagonal Window 1304 arranged according to the viewing time of the content item. Further in this example, a Diagonal Window 1304 located in the upper right of the display might contain, at a particular moment in time, content items representing television programs available on the CBC network transmitted on channel 8 of a Cable Television System 203 media plane, with the content item listed in the Diagonal Window 1304 closest to the center of the display representing a television show viewable at 8:00 PM, the next content item (moving from the centermost to the outermost content item listed) in the Diagonal Window 1304 representing a television show on channel 8 viewable at 8:30 PM, and the outermost content item listed in the Diagonal Window 1304 representing the television show on channel 8 viewable at 9:00 PM. In this example, navigating along the content items listed in the Diagonal Window 1304 represents navigating forward (i.e., from innermost content item, outward to the outermost content item), or backwards (inward) in time. As navigation proceeds along the content items listed in a Diagonal Window 1304, information associated with the selected content item is viewable in the at least one Selected Item Information Window 1303. Alternative embodiments of the present invention may navigate in the opposite or another direction, for example with the innermost content item listed being later in viewing time than the outermost content item listed without departing from the spirit and scope of the present invention. Additionally, other media planes in, including but not limited to, media or VOD file server 202, Internet web 204 (see FIG. 1), other multimedia systems and networks as specified herein, may be navigated using their particular address, file name, track number, reference number or other location numbering scheme as may be applicable without departing from the spirit or scope of the present invention.

Method of Navigating Content Item Display Windows

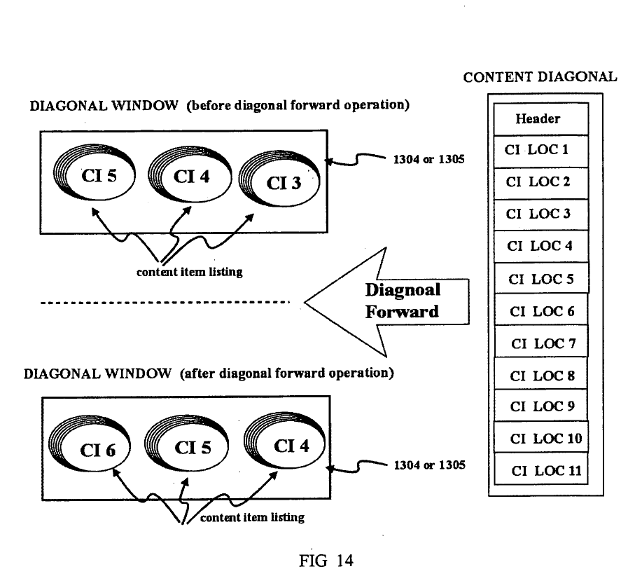

Referring now to FIGS. 14 through 19, the real-time Navigation Display Engine 1202 illustrated in FIG. 11 provides a plurality of navigation functions depicted in FIGS. 14 through 19 that a viewer can use to navigate across the information made available by the Active Content Matrix 501 transmitted to the Navigation Display Engine 1202 by the Navigation Processing Engine 1201, as previously described. Each function of said plurality of navigation functions is defined as follows.

The Diagonal Forward navigation function, as illustrated in FIG. 14, is used to shift the content item listing referenced for selection and displayed in the diagonal window 1304 or 1305 forward, right, or “up” in value, by at least one count, increment or content item, each time this navigation function is invoked. The Diagonal Forward function is used to move through the list of content items displayed in Diagonal Window 1304 or 1305, which may be shorter than the list of content items which can be referenced by (i.e. contained in) the associated Content Diagonal 301 itself.

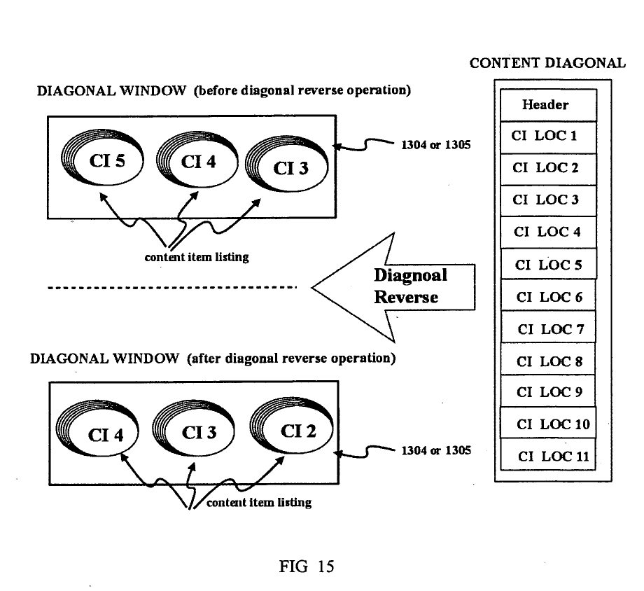

The Diagonal Reverse navigation function, as illustrated in FIG. 15, is used to shift the content item referenced for selection and display in the navigation display windows “backward”, left, or “down” in value, by at least one count, increment or content item, each time this navigation function is invoked. Again, this navigation is used to move through the list of content items displayed in Diagonal Window 1304 or 1305, which may be shorter than the list of content items which can be referenced by (i.e. contained in) the associated Content Diagonal 301 itself.

According to the present invention, the Active Content Matrix 501 may contain a large number of Content Diagonals 301 to define the subset(s) list(s) of the sorted content items. For example, in a Cable Television System media plane 203 with two-hundred channels, there may be two-hundred Content Diagonals 301 that are available at any particular time. These Content Diagonals 301 could be organized in an ordered set in the Active Content Matrix 501 (for example, channel 1 would be the first element in the ordered set of Cable Channel Content Diagonals 301, with channel 2 as the second element, and so on). Accordingly, in order to facilitate the navigation function among these Content Diagonals 301, the Diagonal Rotation Counterclockwise and the Diagonal Rotation Clockwise navigation functions according to the present invention can be utilized to navigate through large numbers of Content Diagonals 301 rapidly.

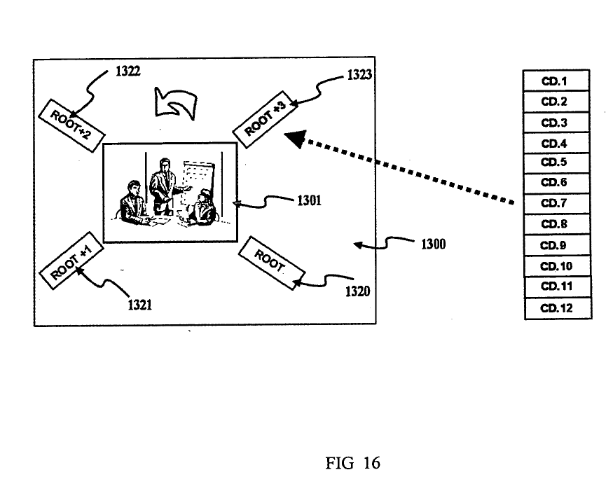

The Diagonal Rotation Counterclockwise navigation function, as illustrated in FIG. 16, positions a Content Diagonal 301 in the Navigation Display 1300 by rotating the diagonal windows 1304 displaying the information from one or more Content Diagonals 301 counter-clockwise around said display each time the function is invoked.

In an exemplary embodiment of the present invention, shown in FIG. 16, the content item rotation functions are generally expressed using the following nomenclature, layout, references, designations, and number of content diagonals, although other nomenclature, layout, references, designations and number of content diagonals can be displayed without departing from the spirit or scope of the present invention:

The Content Diagonal 301 which is aligned on the lower right corner of the Navigation Display 1300 sloping downward from the center to the right is designated as the Current Root Content Diagonal 1320, with the nomenclature: view_con_dig_root.

The Content Diagonal 301 which is aligned on the lower left corner of the Navigation Display 1300 sloping downward from the center to the left is designated as the next ordered diagonal 1321, with the nomenclature: view_con_dig_root+1.

The Content Diagonal 301 which is aligned on the upper left corner of the Navigation Display 1300 sloping upward from the center to the left is designated as the next ordered diagonal 1322, with the nomenclature: view_con_dig_root+2.

The Content Diagonal 301 that is aligned on the upper right corner of the Navigation Display 1300 sloping upward from the center to the right is designated as the next ordered diagonal 1323, or view_con_dig_root+3.

Note that alternative embodiments may provide for any number, n, of content diagonals 301, to be displayed in the Navigation Display 1300 using the following nomenclature, or alternative nomenclatures, without departing from the spirit or scope of the invention:
View-con-dig-root+n

When applied to the Diagonal Rotation Counterclockwise navigation function, a general object rotation function can be used to bring the “next” set of ordered Content Diagonal 301 onto the Navigation Display 1300 by rotating said Content Diagonals 301 counter-clockwise using the following:
View_con_dig_root(new)=view_con_dig_root+1(pre-rotate)
View_con_dig_root+1(new)=view_con_dig_root+2(pre-rotate)
View_con_dig_roo+2 (new)=view_con_dig_root+3(pre-rotate)
View_con_dig_root+3 (new)=next ordered Content Diagonal

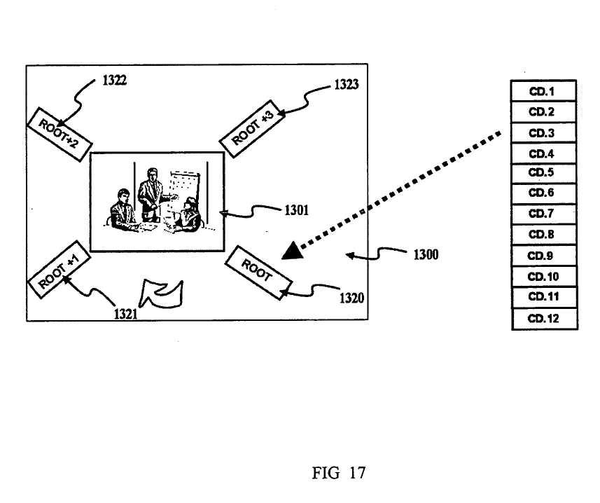

The Diagonal Rotation Clockwise navigation function, as illustrated in FIG. 17, positions a Content Diagonal 301 in the Navigation Display 1300 by rotating the diagonal windows 1304 displaying the information from one or more Content Diagonals 301 clockwise around said display each time the function is invoked. When applied to the Diagonal Rotation Clockwise navigation function, a general object rotation function can bring the “previous” set of ordered Content Diagonal 301 onto the Navigation Display 1300 by rotating said Content Diagonals 301 clockwise using the following:
View_con_dig_root+3(new)=view_con_dig_root+3(pre-rotate)
View_con_dig_root+2(new)=view_con_dig_root+1(pre-rotate)
View_con_dig_roo+1 (new)=view_con_dig_root(pre-rotate)
View_con_dig_root (new)=previous ordered Content Diagonal

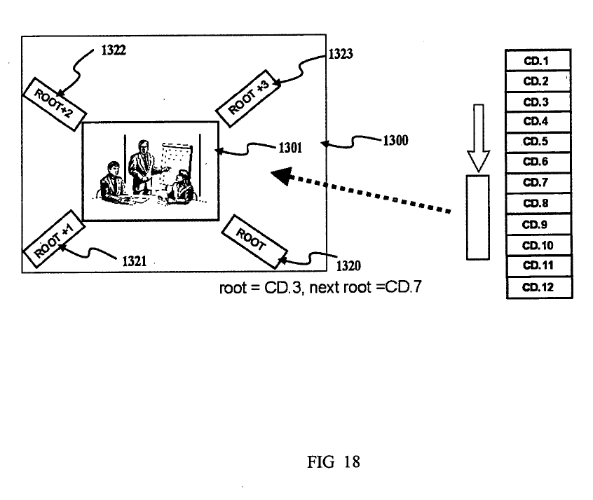

The Diagonal Forward View navigation function, as illustrated in FIG. 18, replaces one or more Content Diagonals 301 then positioned in the Navigation Display 1300, with the “next” set of one or more Content Diagonals 301 found in an ordered set of Content Diagonals 301, each time the function is invoked, using the following:
View_con_dig_root(new)=next_ordered-con_dig
View_con_dig_root+1 (new)=next-ordered_con_dig+1
View_con_dig_roo+2 (new)=next_ordered_con_dig+2
View_con_dig_root+3 (new)=next_ordered_con_dig+3

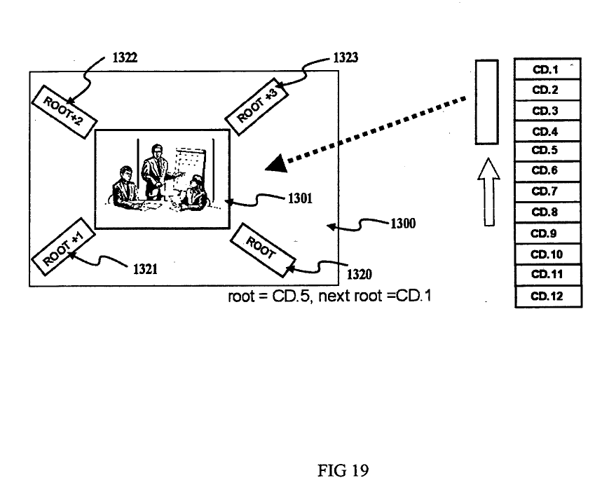

The Diagonal Reverse View navigation function, as illustrated in FIG. 19, replaces one or more Content Diagonals 301 then positioned in the Navigation Display 1300 with the “previous” set of one or more Content Diagonals 301 found in an ordered set of Content Diagonals 301 each time the function is invoked, using the following:
View_con_dig_root(new)=next_ordered_con_dig−4
View_con_dig_root+1(new)=next_ordered_con_dig−3
View_con_dig_roo+2 (new)=next_ordered_con_dig−2
View_con_dig_root+3 (new)=next_ordered_con_dig−1

The Select navigation function selects for viewing, the content item currently referenced in the content item list. Graphical, text, image or other forms of information about the selected content item appears in the at least one Selected Item Information Window 1303. The video or image content of the content item itself appears in the Active Content Item Window 1301.

The Guide navigation function causes the Navigation Display 1300 windows to appear on the display connected to the particular multimedia terminal device used by the viewer.

Each of the foregoing navigation functions is mapped to, and is invoked by depressing, one or more buttons on a remote control, keys on a wired or wireless keyboard, and/or button icons appearing on an on-screen display, depending on which type of the foregoing input devices is used with the particular multimedia terminal device.

In an exemplary embodiment of the present invention, possible assignments for buttons or keys typically found on a remote control device associated with cable tv set top boxes, satellite tv receivers, and television sets as multimedia terminal devices used by the viewer according to the present invention would be defined as follows. Alternative embodiments of the present invention may assign other navigation functions to other combinations of one or more buttons or keys on other input devices associated with other multimedia terminal devices without departing from the spirit and scope of the present invention.

The Diagonal Forward navigation function is invoked by depressing the “Up” button, key, or on-screen icon. The Diagonal Backward navigation function is invoked by depressing the “Down” button, key, or on-screen icon. The Diagonal Rotate Counterclockwise navigation function is invoked by depressing the “Left” button, key, or on-screen icon. The Diagonal Rotate Clockwise navigation function is invoked by depressing the “Right” button, key, or on-screen icon. The Forward View navigation function is invoked by depressing the “Page Up” button, key, or on-screen icon. The Backwards View navigation function is invoked by depressing the “Page Down” button, key, or on-screen icon. The Select navigation function is invoked by depressing the “Select” button, key, or on-screen icon. The Guide navigation function is invoked by depressing the “Guide On/Off” button, key, or on-screen icon

Distributed Processing Architecture of the NPE and the NDE

Referring again to FIG. 11, in an exemplary embodiment of the present invention, the aforementioned parameters and their included information fields comprising the hierarchial multi-dimensional information structure disclosed, as well as the disclosed pre-processing and real-time processing sort and display operations and their constituent algorithms, are processed and executed, in whole or in part, in the real-time Navigation Processing Engine (NPE) 1201 and the real-time Navigation Display Engine (NDE) 1202, and said processing and execution operations may be distributed between the NPE 1201 and NDE 1202 in any manner.

The NPE 1201 and the NDE 1202 each comprise one or more dedicated or shared interconnected processors, memory, storage, and input-output hardware components along with appropriate operating system, device driver, middleware, application or other firmware and software typical of electronic computing devices used in the field of the present invention.

Although all or part of the NPE 1201 and the NDE 1202 are typically, but not necessarily, resident in the multimedia terminal device, it should be noted that the present invention does not require that the NPE 1201 and NDE 1202 be co-located in the multimedia terminal device, nor elsewhere in the multimedia system or multimedia network. All or part of either of the two “engines” may be co-located or separated anywhere in a multimedia system or multimedia network, as well as in a multimedia terminal device, with said processing and execution operations being shared and distributed between them in any proportion and manner, and communication between them occurring within a single device or via the multimedia system or multimedia network.

While the above detailed description has shown, described, and pointed out novel features of the invention as applied to various embodiments, it is evident and will be understood that many various omissions, substitutions, alternatives, modifications, variations, and changes in the form and details of the method, apparatus, process, or device illustrated may be apparent to and made by those skilled in the art without departing from the spirit and scope of the invention. The foregoing description is of the best mode presently contemplated or carrying out the invention. This description is in no way meant to be limiting, but rather is intended to and should be taken as illustrative of the general principles of the invention.

1. A method of organizing, sorting, displaying for navigation, and navigating for finding and selecting one or more multimedia content items available from one or more various types of multimedia content sources using a multimedia terminal based on profile, preference and entitlement information pertinent to at least one viewer, and identifying, describing, locating and characterizing information pertinent to the one or more multimedia content items, and identifying, describing, locating and characterizing information pertinent to the one or more various types of multimedia content sources, comprising:
(a) organizing the identifying, describing, locating and characterizing information pertinent to the one or more multimedia content items, the one or more multimedia content sources, and the at least one viewer using a hierarchial information structure including one or more parameter sets, whereby said one or more parameter sets include identifying, describing, locating and characterizing information;
(b) sorting the information pertinent to the one or more multimedia content items, the one or more multimedia content sources, and the at least one viewer by performing at least one sorting operation on said identifying, describing, locating and characterizing information for applying a defined sorting criteria to identify at least one multimedia content item compliant with said defined sorting criteria, thereby identifying said compliant at least one multimedia content as suitable for the at least one viewer, whereby the at least one sorting operation performed is based on the complexity of the required sort and may occur as a pre processing sorting operation at any time prior to the time the at least one viewer navigates multimedia content, as a real time processing sorting operation at the time the at least one viewer navigates multimedia content, and any combination of both said at least one pre processing sorting operation and said at least one real time processing sorting operation;
(c) displaying a navigation graphical user interface on a television, computer, video, or other visual screen connected to a multimedia terminal, said graphical user interface including at least one first window as a diagonal window displaying an enumeration of the at least one multimedia content item suitable for the at least one viewer, at least one second window as an active diagonal information window displaying information pertinent to the at least one suitable multimedia content item, at least one third window as an active content item window displaying a visual still or moving image visual depiction of a multimedia content item selected by the at least one viewer, at least one fourth window as a selected item information window displaying information pertinent to the selected multimedia content item depicted by the still or moving image; and
(d) navigating through the display in the at least one first window as a diagonal window to select the at least one suitable multimedia content item using at least one of a plurality of on screen navigation functions including a diagonal forward function, a diagonal reverse function, a diagonal rotation counterclockwise function, a diagonal rotation clockwise function, a diagonal forward view function, a diagonal reverse view function, a select function, and a guide on and off function, each function invoked by depressing at least one button on a remote control device, or at least one key on a keyboard, or by clicking on at least one on screen icon connected to a multimedia terminal.

2. The method according to claim 1, wherein the one or more parameter sets further includes
any combination selected from the group consisting of alphanumeric characters, punctuation symbols, text strings, integers, real numbers, arithmetic operators and symbols, and logic operators and symbols to identify, describe, locate and characterize the one or more multimedia content items, and the one or more various multimedia content sources and to represent the profile, preference and entitlement information pertinent to the at least one viewer of multimedia content.

3. The method according to claim 2, wherein the one or more parameter sets of identifying, describing, locating and characterizing information further includes:
(a) a content instance, including a content descriptor, a content locator and a content view token associated with said content locator, as a means for referencing each instance of a particular multimedia content item, wherein a particular multimedia content item occurring at more than one time or location has the same more than one number of content instances, each having the same content descriptor and view token but a different content locator,
(b) said content descriptor as a means for identifying and describing a multimedia content item including name and title, identification number, description, genre and subject matter, version number, classification, subclassification type, substitutability status, removability status, processing and decoding format, the multimedia content item for use, identification of the provider, identification of the owner, author, publisher, or distributor, date of publication or release, viewer age appropriateness, content rating, targeted viewer demographics, usage entitlements and access restriction requirements,
(c) said content locator as a means for defining the source, location, delivery type and method, day and time when available, time duration of availability, search technique required, and access security restrictions and entitlements applied in locating the associated content instance,
(d) said content view token associated with each content locator as a means for defining the characteristics of the particular multimedia content item located by said content locator,
(e) a view token definition as a means for defining the format of the content view token,
(f) a view token definition locator as a means for defining the source, location, delivery type and method, day and time when available, time duration of availability, search technique required, and access security restrictions and entitlements applied in locating the view token definition,
(g) a blank content instance as a means for maintaining the content descriptor, content locator and content view token information structure but blanking out said information from display and prohibiting its navigation,
(h) at least one content diagonal, including a content diagonal header and at least one content locator and its associated content view token, as a means for grouping content locators and their associated content view tokens locating and characterizing multimedia content items having at least one characteristic in common with all other multimedia content items in said grouping, wherein said at least one characteristic is determined by the content view tokens within said grouping,
(i) said content diagonal header as a means for defining a name, identification number, and version number of its associated content diagonal,
(j) a content diagonal locator as a means for defining the source, location, delivery type and method, day and time when available, time duration of availability, search technique required, and access security restrictions and entitlements applied in locating the at least one content diagonal,
(k) a content diagonal view token as a means for defining the at least one characteristic in common with all the content view tokens within the content diagonal,
(l) a viewer configuration descriptor as a means for defining information pertinent to the at least one viewer, thereby making said viewer a configured viewer, including a profile, preferences, restrictions and entitlements particular to each of the at least one configured viewer,
(m) a number of configured viewers parameter as a means for indicating the number of viewers for which a viewer configuration descriptor has been defined, thereby being configured for multimedia content use,
(n) a viewer identification parameter assigned and particular to each configured viewer as a means for identifying said each configured viewer,
(o) a viewer configuration descriptor locator as a means for defining the source, location, delivery type and method, day and time when available, time duration of availability, search technique required, and access security restrictions and entitlements applied in locating a viewer configuration descriptor,
(p) a viewer configuration information parameter set as a means for grouping the at least one viewer configuration descriptor locator pertinent to a particular configured viewer,
(q) a viewer display descriptor as a means for defining what information is displayed for a particular configured viewer,
(r) a viewer display descriptor locator as a means for defining the source, location, delivery type and method, day and time when available, time duration of availability, search technique required, and access security restrictions and entitlements applied in locating a viewer display descriptor,
(s) at least one content matrix, including a content matrix header, a content matrix availability parameter, a content matrix duration parameter, a view token definition locator, a sort algorithm locator, a current root diagonal parameter and at least one content diagonal locator and its associated content diagonal view token, as a means for grouping content diagonal locators and their associated content diagonal view tokens locating and characterizing at least one content diagonal having at least one characteristic in common with all other content diagonals within said grouping, wherein said at least one characteristic is determined by the content diagonal view tokens within said grouping,
(t) said content matrix header included in a content matrix as a means for defining the name, identification number, and version number of its associated content matrix,
(u) said content matrix availability parameter included in a content matrix as a means for defining the day and time when a content matrix is available for use,
(v) said content matrix duration parameter included in a content matrix as a means for defining the time duration that a content matrix is available for use,
(w) said current root diagonal parameter included in a content matrix as a means for designating a content matrix as an origin reference point in a navigation display,
(x) said view token definition locator included in a content matrix as a means for defining the source, location, delivery type and method, day and time when available, time duration of availability, search technique required, and access security restrictions and entitlements applied in locating the view token definition pertinent to the including content matrix,
(y) at least one sort algorithm as a means for defining the procedure applied for sorting a content matrix,
(z) said sort algorithm locator included in a content matrix as a means for defining the source, location, delivery type and method, day and time when available, time duration of availability, search technique required, and security restrictions and entitlements applied in locating said sort algorithm for sorting the including content matrix,
(aa) at least one content matrix modification as a means for modifying a content matrix so as to make said content matrix compliant with a defined sorting criteria as determined by the at least one sort algorithm applied to said content matrix,
(bb) a content matrix modification locator as a means for defining the source, location, delivery type and method, day and time when available, time duration of availability, search technique required, and access security restrictions and entitlements applied in locating a particular content matrix modification,
(cc) an original content matrix as a means for designating a content matrix as unmodified with respect to its initial version,
(dd) a modified content matrix as a means for designating a content matrix as modified from its prior version,
(ee) an original content matrix locator as a means for defining the source, location, delivery type and method, day and time of availability, time duration of availability, search technique required, and access security restrictions and entitlements applied in locating an original content matrix,
(ff) an original content matrix viewer list as a means for enumerating the viewer identification parameter of each configured viewer for which multimedia content items referenced in an original content matrix are suitable,
(gg) a modified content matrix viewer list as a means for enumerating the viewer identification parameter of each configured viewer for which multimedia content items referenced in a modified content matrix are suitable,
(hh) a number of modifications parameter as a means for indicating the number of modifications made to a modified content matrix since its initial version as an original content matrix,
(ii) at least one matrix information data parameter set as at least one means for referencing information pertinent to a content matrix including the original content matrix viewer list, the number of modifications parameter, and the content matrix modification locator,
(jj) a content matrix descriptor, including a matrix tag parameter, a matrix status parameter, a matrix information locator, a previous matrix descriptor locator and a next matrix descriptor locator, as a means for defining the availability status, and position within a processing sequence of the content matrix it describes,
(kk) said matrix tag parameter as a means for referencing a particular content matrix within a content matrix descriptor,
(ll) said matrix status parameter included in a content matrix descriptor as a means for describing the availability of the referenced content matrix and any modifications thereto,
(mm) said matrix information locator, included in the content matrix descriptor, as a means for defining the source, location, delivery type and method, day and time when available, time duration of availability, search technique required, and access security restrictions and entitlements applied in locating a matrix information data parameter set,
(nn) said previous matrix descriptor locator, included in the content matrix descriptor, as a means for defining the source, location, delivery type and method, day and time of availability, time duration of availability search technique required, and access security restrictions and entitlements applied in locating the content matrix preceding the content matrix described by said content matrix descriptor in a processing sequence of a plurality of content matrixes,
(oo) said next matrix descriptor locator, included in the content matrix descriptor, as a means for defining the source, location, delivery type and method, day and time of availability, time duration of availability, search technique required, and access security restrictions and entitlements applied in locating the content matrix following the content matrix described by said content matrix descriptor in a processing sequence of a plurality of content matrixes,
(pp) a content matrix locator as a means for defining the source, location, delivery type and method, day and time when available, time duration of availability, search technique required, and access security restrictions and entitlements applied in locating a content matrix,
(qq) a view filter as a means for defining which particular sort algorithm is applied to verify that each multimedia content item referenced in a content matrix complies with the viewer configuration descriptor pertinent to each of the at least one configured viewer,
(rr) a view filter locator as a means for defining the source, location, delivery type and method, day and time when available, time duration of availability, search technique required, and access security restrictions and entitlements applied in locating a view filter,
(ss) a number of view filter entries parameter as a means for indicating the number of information entities in a view filter,
(tt) at least one view filter definition as a means for defining the format and type of information entities of a view filter,
(uu) a view filter definition locator as a means for defining the source, location, delivery type and method, day and time when available, time duration of availability, search technique required, and access security restrictions and entitlements applied in locating a view filter definition,
(vv) at least one view filter reference parameter as a means for defining the information that is evaluated in a view filter,
(ww) at least one view filter reference definition parameter as a means for defining the value of an associated view filter reference,
(xx) a number of view filter reference definitions parameter as a means for indicating the number of defined values for a particular view filter reference parameter,
(yy) a number of filter values parameter as a means for indicating the number of view filter references defined in a particular view filter definition,
(zz) at least one view filter reference value definition parameter as a means for defining a name corresponding to a particular type of view filter reference,
(aaa) a view filter entity parameter as a means for referencing an associated view filter reference parameter,
(bbb) at least one display information container as a means for conveying content diagonal information or content instance information for display in a navigation display on a video screen,
(ccc) a container type parameter as a means for indicating whether a display information container is a content diagonal information conveyor or a content instance information conveyor,
(ddd) at least one display information array as a means for conveying the at least one display information container,
(eee) a number of display information containers parameter as a means for indicating the number of display information containers conveyed in a display information array,
(fff) at least one display information container descriptor as a means for defining information for particularizing the configuration of a navigation display to a particular configured viewer, and
(ggg) a number of information container descriptors parameter as a means for indicating the number of display information container descriptors in a display information array.

4. The method according to claim 1, wherein the defined sorting criteria further includes at least one multimedia content item characteristic expressed in the information type and format of the at least one view token definition and the at least one sort algorithm, wherein said defined sorting criteria may be defined for application in a pre processing sorting operation, a real time processing sorting operation or any combination of both.

5. The method according to claim 4, wherein the at least one multimedia content item characteristic to which the defined sorting criteria is applied further includes name, title, identification number, version, description, publication release date, class, type, genre, subject matter, content source, location, usage restrictions and entitlements, owner, producer, author, distributor, provider, actor, performer, artist, viewer age appropriateness, content rating, targeted viewer demographics, running time length, file size, availability day, availability time of day, availability time duration, decoding and display processing format.

6. The method according to claim 1, wherein the at least one sorting operation is a pre-processing sorting operation further including
(a) creating an original content matrix,
(b) modifying an existing original content matrix or a previously modified content matrix,
(c) deriving a new content matrix as a derivative content matrix from an existing original content matrix or an existing modified content matrix.

7. The method according to claim 6, wherein the at least one pre processing sorting operation further includes
(a) determining whether to apply an existing defined sorting criteria or a newly defined sorting criteria,
(b) retrieving at least one existing sorting parameter list if applying an existing defined sorting criteria,
(c) creating at least one new sorting parameter list if applying a newly defined sorting criteria,
(d) retrieving at least one existing sort algorithm if applying an existing defined sorting criteria,
(e) creating at least one new sort algorithm if applying a newly defined sorting criteria,
(f) retrieving at least one existing view token definition if applying an existing defined sorting criteria,
(g) creating at least one new view token definition if applying a newly defined sorting criteria,
(h) storing the at least one newly created sorting parameter list if created,
(i) storing the at least one newly created sort algorithm if created,
(j) storing the at least one newly created view token definition if created,
(k) performing the retrieved existing at least one sort algorithm on the existing at least one content matrix using the retrieved at least one existing sorting parameter list, and the retrieved existing at least one view token definition if applying an existing defined sorting criteria to sort an existing content matrix,
(l) performing the newly created at least one sort algorithm to create a new content matrix using the newly created sorting parameter list and the newly created view token definition,
(m) performing the newly created at least one new sort algorithm on the existing content matrix if applying a newly defined sorting criteria,
(n) performing the newly created at least one new sort algorithm on the newly created content matrix if applying a newly defined sorting criteria, whereby the foregoing at least one pre processing sorting operation results in a sorted content matrix.

8. The method according to claim 7, wherein the at least one pre processing sorting operation is performed on all content instances within each and every content diagonal of a content matrix and further includes
(a) performing at least one sort algorithm on each and every content instance and its associated content view token within each and every content diagonal of a content matrix to determine if it complies with the then current pertinent view token definition,
(b) creating a new content view token if said view token definition has changed since its previous version,
(c) performing a second at least one sort algorithm on each and every content instance to determine if it complies with the defined sorting criteria, and thereby suitable for the configured viewer pertinent to said defined sorting criteria,
(d) searching for and substituting a compliant content instance for each non compliant content instance if its substitutability status indicates that substitution is is allowed and if a compliant content instance is found,
(e) creating a new content view token for each substituted compliant content instance,
(f) removing each non compliant content instance for which substitution is not allowed if its removability status indicates that removal is allowed,
(g) replacing each non compliant content instance with a blank content instance if it cannot be substituted or removed,
(h) creating a new content diagonal view token for each content diagonal within the content matrix, thereby describing the current multimedia content item characteristics defined in the constituent content view tokens within said each content diagonal.

9. The method according to claim 1, wherein the at least one sorting operation is a real time sorting operation using content matrix descriptor chaining to define the sequence in which a plurality of successive content matrixes is processed and further includes
(a) receiving at least one content matrix,
(b) creating a content matrix descriptor,
(c) creating a matrix information data parameter set from the information contained in the received content matrix,
(d) initializing the matrix information locator in the newly created content matrix descriptor, thereby defining the source, location, delivery type and method, day and time availability, time duration availability, search technique required, and access security restrictions and entitlements applied in locating the newly created matrix information data parameter set,
(e) initializing both the previous matrix descriptor locator and the next matrix descriptor locator of the newly created content matrix descriptor to a null locator value if the newly created content matrix descriptor is the first in a sequence,
(f) initializing the previous matrix descriptor locator to point to the location of the last enumerated content matrix descriptor and the next matrix descriptor locator to a null locator value if the newly created content matrix descriptor is not the first in a sequence,
(g) initializing the next matrix descriptor locator of the last enumerated content matrix descriptor to point to the location of the newly created content matrix descriptor.

10. The method according to claim 9, wherein the at least one real time sorting operation further includes
(a) receiving at least one content matrix,
(b) assigning a matrix tag parameter to said received content matrix,
(c) creating a real time matrix database including matrix tag parameters, matrix status parameters, matrix information locators, original content matrix locators, content matrix viewer lists, number of modifications parameters, list of modifications parameters, and content matrix modification locators as entries to said real time matrix database,
(d) retrieving the viewer configuration information parameter set pertinent to at least one configured viewer who is actively navigating multimedia content thereby an active configured viewer,
(e) retrieving the at least one view filter definition pertinent to the at least one active configured viewer,
(f) retrieving the at least one view filter pertinent to the at least one active configured viewer,
(g) performing at least one sort algorithm on said received at least one content matrix to determine if it is suitable for said active configured viewer based on said retrieved viewer configuration information parameter set, said retrieved at least one view filter definition and said retrieved at least one view filter,
(h) determining if modifications to the received at least one content matrix are allowed,
(i) searching the real time matrix database for at least one existing content matrix modification suitable for the active configured viewer using information including content matrix locators, content matrix viewer lists, number of content matrix modifications parameters, content matrix modification locators, original content matrixes, and modified content matrixes,
(j) creating at least one new content matrix modification suitable for the at least one active configured viewer if the received at least one content matrix is not suitable for the at least one active configured viewer and no existing suitable modifications are found,
(k) creating at least one modified content matrix suitable for the at least one active configured viewer based on the at least one existing content matrix modification found or the new content matrix modification created,
(l) updating the applicable real time matrix database entries resulting from said modifications including incrementing the number of modifications parameter by the number of content matrix modifications made,
(a) prompting the at least one active configured viewer to select a content matrix that said viewer determines suitable if neither the at least one original content matrix nor the at least one modified content matrix is suitable for said viewer,
(m) adding the viewer identification parameter of the at least one active configured viewer to the content matrix viewer list of the original content matrix, the modified content matrix resulting from said real time sorting operation, or the selected content matrix resulting from the active configured viewer's prompted selection.

11. The method according to claim 10, wherein the real time processing sorting operation is performed on all content instances within each and every content diagonal of a content matrix and further includes
(a) performing at least one sort algorithm on each and every content instance and its associated content view token within each and every content diagonal of a content matrix to determine if it complies with the then current pertinent view token definition,
(b) creating a new content view token if said view token definition has changed since its previous version,
(c) performing a second at least one sort algorithm on each and every content instance to determine if it complies with the defined sorting criteria, and thereby suitable for the configured viewer pertinent to said defined sorting criteria,
(d) searching for and substituting a compliant content instance for each non compliant content instance if its substitutability status indicates that substitution is is allowed and if a compliant content instance is found,
(e) creating a new content view token for each substituted compliant content instance,
(f) removing each non compliant content instance for which substitution is not allowed if its removability status indicates that removal is allowed,
(g) replacing each non compliant content instance with a blank content instance if it cannot be substituted or removed,
(h) creating a new content diagonal view token for each content diagonal within the content matrix, thereby describing the current multimedia content item characteristics defined in the constituent content view tokens within said each content diagonal.
(n) updating the applicable real time matrix database entries resulting from said modifications including incrementing the number of modifications parameter by the number of content matrix modifications made,
(o) adding the viewer identification parameter of the at least one active configured viewer to the content matrix viewer list of the original or modified content matrix resulting from said real time sorting operation.
(p) initializing the content matrix locator parameter to point to the location of the resulting modified content matrix,
(q) update the matrix information data parameter set.

12. The method according to claim 1, wherein displaying the navigation graphical user interface further includes
(a) receiving a content matrix suitable for the at least one active configured viewer,
(b) designating said received content matrix as an active content matrix,
(c) creating a display information array based on the information contained in the active content matrix as display configuration information pertinent to a particular active configured viewer,
(d) retrieving the current root diagonal number parameter from the active content matrix,
(i) performing at least one sort algorithm on each and every content instance and its associated content view token within each and every content diagonal of the active content matrix to determine if it complies with the view filter pertinent to the active configured viewer,
(j) searching for and substituting a compliant content instance for each non compliant content instance if its substitutability status indicates that substitution is allowed and if a compliant content instance is found,
(k) creating a new content view token for each substituted compliant content instance,
(l) removing each non compliant content instance for which substitution is not allowed if its removability status indicates that removal is allowed,
(m) replacing each non compliant content instance with a blank content instance if it cannot be substituted or removed,
(n) creating a display information array including at least one display information container of only information from those compliant content instances.

13. The method according to claim 12, wherein the information contained in the display information container is displayed on a television, computer, video or other visual screen using a plurality of on screen windows including
(a) displaying in the at least one active content item window, a still or moving image rendering of a multimedia content item selected and thereby activated by the active at least one configured viewer,
(b) displaying in the at least one diagonal window, a list of the at least one multimedia content item identified in the at least one content diagonal parameter set,
(c) displaying in the at least one diagonal window designated as the active diagonal window, a list of the at least one multimedia content item identified in the active content diagonal parameter set,
(d) displaying in the at least one active diagonal information window, information received from the at least one display information container parameter of the display information array parameter set as information pertinent to the at least one multimedia content item listed in the at least one active diagonal window,
(e) displaying in the at least one selected item information window, information pertinent to the at least one multimedia content item displayed in the at least one active content item window.

14. The method according to claim 1, wherein the diagonal forward navigation function further includes
(a) shifting the multimedia content item graphical index displayed in a diagonal window forward, from right to left, or up in value by at least one count, increment or next multimedia content item listed, each time this function is invoked, whereby the at least one content diagonal containing the information then positioned in the display for navigation is replaced with information from a content diagonal next in a sequence of a plurality of content diagonals, to aid a viewer in navigating in a forward first to last direction through menu list of multimedia content items displayed in a diagonal window which may be shorter than the number of multimedia content items referenced in the content diagonal associated with said displaying diagonal window.

15. The method according to claim 1, wherein the diagonal reverse navigation function further includes
(a) shifting the multimedia content item graphical index displayed in a diagonal window backward, from left to right, or down in value by at least one count, decrement or previous multimedia content item listed, each time this function is invoked, whereby the at least one content diagonal containing the information then positioned in the display for navigation is replaced with information from a content diagonal previous in a sequence of a plurality of content diagonals, to aid a viewer in navigating in a last to first direction through menu list of multimedia content items displayed in a diagonal window which may be shorter than the number of multimedia content items referenced in the content diagonal associated with said displaying diagonal window.

16. The method according to claim 1, wherein the diagonal rotation counterclockwise function further includes
(a) retrieving the content diagonal root parameter,
(b) invoking a general object rotation function and using the content diagonal root parameter as a reference with respect to which the at least one diagonal window is rotated counterclockwise around the navigation display,
(c) using said rotation to position within the at least one diagonal window for displaying the information contained in the at least one content diagonal next in a sequence of a plurality of content diagonals each time said navigation function is invoked, whereby this navigation function may be used by a viewer to navigate through the information contained in a plurality of content diagonals rapidly in a sequence direction from current to next.

17. The method according to claim 1, wherein the diagonal rotation clockwise function further includes
(a) retrieving the content diagonal root parameter,
(b) invoking a general object rotation function and using the content diagonal root parameter as a reference with respect to which the at least one diagonal window is rotated clockwise around the navigation display,
(b) using said rotation to position within the at least one diagonal window for displaying the information contained in the at least one content diagonal previous in a sequence of a plurality of content diagonals each time said navigation function is invoked, whereby this navigation function may be used by a viewer to navigate through the information contained in a plurality of content diagonals rapidly in a sequence direction from current to previous.

18. The method according to claim 1, wherein the diagonal forward view navigation function further includes shifting the graphical index displayed in a diagonal window forward, from right to left, or up by enveloping a plurality comprising a set of next content diagonals, each time this function is invoked, whereby said plurality of content diagonals then positioned in the diagonal window for navigation is replaced with another plurality of equal number of content diagonals occurring next in an enumeration of content diagonals.

19. The method according to claim 1, wherein the diagonal reverse view navigation function further includes shifting the graphical index displayed in a diagonal window backward, from right to left, or down by enveloping a plurality comprising a set of previous content diagonals, each time this function is invoked, whereby said plurality of content diagonals then positioned in the diagonal window for navigation is replaced with another plurality of equal number of content diagonals occurring previous in an enumeration of content diagonals.

20. The method according to claim 1, wherein the select navigation function further includes
(a) indicating on the display selection of a particular multimedia content item listed in said displayed graphical index,
(b) activating the selected multimedia content item by displaying information pertinent to it in the at least one selected item information window,
(c) displaying a still or moving image rendering of said selected multimedia content item in the at least one active content item window.

21. The method according to claim 1, wherein the guide on and off navigation function further includes causing the plurality of display windows to appear on the visual screen by invoking the on function and causing the plurality of display windows to disappear from the visual screen by invoking the off function.

22. An apparatus for organizing, sorting, displaying for navigation, and navigating for finding and selecting one or more multimedia content items available from one or more varied types of multimedia content sources and displaying on a television, computer, video or other visual screen a plurality of display windows containing information about or content of at least one multimedia content item, whereby the particular at least one multimedia content item is based on the sorting, comprising:
(a) at least one memory or other data storage device that stores information defining at least one sorting criteria, information identifying, describing, locating and characterizing one or more multimedia content items, information identifying, describing, locating and characterizing one or more various types of multimedia content sources, and information identifying, describing, locating and characterizing one or more viewers of multimedia content;
(b) at least one network interface, including hardware and software, for connection to a multimedia content source and communication of said identifying, describing, locating and characterizing information;
(c) at least one display interface, including hardware and software, for connection to a television screen, computer screen, video or other visual screen and display of said identifying, describing, locating and characterizing information;
(d) at least one user interface, including hardware and software, for controlling and communicating with the apparatus by a user of the apparatus or viewer of multimedia content; and
(e) at least one processor engine, including hardware and software, connected with the at least one network interface, the at least one display interface, the at least one user interface, and the at least one memory or other data storage device, that retrieves the information defining the sorting criteria and the information identifying, describing, locating and characterizing multimedia content items, multimedia content sources, and viewers of multimedia content, performs at least one organizing operation to organize the identifying, describing, locating and characterizing information, performs at least one sorting operation to apply the at least one sorting criteria information to some or all of the identifying, describing, locating and characterizing information, groups only those multimedia content items which comply with said sorting criteria as suitable for use by a particular viewer, displays in the plurality of display windows information about or content of only those suitable multimedia content items, performs at least one navigation function invoked by a viewer to navigate through the displayed information for selecting at least one multimedia content item therefrom.

23. The apparatus according to claim 22, wherein the at least one memory or data storage device, the at least one network interface, the at least one display interface, the at least one user interface, and the at least one processor engine may all be located together at one location or each one or more of them distributed among a plurality of location in at least one multimedia content source, at least one multimedia content network, or at least one multimedia terminal, or in any combination thereof.

24. The apparatus according to claim 22, wherein the at least one processing engine organizes, sorts, displays, and navigates some or all of the identifying, describing, locating and characterizing information at any time prior to viewer navigation of multimedia content items as a pre processing operation, at the time of said navigation as a real time processing operation, or in any combination of both.

25. The apparatus according to claim 22, wherein the sorting criteria and the identifying, describing, locating and characterizing information organized, sorted, displayed, and navigated by said apparatus further includes a hierarchial information structure including one or more parameter sets, whereby said one or more parameter sets includes any combination selected from the group consisting of alphanumeric characters, punctuation symbols, text strings, integers, real numbers, arithmetic operators and symbols, and logic operators and symbols.

26. The apparatus according to claim 23, wherein the hierarchial information structure of one or more parameter sets organized, sorted, displayed, and navigated by said apparatus further includes the parameters according to claim 3.

27. The apparatus according to claim 22, wherein the at least one sorting operation performed by said apparatus further includes the pre processing sorting method according to claim 4, 5, 6, 7, or 8.

28. The apparatus according to claim 22, wherein the at least one sorting operation performed by said apparatus further includes the real time processing sort method according to claim 9, 10, or 11.

29. The apparatus according to claim 22, wherein the displaying for navigation information by said apparatus further includes the method according to claim 12 or 13.

30. The apparatus according to claim 22, wherein the navigation of displayed information by said apparatus further includes the method according to claim 14, 15, 16, 17, 18, 19, 20, or 21.
